(19) United States
(12) Patent Application Publication
(10) Pub. No.: US 2013/0337317 A1
(43) Pub. Date: Dec. 19, 2013

(54) NONAQUEOUS ELECTROLYTIC SOLUTION, AND BATTERY USING SAME

(71) Applicant: MITSUBISHI CHEMICAL CORPORATION, Tokyo (JP)

(72) Inventors: Kunihisa SHIMA, Mie (JP); Shuhei Sawa, Ibaraki (JP); Youichi Ohashi, Ibaraki (JP)

(73) Assignee: MITSUBISHI CHEMICAL CORPORATION, Tokyo (JP)

(21) Appl. No.: 13/973,286

(22) Filed: Aug. 22, 2013

Related U.S. Application Data
(63) Continuation of application No. PCT/JP2012/054173, filed on Feb. 21, 2012.

(30) Foreign Application Priority Data
Feb. 22, 2011 (JP) 2011-036427

(51) Int. Cl. H01M 10/0567; H01M 10/0525

(52) U.S. Cl. CPC H01M 10/0567; H01M 10/0525
USPC 429/188

(57) ABSTRACT

The invention relates to a nonaqueous electrolytic solution comprising an electrolyte and a nonaqueous solvent, the nonaqueous electrolytic solution comprising a specific compound.

### TECHNICAL FIELD

The present invention relates to nonaqueous electrolytic solutions, and batteries using the same.

### BACKGROUND ART

There have been increasing demands for higher capacity secondary batteries along with the rapidly advancing development of electronic devices. The lithium ion secondary batteries having higher energy density than nickel-cadmium batteries and nickel-hydrogen batteries are now in common use, and have been actively studied.

Typically, the electrolytic solution used for nonaqueous electrolytic solution batteries is mainly configured from an electrolyte and a nonaqueous solvent. The electrolytic solution of lithium ion secondary batteries is typically a nonaqueous electrolytic solution produced by dissolving electrolytes such as LiPF₆, LiBF₄, and LiN(CF₃SO₂)₂ in a mixed solvent of a high-dielectric-constant solvent (such as ethylene carbonate, propylene carbonate, and γ-butyrolactone) and a low-viscosity solvent (such as dimethyl carbonate, diethyl carbonate, and ethyl methyl carbonate).

It is known that the lithium ion secondary batteries, when stored under high-temperature conditions in the charged state, generate gas, and deteriorate such as in lowering of battery capacity. In the worst case, a runaway reaction occurs inside the battery, which may pose serious hazards such as battery burst or fire. There have been various studies of nonaqueous solvents and electrolytes to overcome such drawbacks.

A nonaqueous electrolytic solution containing a cyclic phosphorus compound having a biphenyl structure has been proposed for a method of improving the characteristics of lithium ion secondary batteries (see Patent Document 1). The phosphorus compound contained in the electrolytic solution used in Patent Document 1 is a compound that forms a ring with the oxygen atom and the phosphorus atom of the phosphoric acid ester group. The electrolytic solution is described as being capable of suppressing the oxidative decomposition of the nonaqueous electrolytic solution at the positive electrode, and suppressing lowering of lifetime characteristics.

### CITATION LIST

### Patent Documents

Patent Document 1: JP-A-2009-266663

### SUMMARY OF THE INVENTION

### Problems that the Invention is to Solve

However, the effect of suppressing gas generation in nonaqueous electrolytic solution secondary batteries under high-temperature storage conditions is not sufficient, and there is room for further improvement.

It is accordingly an object of the present invention to provide a secondary-battery nonaqueous electrolytic solution that can suppress gas generation during high-temperature storage in the charged state, and can improve the battery charge and discharge characteristics in nonaqueous electrolytic solution secondary batteries. The invention is also intended to provide a secondary battery using such nonaqueous electrolytic solutions. Another object is to provide a compound represented by the following general formula (1) as an additive of the nonaqueous electrolytic solution.

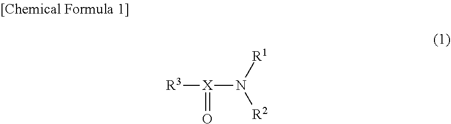

(R¹ and R² represent a hydrogen group, or an organic group of 1 to 10 carbon atoms which may contain heteroatom(s), R³ represents a hydrogen group, or an organic group of 1 to 20 carbon atoms which may contain heteroatom(s), R¹ to R³ may be the same or different, and two of or all three of R¹ to R³ may bind to each other to form ring(s).

At least one of R¹ and R² represents an organic group of 2 to 10 carbon atoms which has a carbon-carbon unsaturated bond not directly bonded to the nitrogen atom, and may contain heteroatom(s).

X represents C, S═O or P(R⁴), where R⁴ represents an organic group of 1 to 10 carbon atoms that may contain heteroatom(s).)

### Means for Solving the Problems

The present inventors conducted intensive studies to solve the foregoing problems, and found that the foregoing problems can be solved by containing the compound of the general formula (1) in an electrolytic solution. The present invention was completed on the basis of this finding.

Specifically, the gist of the present invention includes the following.

(a) A nonaqueous electrolytic solution that comprises an electrolyte and a nonaqueous solvent, the nonaqueous electrolytic solution comprising a compound represented by the following general formula (1),

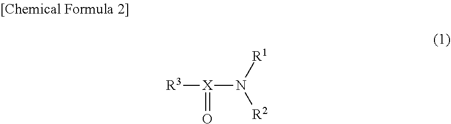

wherein R¹ and R² represents a hydrogen group, or an organic group of 1 to 10 carbon atoms which may contain heteroatom(s), R³ represents a hydrogen group, or an organic group of 1 to 20 carbon atoms which may contain heteroatom(s), R¹ to R³ may be the same or different, and two of or all three of R¹ to R³ may bind to each other to form ring(s),

in which at least one of R¹ and R² represents an organic group of 2 to 10 carbon atoms which has a carbon-carbon unsaturated bond not directly bonded to the nitrogen atom, and may contain heteroatom(s), and

X represents C, S═O or P(R⁴), and R⁴ represents an organic group of 1 to 10 carbon atoms which may contain heteroatom(s).

(b) The nonaqueous electrolytic solution according to the item (a) above, wherein at least one of R¹ and R² in the general formula (1) is an organic group of 2 to 10 carbon atoms which has a carbon-carbon unsaturated bond at a terminal, and may contain heteroatom(s).

(c) The nonaqueous electrolytic solution according to the item (b) above, wherein at least one of R¹ and R² in the general formula (1) is an allyl group or a propargyl group.

(d) The nonaqueous electrolytic solution according to any one of the items (a) to (c), wherein the nonaqueous electrolytic solution comprises the compound represented by the general formula (1) in an amount of 0.001 mass % or more and 10 mass % or less.

(e) The nonaqueous electrolytic solution according to any one of the items (a) to (d), wherein the nonaqueous electrolytic solution comprises at least one compound selected from the group consisting of a cyclic carbonate having a carbon-carbon unsaturated bond, a cyclic carbonate having a halogen atom, monofluorophosphate, difluorophosphate, a nitrile compound, and an isocyanate compound.

(f) A nonaqueous electrolytic solution battery comprising: a negative electrode and a positive electrode capable of storing and releasing lithium ions; and a nonaqueous electrolytic solution,

wherein the nonaqueous electrolytic solution is the nonaqueous electrolytic solution of any one of the items (a) to (e).

### Advantage of the Invention

When used for batteries, the electrolytic solution according to the present invention can suppress gas generation during high-temperature storage in the charged state of the battery, and can provide a battery that excels in charge and discharge characteristics, specifically voltage and capacity during high-temperature storage. The compound according to the present invention is useful as a component of the battery electrolytic solution having the foregoing effect.

### MODE FOR CARRYING OUT THE INVENTION

An embodiment of the present invention is described below in detail. The following descriptions represent one example (a representative example) of the embodiment of the invention, and the invention should not be construed as being specified by the contents described below, and can be implemented in any ways.

As used herein, “weight %”, “parts by weight” and “mass %”, and “parts by mass” are synonymous to each other.

### [1. Nonaqueous Electrolytic Solution]

A nonaqueous electrolytic solution according to the present invention contains an electrolyte and a nonaqueous solvent dissolving the electrolyte, as with the case of common nonaqueous electrolytic solutions, and further contains the compound represented by the foregoing general formula (1).

### [1-1. Electrolyte]

The electrolyte used in the nonaqueous electrolytic solution of the present invention is not limited, and any known electrolyte may be used, provided that it is usable for the nonaqueous electrolytic solution secondary battery of interest. When the nonaqueous electrolytic solution of the present invention is used for a lithium ion secondary battery, a lithium salt is typically used as the electrolyte.

Specific examples of the electrolyte include inorganic lithium salts such as LiClO₄, LiAsF₆, LiPF₆, Li₂CO₃, LiBF₄, LiSbF₆, LiSO₃F, and LiN(FSO₂)₂; fluorine-containing organic lithium salts such as LiCF₃SO₃, LiN(CF₃SO₂)₂, LiN(C₂FsSO₂), lithium cyclic 1,3-hexafluoropropane disulfonylimide, lithium cyclic 1,2-tetrafluoroethane disulfonylimide, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂FsSO₂)₂, LiBF₂(CF₃)₂, LiBF₂(C₂F₅)₂, LiBF₂(CF₃SO₂)₂, and LiBF₂(C₂F₅SO₂)₂; and dicarboxylic acid-containing complex lithium salts such as lithium bis(oxalate)borate, lithium difluoro(oxalate)borate, lithium tris(oxalate)phosphate, lithium difluoro bis(oxalate)phosphate, and lithium tetrafluoro(oxalate)phosphate.

Preferred from the viewpoints of the solubility and the degree of dissociation for the nonaqueous solvent, electrical conductivity, and the battery characteristics of the product battery are LiPF₆, LiBF₄, LiSO₃F, LiN(FSO₂)₂, LiCF₃SO₃, LiN(CF₃SO₂)₂, LiN(C₂FsSO₂)₂, lithium cyclic 1,3-hexafluoropropane disulfonylimide, lithium cyclic 1,2-tetrafluoroethane disulfonylimide, lithium bis(oxalate)borate, lithium difluoro(oxalate)borate, lithium tris(oxalate)phosphate, lithium difluoro bis(oxalate)phosphate, and lithium tetrafluoro(oxalate)phosphate, particularly LiPF₆ and LiBF₄.

The electrolyte may be used alone, or two or more may be used in any combination and/or proportion. It is preferable to use two specific inorganic lithium salts in combination, or use an inorganic lithium salt with a fluorine-containing organic lithium salt, because it can suppress gas generation during trickle charging, or suppress deterioration after high-temperature storage. It is particularly preferable to use LiPF₆ and LiBF₄ in combination, or use an inorganic lithium salt such as LiPF₆ and LiBF₄ in combination with a fluorine-containing organic lithium salt such as LiCF₃SO₃, LiN(CF₃SO₂)₂, and LiN(C₂FsSO₂)₂.

When using LiPF₆ and LiBF₄ in combination, LiBF₄ is typically contained in a proportion of 0.01 mass % or more and 50 mass % or less with respect to the total electrolyte. The proportion is preferably 0.05 mass % or more, more preferably 0.1 mass % or more, and preferably 20 mass % or less, more preferably 10 mass % or less, particularly preferably 5 mass % or less, most preferably 3 mass % or less. In these proportion ranges, the desired effect can be obtained more easily, and the resistance increase in the electrolytic solution due to the low degree of dissociation of LiBF₄ can be suppressed.

When an inorganic lithium salt such as LiPF₆ and LiBF₄ is used in combination with an inorganic lithium salt (such as LiSO₃F and LiN(FSO₂)₂), a fluorine-containing organic lithium salt (such as LiCF₃SO₃, LiN(CF₃SO₂)₂, LiN(C₂FsSO₂)₂, lithium cyclic 1,3-hexafluoropropane disulfonylimide, lithium cyclic 1,2-tetrafluoroethane disulfonylimide, LiN(CF₃SO₂)(C₄F₉SO₂), LiC(CF₃SO₂)₃, LiPF₄(CF₃)₂, LiPF₄(C₂F₅)₂, LiPF₄(CF₃SO₂)₂, LiPF₄(C₂FsSO₂)₂, LiBF₂(CF₃)₂, LiBF₂(C₂F₅)₂, LiBF₂(CF₃SO₂)₂, and LiBF₂(C₂FsSO₂)₂), or a dicarboxylic acid-containing complex lithium salt (such as lithium bis(oxalate)borate, lithium tris(oxalate)phosphate, lithium difluorooxalateborate, lithium tri(oxalate)phosphate, lithium difluoro bis(oxalate)phosphate, and lithium tetrafluoro(oxalate)phosphate), the proportion of the inorganic lithium salt with respect to the total electrolyte is typically 70 mass % or more, preferably 80 mass % or more, more preferably 85 mass % or more, and typically 99 mass % or less, preferably 95 mass % or less.

The concentration of the lithium salt in the nonaqueous electrolytic solution of the present invention may be any concentration, as long as it does not impair the substance of the present invention, and is typically 0.5 mol/L or more, preferably 0.6 mol/L or more, more preferably 0.8 mol/L or more, and is typically 3 mol/L or less, preferably 2 mol/L or less, more preferably 1.8 mol/L or less, further preferably 1.6 mol/L or less. A lithium salt concentration in these ranges provides a sufficient electric conductivity in the nonaqueous electrolytic solution, and suppresses lowering of electric conductivity due to viscosity increase, and the performance drop of the nonaqueous electrolytic solution secondary battery.

### [1-2. Nonaqueous Solvent]

A known nonaqueous electrolytic solution solvent may be appropriately selected and used as the nonaqueous solvent contained in the nonaqueous electrolytic solution of the present invention. The nonaqueous solvent may be used alone, or two or more may be used in any combination and/or proportion.

Examples of the typical nonaqueous solvents include cyclic carbonates, chain carbonates, chain or cyclic carboxylic acid esters, chain or cyclic ethers, phosphorus-containing organic solvents, sulfur-containing organic solvents, and aromatic fluorine-containing solvents.

Examples of the cyclic carbonates include cyclic carbonates such as ethylene carbonate, propylene carbonate, and butylene carbonate. The cyclic carbonates are typically of 3 to 6 carbon atoms.

Preferred among these examples are ethylene carbonate and propylene carbonate, because these have high dielectric constants and easily dissolve the electrolyte, and provide desirable cycle characteristics in the product nonaqueous electrolytic solution secondary battery. Ethylene carbonate is particularly preferred. Some of the hydrogen atoms in these compounds may be substituted with fluorine.

Examples of such fluorine-substituted cyclic carbonates include fluorine-substituted cyclic carbonates of 3 to 5 carbon atoms such as fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene carbonate, of which fluoroethylene carbonate, 1,2-difluoroethylene carbonate, and trifluoromethylethylene carbonate are preferred.

Examples of the chain carbonates include chain carbonates such as dimethyl carbonate, ethyl methyl carbonate, diethyl carbonate, methyl-n-propyl carbonate, ethyl-n-propyl carbonate, and di-n-propyl carbonate. The number of carbons atoms forming the alkyl group is preferably 1 to 5, particularly preferably 1 to 4. Dimethyl carbonate, diethyl carbonate, and ethyl methyl carbonate are preferred from the viewpoint of improving battery characteristics.

Some of the hydrogen atoms of the alkyl group may be substituted with fluorine. Examples of such fluorine-substituted chain carbonates include bis(fluoromethyl)carbonate, bis(difluoromethyl)carbonate, bis(trifluoromethyl)carbonate, bis(2-fluoroethyl)carbonate, bis(2,2-difluoroethyl)carbonate, bis(2,2,2-trifluoroethyl)carbonate, 2-fluoroethyl methyl carbonate, 2,2-difluoroethyl methyl carbonate, and 2,2,2-trifluoroethyl methyl carbonate.

Examples of the chain carboxylic acid esters include methyl acetate, ethyl acetate, propyl acetate, isopropyl acetate, butyl acetate, sec-butyl acetate, isobutyl acetate, t-butyl acetate, methyl propionate, ethyl propionate, propyl propionate, isopropyl propionate, methyl butyrate, ethyl butyrate, propyl butyrate, methyl valerate, ethyl valerate, and compounds in which some of the hydrogen atoms of these compounds are substituted with fluorine.

Examples of such fluorine-substituted compounds include trifluoromethyl acetate, trifluoroethyl acetate, trifluoropropyl acetate, trifluorobutyl acetate, and 2,2,2-trifluoroethyl trifluoroacetate. Of these, methyl acetate, ethyl acetate, propyl acetate, butyl acetate, methyl propionate, ethyl propionate, propyl propionate, methyl butyrate, ethyl butyrate, and methyl valerate are preferred from the viewpoint of improving battery characteristics.

Examples of the cyclic carboxylic acid esters include γ-butyrolactone, γ-valerolactone, and compounds in which some of the hydrogen atoms of these compounds are substituted with fluorine. Preferred is γ-butyrolactone.

Examples of the chain ethers include dimethoxymethane, 1,1-dimethoxyethane, 1,2-dimethoxyethane, diethoxymethane, 1,1-diethoxyethane, 1,2-diethoxyethane, ethoxymethoxymethane, 1,1-ethoxymethoxyethane, 1,2-ethoxymethoxyethane, and compounds in which some of the hydrogen atoms of these compounds are substituted with fluorine.

Examples of such compounds in which some of the hydrogen atoms of these compounds are substituted with fluorine include bis(trifluoroethoxy)ethane, ethoxytrifluoroethoxyethane, methoxytrifluoroethoxyethane, 1,1,1,2,2,3,4,5,5,5-decafluoro-3-methoxy-4-trifluoromethyl-pentane, 1,1,1,2,2,3,4,5,5,5-decafluoro-3-ethoxy-4-trifluoromethyl-pentane, 1,1,1,2,2,3,4,5,5,5-decafluoro-3-propoxy-4-trifluoromethyl-pentane, 1,1,2,2-tetrafluoroethyl-2,2,3,3-tetrafluoropropylether, and 2,2-difluoroethyl-2,2,3,3-tetrafluoropropylether. Preferred are 1,2-dimethoxyethane, and 1,2-diethoxyethane.

Examples of the cyclic ethers include tetrahydrofuran, 2-methyltetrahydrofuran, and compounds in which some of the hydrogen atoms of these compounds are substituted with fluorine.

Examples of the phosphorus-containing organic solvents include trimethyl phosphate, triethyl phosphate, dimethylethyl phosphate, methyldiethyl phosphate, methyl ethylene phosphate, ethyl ethylene phosphate, triphenyl phosphate, trimethyl phosphate, triethyl phosphate, triphenyl phosphate, trimethylphosphine oxide, triethylphosphine oxide, triphenylphosphine oxide, and compounds in which some of the hydrogen atoms of these compounds are substituted with fluorine.

Examples of such compounds in which some of the hydrogen atoms of these compounds are substituted with fluorine include tris(2,2,2-trifluoroethyl)phosphate, and tris(2,2,3,3,3-pentafluoropropyl)phosphate.

Examples of the sulfur-containing organic solvents include sulfolane, 2-methyl sulfolane, 3-methyl sulfolane, dimethyl sulfone, diethyl sulfolane, ethyl methyl sulfone, methyl propyl sulfone, dimethyl sulfoxide, methyl methane sulfonate, ethyl methane sulfonate, methyl ethane sulfonate, ethyl ethane sulfonate, dimethyl sulfate, diethyl sulfate, butyl sulfate, and compounds in which some of the hydrogen atoms of these compounds are substituted with fluorine.

Examples of the aromatic fluorine-containing solvents include fluorobenzene, difluorobenzene, trifluorobenzene, tetrafluorobenzene, pentafluorobenzene, hexafluorobenzene, and benzotrifluoride.

Among these nonaqueous solvents, it is preferable to use the cyclic carbonates ethylene carbonate and/or propylene carbonate. It is more preferable to use these cyclic carbonates in combination with the chain carbonates from the viewpoint of realizing high conductivity and low viscosity at the same time in the electrolytic solution.

When using a combination of the cyclic carbonate and the chain carbonate as the nonaqueous solvent, the chain carbonate is preferably contained in the nonaqueous solvent of the nonaqueous electrolytic solution of the present invention in typically 20 volume % or more, preferably 40 volume % or more, and typically 95 volume % or less, preferably 90 volume % or less.

On the other hand, the cyclic carbonate is preferably contained in the nonaqueous solvent of the nonaqueous electrolytic solution of the present invention in typically 5 volume % or more, preferably 10 volume % or more, and typically 80 volume % or less, preferably 60 volume % or less. With the chain carbonate contained in these proportions, it is possible to suppress a viscosity increase in the nonaqueous electrolytic solution of the present invention, and the lowering of the electric conductivity in the nonaqueous electrolytic solution of the present invention caused when the degree of dissociation of the electrolyte lithium salt decreases. The fluoroethylene carbonate may be used as a solvent or an additive, and, in this case, the content thereof is not limited to the foregoing contents.

In this specification, the volume of the nonaqueous solvent is a measured value at 25° C. For nonaqueous solvents such as ethylene carbonate that are solid at 25° C., a measured value at the melting point is used.

The nonaqueous electrolytic solution of the present invention contains the compound represented by the following general formula (1).

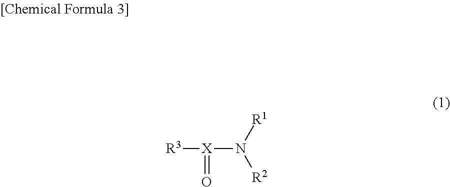

(R¹ and R² represent hydrogen groups, or organic groups of 1 to 10 carbon atoms that may contain heteroatom(s), R³ represents a hydrogen group, or an organic group of 1 to 20 carbon atoms that may contain heteroatom(s), R¹ to R³ may be the same or different, and two of or all three of R¹ to R³ may bind to each other to form ring(s).

At least one of R¹ and R² represents an organic group of 2 to 10 carbon atoms that has a carbon-carbon unsaturated bond not directly bonded to the nitrogen atom, and that may contain heteroatom(s).

X represents C, S═O or P(R⁴), where R⁴ represents an organic group of 1 to 10 carbon atoms that may contain heteroatom(s).)

As used herein, “hydrogen group” means hydrogen atom.

Examples of the heteroatom of the organic groups that may contain heteroatom(s) represented by R¹ to R³ of the general formula (1) include: halogen atoms such as fluorine, chlorine, bromine, and iodine; functional groups of carbon and oxygen such as a carbonyl group, a carboxylic acid ester group, and a carbonate ester; functional groups of carbon, oxygen, and nitrogen such as a carboxylic acid amide, a carbamate group, a urea group, a cyanate group, and an isocyanate group; functional groups of carbon and nitrogen such as a nitrile group, and an isonitrile group; functional groups of nitrogen and oxygen such as a nitro group, and a nitroso group; functional groups of nitrogen such as an amino group; functional groups of oxygen such as an ether group; functional groups of silicon such as a silyl group; functional groups of sulfur and oxygen such as a sulfoxide group, a sulfonyl group, a sulfonic acid ester group, and a sulfuric acid ester group; functional groups of sulfur, oxygen, and nitrogen such as a sulfonic acid amide group, and sulfuric acid amide group; functional groups of sulfur such as a sulfide group, and a disulfide group; and functional groups containing phosphorus such as a phosphine group, a phosphoric acid ester, a phosphonic ester group, a phosphinic ester group, phosphoric amide, phosphonic amide, and phosphinic amide.

Examples of the organic groups include, saturated or unsaturated hydrocarbon groups, and aromatic hydrocarbon groups.

Examples of the saturated hydrocarbon groups include linear or branched alkyl groups such as a methyl group, an ethyl group, an n-propyl group, and i-propyl group, an n-butyl group, and a sec-butyl group; and cyclic alkyl groups such as a cyclopropyl group, a cyclopentyl group, and a cyclohexyl group.

Examples of the unsaturated hydrocarbon groups include alkenyl groups such as a vinyl group, an allyl group, and a 1-propenyl group; and alkynyl groups such as an ethynyl group, a propargyl group, and a 1-propynyl group.

Examples of the aromatic hydrocarbon groups include aryl groups such as a phenyl group, and a tolyl group; and aralkyl groups such as a benzyl group, and a phenethyl group.

The number of carbon atoms in the saturated hydrocarbon groups is typically 1 to 10, preferably 6 or less, further preferably 4 or less. The number of carbon atoms in the unsaturated hydrocarbon groups is typically 2 to 10, preferably 6 or less, further preferably 4 or less. The number of carbon atoms in the aromatic hydrocarbon groups is typically 6 to 10, preferably 8 or less.

At least one of R¹ and R² in the general formula (1) needs to be an organic group of 2 to 10 carbon atoms that has a carbon-carbon unsaturated bond not directly bonded to the nitrogen atom, and that may contain heteroatom(s).

The carbon-carbon unsaturated bond not directly bonded to the nitrogen atom excludes unsaturated bonds attached to the carbon atom adjacent to the nitrogen atom, such as in-N—C═C—.

When the carbon-carbon unsaturated bond is not contained, the effect of suppressing gas generation during the high-temperature storage of battery suffers, and the capacity after high-temperature storage becomes inferior.

Of these carbon-carbon unsaturated bonds, it is preferable from the viewpoint of suppressing gas generation during high-temperature storage that at least one of R¹ and R² of the general formula (1) is an organic group of 2 to 10 carbon atoms that has a carbon-carbon unsaturated bond at the terminal, and that may contain heteroatom(s). It is also preferable that the organic group of 2 to 10 carbon atoms that has a carbon-carbon unsaturated bond at the terminal and that may contain heteroatom(s) is an allyl group or a propargyl group.

One of R¹ and R² in the general formula (1) may have a carbon-carbon unsaturated bond directly bonded to the nitrogen atom, provided that at least one of R¹ and R² in the general formula (1) has a carbon-carbon unsaturated bond not directly bonded to the nitrogen atom.

Specific examples of such combinations include the following.

R¹: vinyl group, R²: allyl group

R¹: vinyl group, R²: propargyl group

R¹: 1-propenyl group, R²: allyl group

R¹: 1-propenyl group, R²: propargyl group

X in the general formula (1) represents C, S═O or P(R⁴), where R⁴ represents an organic group of 1 to 10 carbon atoms that may contain heteroatom(s). Here, X and R³ do not form a ring. When X is P(R⁴), R³ and R⁴ do not bind to each other to form a ring when either one of R³ and R⁴ has an oxygen atom, and the oxygen atom is directly bonded to the phosphorus atom of P(R⁴), and when the other of R³ and R⁴ has a P—C bond attached to the phosphorus atom of P(R⁴).

Specific examples of the compounds represented by the general formula (1) include the following.

### 1. Chain Carboxylic Acid Amide

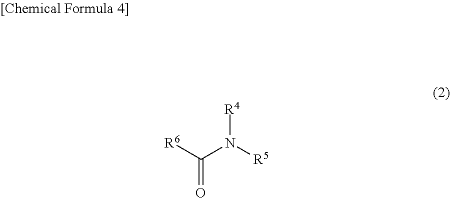

Examples of R⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond, such as an allyl group, a propargyl group, a 3-butenyl group, a 3-butynyl group, a 4-pentenyl group, and a 4-pentynyl group are preferred from the viewpoint of battery characteristics.

Examples of R⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond, such as an allyl group, a propargyl group, a 3-butenyl group, a 3-butynyl group, a 4-pentenyl group, and a 4-pentynyl group are preferred from the viewpoint of battery characteristics. Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁶ includes a hydrogen group, a methyl group, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of the substituents containing a heteroatom include methoxymethyl, ethoxymethyl, an acetylmethyl group, a cyanomethyl group, a 1-cyanoethyl group, and a 2-cyanoethyl group.

Preferred as combinations of R⁴ to R⁶ from the viewpoint of battery characteristics are those in which R⁴ is an allyl group or a propargyl group. Examples include the following.

R⁴: allyl group, R⁵: allyl group, R⁶: hydrogen group

R⁴: allyl group, R⁵: hydrogen group, R⁶: hydrogen group

R⁴: propargyl group, R⁵: propargyl group, R⁶: hydrogen group

R⁴: propargyl group, R⁵: hydrogen group, R⁶: hydrogen group

R⁴: allyl group, R⁵: methyl group, R⁶: hydrogen group

R⁴: propargyl group, R⁵: methyl group, R⁶: hydrogen group

R⁴: allyl group, R⁵: ethyl group, R¹: hydrogen group

R⁴: propargyl group, R⁵: ethyl group, R⁶: hydrogen group

R⁴: allyl group, R⁵: allyl group, R⁶: methyl group

R⁴: allyl group, R⁵: hydrogen group, R⁶: methyl group

R⁴: propargyl group, R⁵: propargyl group, R⁶: methyl group

R⁴: propargyl group, R⁵: hydrogen group, R⁶: methyl group

R⁴: allyl group, R⁵: methyl group, R⁶: methyl group

R⁴: propargyl group, R⁵: methyl group, R⁶: methyl group

R⁴: allyl group, R⁵: ethyl group, R⁶: methyl group

R⁴: propargyl group, R⁵: ethyl group, R⁶: methyl group

R⁴: allyl group, R⁵: allyl group, R⁶: ethyl group

R⁴: allyl group, R⁵: hydrogen group, R⁶: ethyl group

R⁴: propargyl group, R⁵: propargyl group, R⁶: ethyl group

R⁴: propargyl group, R⁵: hydrogen group, R⁶: ethyl group

R⁴: allyl group, R⁵: methyl group, R⁶: ethyl group

R⁴: propargyl group, R⁵: methyl group, R⁶: ethyl group

R⁴: allyl group, R⁵: ethyl group, R⁶: ethyl group

R⁴: propargyl group, R⁵: ethyl group, R⁶: ethyl group

R⁴: allyl group, R⁵: allyl group, R⁶: propyl group

R⁴: allyl group, R⁵: hydrogen group, R⁶: propyl group

R⁴: propargyl group, R⁵: propargyl group, R⁶: propyl group

R⁴: propargyl group, R⁵: hydrogen group, R⁶: propyl group

R⁴: allyl group, R⁵: methyl group, R⁶: propyl group

R⁴: propargyl group, R⁵: methyl group, R⁶: propyl group

R⁴: allyl group, R⁵: ethyl group, R⁶: propyl group

R⁴: propargyl group, R⁵: ethyl group, R⁶: propyl group

R⁴: allyl group, R⁵: allyl group, R⁶: isopropyl group

R⁴: allyl group, R⁵: hydrogen group, R⁶: isopropyl group

R⁴: propargyl group, R⁵: propargyl group, R⁶: isopropyl group

R⁴: propargyl group, R⁵: hydrogen group, R⁶: isopropyl group

R⁴: allyl group, R⁵: methyl group, R⁶: isopropyl group

R⁴: propargyl group, R⁵: methyl group, R⁶: isopropyl group

R⁴: allyl group, R⁵: ethyl group, R⁶: isopropyl group

R⁴: propargyl group, R⁵: ethyl group, R⁶: isopropyl group

R⁴: allyl group, R⁵: allyl group, R⁶: butyl group

R⁴: allyl group, R⁵: hydrogen group, R⁶: butyl group

R⁴: propargyl group, R⁵: propargyl group, R⁶: butyl group

R⁴: propargyl group, R⁵: hydrogen group, R⁶: butyl group

R⁴: allyl group, R⁵: methyl group, R⁶: butyl group

R⁴: propargyl group, R⁵: methyl group, R⁶: butyl group

R⁴: allyl group, R⁵: ethyl group, R⁶: butyl group

R⁴: propargyl group, R⁵: ethyl group, R⁶: butyl group

R⁴: allyl group, R⁵: allyl group, R⁶: sec-butyl group

R⁴: allyl group, R⁵: hydrogen group, R⁶: sec-butyl group

R⁴: propargyl group, R⁵: propargyl group, R⁶: sec-butyl group

R⁴: propargyl group, R⁵: hydrogen group, R⁶: sec-butyl group

R⁴: allyl group, R⁵: methyl group, R⁶: sec-butyl group

R⁴: propargyl group, R⁵: methyl group, R⁶: sec-butyl group

R⁴: allyl group, R⁵: ethyl group, R⁶: sec-butyl group

R⁴: propargyl group, R⁵: ethyl group, R⁶: sec-butyl group

R⁴: allyl group, R⁵: allyl group, R⁶: tert-butyl group

R⁴: allyl group, R⁵: hydrogen group, R⁶: tert-butyl group

R⁴: propargyl group, R⁵: propargyl group, R⁶: tert-butyl group

R⁴: propargyl group, R⁵: hydrogen group, R⁶: tert-butyl group

R⁴: allyl group, R⁵: methyl group, R⁶: tert-butyl group

R⁴: propargyl group, R⁵: methyl group, R⁶: tert-butyl group

R⁴: allyl group, R⁵: ethyl group, R⁶: tert-butyl group

R⁴: propargyl group, R⁵: ethyl group, R⁶: tert-butyl group

R⁴: allyl group, R⁵: allyl group, R⁶: pentyl group

R⁴: allyl group, R⁵: hydrogen group, R⁶: pentyl group

R⁴: propargyl group, R⁵: propargyl group, R⁶: pentyl group

R⁴: propargyl group, R⁵: hydrogen group, R⁶: pentyl group

R⁴: allyl group, R⁵: methyl group, R⁶: pentyl group

R⁴: propargyl group, R⁵: methyl group, R⁶: pentyl group

R⁴: allyl group, R⁵: ethyl group, R⁶: pentyl group

R⁴: propargyl group, R⁵: ethyl group, R⁶: pentyl group

R⁴: allyl group, R⁵: allyl group, R⁶: hexyl group

R⁴: allyl group, R⁵: hydrogen group, R⁶: hexyl group

R⁴: propargyl group, R⁵: propargyl group, R⁶: hexyl group

R⁴: propargyl group, R⁵: hydrogen group, R⁶: hexyl group

R⁴: allyl group, R⁵: methyl group, R⁶: hexyl group

R⁴: propargyl group, R⁵: methyl group, R⁶: hexyl group

R⁴: allyl group, R⁵: ethyl group, R⁶: hexyl group

R⁴: propargyl group, R⁵: ethyl group, R⁶: hexyl group

R⁴: allyl group, R⁵: allyl group, R⁶: heptyl group

R⁴: allyl group, R⁵: hydrogen group, R⁶: heptyl group

R⁴: propargyl group, R⁵: propargyl group, R⁶: heptyl group

R⁴: propargyl group, R⁵: hydrogen group, R⁶: heptyl group

R⁴: allyl group, R⁵: methyl group, R⁶: heptyl group

R⁴: propargyl group, R⁵: methyl group, R⁶: heptyl group

R⁴: allyl group, R⁵: ethyl group, R⁶: heptyl group

R⁴: propargyl group, R⁵: ethyl group, R⁶: heptyl group

R⁴: allyl group, R⁵: allyl group, R⁶: octyl group

R⁴: allyl group, R⁵: hydrogen group, R⁶: octyl group

R⁴: propargyl group, R⁵: propargyl group, R⁶: octyl group

R⁴: propargyl group, R⁵: hydrogen group, R⁶: octyl group

R⁴: allyl group, R⁵: methyl group, R⁶: octyl group

R⁴: propargyl group, R⁵: methyl group, R⁶: octyl group

R⁴: allyl group, R⁵: ethyl group, R⁶: octyl group

R⁴: propargyl group, R⁵: ethyl group, R⁶: octyl group

R⁴: allyl group, R⁵: allyl group, R⁶: nonyl group

R⁴: allyl group, R⁵: hydrogen group, R⁶: nonyl group

R⁴: propargyl group, R⁵: propargyl group, R⁶: nonyl group

R⁴: propargyl group, R⁵: hydrogen group, R⁶: nonyl group

R⁴: allyl group, R⁵: methyl group, R⁶: nonyl group

R⁴: propargyl group, R⁵: methyl group, R⁶: nonyl group

R⁴: allyl group, R⁵: ethyl group, R⁶: nonyl group

R⁴: propargyl group, R⁵: ethyl group, R⁶: nonyl group

R⁴: allyl group, R⁵: allyl group, R⁶: decyl group

R⁴: allyl group, R⁵: hydrogen group, R⁶: decyl group

R⁴: propargyl group, R⁵: propargyl group, R⁶: decyl group

R⁴: propargyl group, R⁵: hydrogen group, R⁶: decyl group

R⁴: allyl group, R⁵: methyl group, R⁶: decyl group

R⁴: propargyl group, R⁵: methyl group, R⁶: decyl group

R⁴: allyl group, R⁵: ethyl group, R⁶: decyl group

R⁴: propargyl group, R⁵: ethyl group, R⁶: decyl group

R⁴: allyl group, R⁵: allyl group, R⁶: cyclohexyl group

R⁴: allyl group, R⁵: hydrogen group, R⁶: cyclohexyl group

R⁴: propargyl group, R⁵: propargyl group, R⁶: cyclohexyl group

R⁴: propargyl group, R⁵: hydrogen group, R⁶: cyclohexyl group

R⁴: allyl group, R⁵: methyl group, R⁶: cyclohexyl group

R⁴: propargyl group, R⁵: methyl group, R⁶: cyclohexyl group

R⁴: allyl group, R⁵: ethyl group, R⁶: cyclohexyl group

R⁴: propargyl group, R⁵: ethyl group, R⁶: cyclohexyl group

R⁴: allyl group, R⁵: allyl group, R⁶: phenyl group

R⁴: allyl group, R⁵: hydrogen group, R⁶: phenyl group

R⁴: propargyl group, R⁵: propargyl group, R⁶: phenyl group

R⁴: propargyl group, R⁵: hydrogen group, R⁶: phenyl group

R⁴: allyl group, R⁵: methyl group, R⁶: phenyl group

R⁴: propargyl group, R⁵: methyl group, R⁶: phenyl group

R⁴: allyl group, R⁵: ethyl group, R⁶: phenyl group

R⁴: propargyl group, R⁵: ethyl group, R⁶: phenyl group

R⁴: allyl group, R⁵: allyl group, R⁶: vinyl group

R⁴: allyl group, R⁵: hydrogen group, R⁶: vinyl group

R⁴: propargyl group, R⁵: propargyl group, R⁶: vinyl group

R⁴: propargyl group, R⁵: hydrogen group, R⁶: vinyl group

R⁴: allyl group, R⁵: methyl group, R⁶: vinyl group

R⁴: propargyl group, R⁵: methyl group, R⁶: vinyl group

R⁴: allyl group, R⁵: ethyl group, R⁶: vinyl group

R⁴: propargyl group, R⁵: ethyl group, R⁶: vinyl group

R⁴: allyl group, R⁵: allyl group, R⁶: isopropenyl group

R⁴: allyl group, R⁵: hydrogen group, R⁶: isopropenyl group

R⁴: propargyl group, R⁵: propargyl group, R⁶: isopropenyl group

R⁴: propargyl group, R⁵: hydrogen group, R⁶: isopropenyl group

R⁴: allyl group, R⁵: methyl group, R⁶: isopropenyl group

R⁴: propargyl group, R⁵: methyl group, R⁶: isopropenyl group

R⁴: allyl group, R⁵: ethyl group, R⁶: isopropenyl group

R⁴: propargyl group, R⁵: ethyl group, R⁶: isopropenyl group

R⁴: allyl group, R⁵: allyl group, R⁶: 1-propenyl group

R⁴: allyl group, R⁵: hydrogen group, R⁶: 1-propenyl group

R⁴: propargyl group, R⁵: propargyl group, R⁶: 1-propenyl group

R⁴: propargyl group, R⁵: hydrogen group, R⁶: 1-propenyl group

R⁴: allyl group, R⁵: methyl group, R⁶: 1-propenyl group

R⁴: propargyl group, R⁵: methyl group, R⁶: 1-propenyl group

R⁴: allyl group, R⁵: ethyl group, R⁶: 1-propenyl group

R⁴: propargyl group, R¹: ethyl group, R⁶: 1-propenyl group

R⁴: allyl group, R⁵: allyl group, R⁶: cyanomethyl group

R⁴: allyl group, R⁵: hydrogen group, R⁶: cyanomethyl group

R⁴: propargyl group, R⁵: propargyl group, R⁶: cyanomethyl group

R⁴: propargyl group, R⁵: hydrogen group, R⁶: cyanomethyl group

R⁴: allyl group, R⁵: methyl group, R⁶: cyanomethyl group

R⁴: propargyl group, R⁵: methyl group, R⁶: cyanomethyl group

R⁴: allyl group, R⁵: ethyl group, R⁶: cyanomethyl group

R⁴: propargyl group, R⁵: ethyl group, R⁶: cyanomethyl group

R⁴: allyl group, R⁵: allyl group, R⁶: 1-cyanoethyl group

R⁴: allyl group, R⁵: hydrogen group, R⁶: 1-cyanoethyl group

R⁴: propargyl group, R⁵: propargyl group, R⁶: 1-cyanoethyl group

R⁴: propargyl group, R⁵: hydrogen group, R⁶: 1-cyanoethyl group

R⁴: allyl group, R⁵: methyl group, R⁶: 1-cyanoethyl group

R⁴: propargyl group, R⁵: methyl group, R⁶: 1-cyanoethyl group

R⁴: allyl group, R⁵: ethyl group, R⁶: 1-cyanoethyl group

R⁴: propargyl group, R⁵: ethyl group, R⁶: 1-cyanoethyl group

R⁴: allyl group, R⁵: allyl group, R⁶: 2-cyanoethyl group

R⁴: allyl group, R⁵: hydrogen group, R⁶: 2-cyanoethyl group

R¹: propargyl group, R⁵: propargyl group, R¹: 2-cyanoethyl group

R⁴: propargyl group, R⁵: hydrogen group, R⁶: 2-cyanoethyl group

R⁴: allyl group, R⁵: methyl group, R⁶: 2-cyanoethyl group

R⁴: propargyl group, R⁵: methyl group, R⁶: 2-cyanoethyl group

R⁴: allyl group, R⁵: ethyl group, R⁶: 2-cyanoethyl group

R⁴: propargyl group, R⁵: ethyl group, R⁶: 2-cyanoethyl group

Preferred examples from the viewpoints of suppressing gas generation during high-temperature storage, and improving the charge and discharge characteristics of battery include:

R⁴: allyl group, R⁵: allyl group, R⁶: hydrogen group

R⁴: allyl group, R⁵: hydrogen group, R⁶: hydrogen group

R⁴: propargyl group, R⁵: hydrogen group, R⁶: hydrogen group

R⁴: allyl group, R⁵: methyl group, R⁶: hydrogen group

R⁴: allyl group, R⁵: ethyl group, R⁶: hydrogen group

R⁴: allyl group, R⁵: allyl group, R⁶: methyl group

R⁴: allyl group, R⁵: hydrogen group, R⁶: methyl group

R⁴: propargyl group, R⁵: hydrogen group, R⁶: methyl group

R⁴: allyl group, R⁵: methyl group, R⁶: methyl group

R⁴: allyl group, R⁵: ethyl group, R⁶: methyl group

R⁴: allyl group, R⁵: allyl group, R⁶: ethyl group

R⁴: allyl group, R⁵: hydrogen group, R⁶: ethyl group

R⁴: propargyl group, R⁵: hydrogen group, R⁶: ethyl group

R⁴: allyl group, R⁵: methyl group, R⁶: ethyl group

R⁴: allyl group, R⁵: ethyl group, R⁶: ethyl group

R⁴: allyl group, R⁵: allyl group, R⁶: propyl group

R⁴: allyl group, R⁵: hydrogen group, R⁶: propyl group

R⁴: propargyl group, R⁵: hydrogen group, R⁶: propyl group

R⁴: allyl group, R⁵: methyl group, R⁶: propyl group

R⁴: allyl group, R⁵: ethyl group, R⁶: propyl group

R⁴: allyl group, R⁵: allyl group, R⁶: isopropyl group

R⁴: allyl group, R⁵: hydrogen group, R⁶: isopropyl group

R⁴: propargyl group, R⁵: hydrogen group, R⁶: isopropyl group

R⁴: allyl group, R⁵: methyl group, R⁶: isopropyl group

R⁴: allyl group, R⁵: ethyl group, R⁶: isopropyl group

R⁴: allyl group, R⁵: allyl group, R⁶: butyl group

R⁴: allyl group, R⁵: hydrogen group, R⁶: butyl group

R⁴: propargyl group, R⁵: hydrogen group, R⁶: butyl group

R⁴: allyl group, R⁵: methyl group, R⁶: butyl group

R⁴: allyl group, R⁵: ethyl group, R⁶: butyl group

R⁴: allyl group, R⁵: allyl group, R⁶: sec-butyl group

R⁴: allyl group, R⁵: hydrogen group, R⁶: sec-butyl group

R⁴: propargyl group, R⁵: hydrogen group, R⁶: sec-butyl group

R⁴: allyl group, R⁵: methyl group, R⁶: sec-butyl group

R⁴: allyl group, R⁵: ethyl group, R⁶: sec-butyl group

R⁴: allyl group, R⁵: allyl group, R⁶: tert-butyl group

R⁴: allyl group, R⁵: hydrogen group, R⁶: tert-butyl group

R⁴: propargyl group, R⁵: hydrogen group, R⁶: tert-butyl group

R⁴: allyl group, R⁵: methyl group, R⁶: tert-butyl group

R⁴: allyl group, R⁵: ethyl group, R⁶: tert-butyl group

R⁴: allyl group, R⁵: allyl group, R⁶: pentyl group

R⁴: allyl group, R⁵: hydrogen group, R⁶: pentyl group

R⁴: propargyl group, R⁵: hydrogen group, R⁶: pentyl group

R⁴: allyl group, R⁵: methyl group, R⁶: pentyl group

R⁴: allyl group, R⁵: ethyl group, R⁶: pentyl group

R⁴: allyl group, R⁵: allyl group, R⁶: hexyl group

R⁴: allyl group, R⁵: hydrogen group, R⁶: hexyl group

R⁴: propargyl group, R⁵: hydrogen group, R⁶: hexyl group

R⁴: allyl group, R⁵: methyl group, R⁶: hexyl group

R⁴: allyl group, R⁵: ethyl group, R⁶: hexyl group

R⁴: allyl group, R⁵: allyl group, R⁶: heptyl group

R⁴: allyl group, R⁵: hydrogen group, R⁶: heptyl group

R⁴: propargyl group, R⁵: hydrogen group, R⁶: heptyl group

R⁴: allyl group, R⁵: methyl group, R⁶: heptyl group

R⁴: allyl group, R⁵: ethyl group, R⁶: heptyl group

R⁴: allyl group, R⁵: allyl group, R⁶: octyl group

R⁴: allyl group, R⁵: hydrogen group, R⁶: octyl group

R⁴: propargyl group, R⁵: hydrogen group, R⁶: octyl group

R⁴: allyl group, R⁵: methyl group, R⁶: octyl group

R⁴: allyl group, R⁵: ethyl group, R⁶: octyl group

R⁴: allyl group, R⁵: allyl group, R⁶: nonyl group

R⁴: allyl group, R⁵: hydrogen group, R⁶: nonyl group

R⁴: propargyl group, R⁵: hydrogen group, R⁶: nonyl group

R⁴: allyl group, R⁵: methyl group, R⁶: nonyl group

R⁴: allyl group, R⁵: ethyl group, R⁶: nonyl group

R⁴: allyl group, R⁵: allyl group, R⁶: decyl group

R⁴: allyl group, R⁵: hydrogen group, R⁶: decyl group

R⁴: propargyl group, R⁵: hydrogen group, R⁶: decyl group

R⁴: allyl group, R⁵: methyl group, R⁶: decyl group

R⁴: allyl group, R⁵: ethyl group, R⁶: decyl group

R⁴: allyl group, R⁵: allyl group, R⁶: cyclohexyl group

R⁴: allyl group, R⁵: hydrogen group, R⁶: cyclohexyl group

R⁴: propargyl group, R⁵: hydrogen group, R⁶: cyclohexyl group

R⁴: allyl group, R⁵: methyl group, R⁶: cyclohexyl group

R⁴: allyl group, R⁵: ethyl group, R⁶: cyclohexyl group

R⁴: allyl group, R⁵: allyl group, R⁶: phenyl group

R⁴: allyl group, R⁵: hydrogen group, R⁶: phenyl group

R⁴: propargyl group, R⁵: hydrogen group, R⁶: phenyl group

R⁴: allyl group, R⁵: methyl group, R⁶: phenyl group

R⁴: allyl group, R⁵: ethyl group, R⁶: phenyl group

R⁴: allyl group, R⁵: allyl group, R⁶: vinyl group

R⁴: allyl group, R⁵: hydrogen group, R⁶: vinyl group

R⁴: propargyl group, R⁵: hydrogen group, R⁶: vinyl group

R⁴: allyl group, R⁵: methyl group, R⁶: vinyl group

R⁴: allyl group, R⁵: ethyl group, R⁶: vinyl group

R⁴: allyl group, R⁵: allyl group, R⁶: isopropenyl group

R⁴: allyl group, R⁵: hydrogen group, R⁶: isopropenyl group

R⁴: propargyl group, R⁵: hydrogen group, R⁶: isopropenyl group

R⁴: allyl group, R⁵: methyl group, R⁶: isopropenyl group

R⁴: allyl group, R⁵: ethyl group, R⁶: isopropenyl group

R⁴: allyl group, R⁵: allyl group, R⁶: 1-propenyl group

R⁴: allyl group, R⁵: hydrogen group, R⁶: 1-propenyl group

R⁴: propargyl group, R⁵: hydrogen group, R⁶: 1-propenyl group

R⁴: allyl group, R⁵: methyl group, R⁶: 1-propenyl group

R⁴: allyl group, R⁵: ethyl group, R⁶: 1-propenyl group

R⁴: allyl group, R⁵: allyl group, R⁶: cyanomethyl group

R⁴: allyl group, R⁵: hydrogen group, R⁶: cyanomethyl group

R⁴: propargyl group, R⁵: hydrogen group, R⁶: cyanomethyl group

R⁴: allyl group, R⁵: methyl group, R⁶: cyanomethyl group

R⁴: allyl group, R⁵: ethyl group, R⁶: cyanomethyl group

R⁴: allyl group, R⁵: allyl group, R⁶: 1-cyanoethyl group

R⁴: allyl group, R⁵: hydrogen group, R⁶: 1-cyanoethyl group

R⁴: propargyl group, R⁵: hydrogen group, R⁶: 1-cyanoethyl group

R⁴: allyl group, R⁵: methyl group, R⁶: 1-cyanoethyl group

R⁴: allyl group, R⁵: ethyl group, R⁶: 1-cyanoethyl group

R⁴: allyl group, R⁵: allyl group, R⁶: 2-cyanoethyl group

R⁴: allyl group, R⁵: hydrogen group, R⁶: 2-cyanoethyl group

R⁴: propargyl group, R⁵: hydrogen group, R⁶: 2-cyanoethyl group

R⁴: allyl group, R⁵: methyl group, R⁶: 2-cyanoethyl group

R⁴: allyl group, R⁵: ethyl group, R⁶: 2-cyanoethyl group

Further preferred examples include the following.

R⁴: allyl group, R⁵: allyl group, R⁶: hydrogen group

R⁴: allyl group, R⁵: hydrogen group, R⁶: hydrogen group

R⁴: propargyl group, R⁵: hydrogen group, R⁶: hydrogen group

R⁴: allyl group, R⁵: allyl group, R⁶: methyl group

R⁴: allyl group, R⁵: hydrogen group, R⁶: methyl group

R⁴: propargyl group, R⁵: hydrogen group, R⁶: methyl group

R⁴: allyl group, R⁵: allyl group, R⁶: ethyl group

R⁴: allyl group, R⁵: hydrogen group, R⁶: ethyl group

R⁴: propargyl group, R⁵: hydrogen group, R⁶: ethyl group

R⁴: allyl group, R⁵: allyl group, R⁶: propyl group

R⁴: allyl group, R⁵: hydrogen group, R⁶: propyl group

R⁴: propargyl group, R⁵: hydrogen group, R⁶: propyl group

R⁴: allyl group, R⁵: allyl group, R⁶: isopropyl group

R⁴: allyl group, R⁵: hydrogen group, R⁶: isopropyl group

R⁴: propargyl group, R⁵: hydrogen group, R⁶: isopropyl group

R⁴: allyl group, R⁵: allyl group, R⁶: butyl group

R⁴: allyl group, R⁵: hydrogen group, R⁶: butyl group

R⁴: propargyl group, R⁵: hydrogen group, R⁶: butyl group

R⁴: allyl group, R⁵: allyl group, R⁶: sec-butyl group

R⁴: allyl group, R⁵: hydrogen group, R⁶: sec-butyl group

R⁴: propargyl group, R⁵: hydrogen group, R⁶: sec-butyl group

R⁴: allyl group, R⁵: allyl group, R⁶: tert-butyl group

R⁴: allyl group, R⁵: hydrogen group, R⁶: tert-butyl group

R⁴: propargyl group, R⁵: hydrogen group, R⁶: tert-butyl group

R⁴: allyl group, R⁵: allyl group, R⁶: pentyl group

R⁴: allyl group, R⁵: hydrogen group, R⁶: pentyl group

R⁴: propargyl group, R⁵: hydrogen group, R⁶: pentyl group

R⁴: allyl group, R⁵: allyl group, R⁶: hexyl group

R⁴: allyl group, R⁵: hydrogen group, R⁶: hexyl group

R⁴: propargyl group, R⁵: hydrogen group, R⁶: hexyl group

R⁴: allyl group, R⁵: allyl group, R⁶: heptyl group

R⁴: allyl group, R⁵: hydrogen group, R⁶: heptyl group

R⁴: propargyl group, R⁵: hydrogen group, R⁶: heptyl group

R⁴: allyl group, R⁵: allyl group, R⁶: octyl group

R⁴: allyl group, R⁵: hydrogen group, R⁶: octyl group

R⁴: propargyl group, R⁵: hydrogen group, R⁶: octyl group

R⁴: allyl group, R⁵: allyl group, R⁶: nonyl group

R⁴: allyl group, R⁵: hydrogen group, R⁶: nonyl group

R⁴: propargyl group, R⁵: hydrogen group, R⁶: nonyl group

R⁴: allyl group, R⁵: allyl group, R⁶: decyl group

R⁴: allyl group, R⁵: hydrogen group, R⁶: decyl group

R⁴: propargyl group, R⁵: hydrogen group, R⁶: decyl group

R⁴: allyl group, R⁵: allyl group, R⁶: cyclohexyl group

R⁴: allyl group, R⁵: hydrogen group, R⁶: cyclohexyl group

R⁴: propargyl group, R⁵: hydrogen group, R⁶: cyclohexyl group

R⁴: allyl group, R⁵: allyl group, R⁶: phenyl group

R⁴: allyl group, R⁵: hydrogen group, R⁶: phenyl group

R⁴: propargyl group, R⁵: hydrogen group, R⁶: phenyl group

R⁴: allyl group, R⁵: allyl group, R⁶: vinyl group

R⁴: allyl group, R⁵: hydrogen group, R⁶: vinyl group

R⁴: propargyl group, R⁵: hydrogen group, R⁶: vinyl group

R⁴: allyl group, R⁵: allyl group, R⁶: isopropenyl group

R⁴: allyl group, R⁵: hydrogen group, R⁶: isopropenyl group

R⁴: propargyl group, R⁵: hydrogen group, R⁶: isopropenyl group

R⁴: allyl group, R⁵: allyl group, R⁶: 1-propenyl group

R⁴: allyl group, R⁵: hydrogen group, R⁶: 1-propenyl group

R⁴: propargyl group, R⁵: hydrogen group, R⁶: 1-propenyl group

R⁴: allyl group, R⁵: allyl group, R⁶: cyanomethyl group

R⁴: allyl group, R⁵: hydrogen group, R⁶: cyanomethyl group

R⁴: propargyl group, R⁵: hydrogen group, R⁶: cyanomethyl group

R⁴: allyl group, R⁵: allyl group, R⁶: 1-cyanoethyl group

R⁴: allyl group, R⁵: hydrogen group, R⁶: 1-cyanoethyl group

R⁴: propargyl group, R⁵: hydrogen group, R⁶: 1-cyanoethyl group

R⁴: allyl group, R⁵: allyl group, R⁶: 2-cyanoethyl group

R⁴: allyl group, R⁵: hydrogen group, R⁶: 2-cyanoethyl group

R⁴: propargyl group, R⁵: hydrogen group, R⁶: 2-cyanoethyl group

The R⁴ to R⁶ in the foregoing combinations may be substituted with heteroatoms. When substituted with heteroatoms, the heteroatoms are preferably halogen atoms such as fluorine, chlorine, bromine, and iodine, further preferably fluorine atoms.

Examples of such heteroatom-substituted R⁴ to R⁶ include the following.

R⁴: allyl group, R⁵: allyl group, R⁶: trifluoromethyl group

R⁴: allyl group, R⁵: hydrogen group, R⁶: trifluoromethyl group

R⁴: propargyl group, R⁵: hydrogen group, R⁶: trifluoromethyl group

R⁴: allyl group, R⁵: allyl group, R⁶: trifluoromethyl group

Preferred examples include the following.

R⁴: allyl group, R⁵: allyl group, R⁶: trifluoromethyl group

### 2. Cyclic Carboxylic Acid Amide

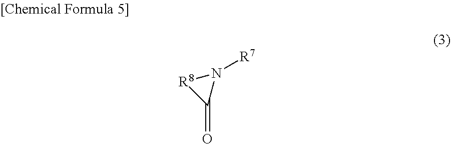

Examples of R⁷ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁸ include an ethylene group, a trimethylene group, a 1-methyltrimethylene group, a 2-methyltrimethylene group, a 3-methyltrimethylene group, a 1-methyltetramethylene group, a 4-methyltetramethylene group, and a pentamethylene group.

Preferred as combinations of R⁷ and R⁸ from the viewpoint of battery characteristics are those in which R⁷ is an allyl group or a propargyl group.

Examples in which R⁷ is an allyl group include N-allyl-β-propiolactam, N-allyl-2-pyrrolidone, N-allyl-3-methyl-2-pyrrolidone, N-allyl-5-methyl-2-pyrrolidone, N-allyl-2-piperidone, N-allyl-3-methyl-2-piperidone, N-allyl-6-methyl-2-piperidone, and N-allyl-∈-caprolactam.

Examples in which R⁷ is a propargyl group include N-propargyl-β-propiolactam, N-propargyl 2-pyrrolidone, N-propargyl 3-methyl-2-pyrrolidone, N-propargyl 5-methyl-2-pyrrolidone, N-propargyl 2-piperidone, N-propargyl 3-methyl-2-piperidone, N-propargyl 6-methyl-2-piperidone, and N-propargyl ∈-caprolactam.

Preferred examples from the viewpoints of suppressing gas generation during high-temperature storage, and improving the charge and discharge characteristics of battery include N-allyl-β-propiolactam, N-allyl-2-pyrrolidone, N-allyl-2-piperidone, N-allyl-∈-caprolactam, N-propargyl-β-propiolactam, N-propargyl-2-pyrrolidone, N-propargyl-2-piperidone, and N-propargyl-∈-caprolactam.

### 3. Dicarboxylic Acid Amide

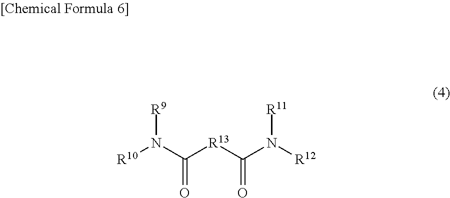

Examples of R⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹⁰ to R¹² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R¹³ include a direct bond, a methylene group, an ethylene group, a trimethylene group, a tetramethylene group, a pentamethylene group, a hexamethylene group, a heptamethylene group, an octamethylene group, a nonamethylene group, a decamethylene group, a vinylene group, an acetylene group, a 1,2-phenylene group, a 1,3-phenylene group, a 1,4-phenylene group, a 4,4′-biphenylene group, a 1,2-cyclohexanediyl group, a 1,3-cyclohexanediyl group, and a 1,4-cyclohexanediyl group.

Preferred as combinations of R⁹ and R¹³ from the viewpoint of battery characteristics are those in which R⁹ is an allyl group or a propargyl group. Examples include the following.

R⁹ to R¹²: allyl group, R¹³: direct bond

R⁹ to R¹²: allyl group, R¹³: methylene group

R⁹ to R¹²: allyl group, R¹³: ethylene group

R⁹ to R¹²: allyl group, R¹³: trimethylene group

R⁹ to R¹²: allyl group, R¹³: tetramethylene group

R⁹ to R¹²: allyl group, R¹³: pentamethylene group

R⁹ to R¹²: allyl group, R¹³: hexamethylene group

R⁹ to R¹²: allyl group, R¹³: 1,2-phenylene group

R⁹ to R¹²: allyl group, R¹³: 1,3-phenylene group

R⁹ to R¹²: allyl group, R¹³: 1,4-phenylene group

R⁹ to R¹²: allyl group, R¹³: 1,2-cyclohexanediyl group

R⁹ to R¹²: allyl group, R¹³: 1,3-cyclohexanediyl group

R⁹ to R¹²: allyl group, R¹³: 1,4-cyclohexanediyl group

R⁹ to R¹²: allyl group, R¹³: cis-vinylene group

R⁹ to R¹²: allyl group, R¹³: trans-vinylene group

R⁹ to R¹²: allyl group, R¹³: acetylene group

R⁹ to R¹²: propargyl group, R¹³: direct bond

R⁹ to R¹²: propargyl group, R¹³: methylene group

R⁹ to R¹²: propargyl group, R³: ethylene group

R⁹ to R¹²: propargyl group, R¹³: trimethylene group

R⁹ to R¹²: propargyl group, R¹³: tetramethylene group

R⁹ to R¹²: propargyl group, R¹³: pentamethylene group

R⁹ to R¹²: propargyl group, R¹³: hexamethylene group

R⁹ to R¹²: propargyl group, R¹³: 1,2-phenylene group

R⁹ to R²: propargyl group, R¹³: 1,3-phenylene group

R⁹ to R¹²: propargyl group, R¹³: 1,4-phenylene group

R⁹ to R¹²: propargyl group, R¹³: 1,2-cyclohexanediyl group

R⁹ to R¹²: propargyl group, R¹³: 1,3-cyclohexanediyl group

R⁹ to R¹²: propargyl group, R¹³: 1,4-cyclohexanediyl group

R⁹ to R¹²: propargyl group, R¹³: cis-vinylene group

R⁹ to R¹²: propargyl group, R¹³: trans-vinylene group

R⁹ to R¹²: propargyl group, R¹³: acetylene group

R⁹, R¹¹: allyl group, R¹⁰, R¹²: hydrogen group, R¹³: direct bond

R⁹, R¹¹: allyl group, R¹⁰, R¹²: hydrogen group, R¹³: methylene group

R⁹, R¹¹: allyl group, R¹⁰, R¹²: hydrogen group, R¹³: ethylene group

R⁹, R¹¹: allyl group, R¹⁰, R¹²: hydrogen group, R¹³: trimethylene group

R⁹, R¹¹: allyl group, R¹⁰, R¹²: hydrogen group, R¹³: tetramethylene group

R⁹, R¹¹: allyl group, R¹⁰, R¹²: hydrogen group, R¹³: pentamethylene group

R⁹, R¹¹: allyl group, R¹⁰, R¹²: hydrogen group, R¹³: hexamethylene group

R⁹, R¹¹: allyl group, R¹⁰, R¹²: hydrogen group, R¹³: 1,2-phenylene group

R⁹, R¹¹: allyl group, R¹⁰, R¹²: hydrogen group, R¹³: 1,3-phenylene group

R⁹, R¹¹: allyl group, R¹⁰, R¹²: hydrogen group, R¹³: 1,4-phenylene group

R⁹, R¹¹: allyl group, R¹⁰, R¹²: hydrogen group, R¹³: 1,2-cyclohexanediyl group

R⁹, R¹¹: allyl group, R¹⁰, R¹²: hydrogen group, R¹³: 1,3-cyclohexanediyl group

R⁹, R¹¹: allyl group, R¹⁰, R¹²: hydrogen group, R¹³: 1,4-cyclohexanediyl group

R⁹, R¹¹: allyl group, R¹⁰, R¹²: hydrogen group, R¹³: cis-vinylene group

R⁹, R¹¹: allyl group, R¹⁰, R¹²: hydrogen group, R¹³: trans-vinylene group

R⁹, R¹¹: allyl group, R¹⁰, R¹²: hydrogen group, R¹³: acetylene group

R⁹, R¹¹: propargyl group, R¹⁰, R¹²: hydrogen group, R¹³: direct bond

R⁹, R¹¹: propargyl group, R¹⁰, R¹²: hydrogen group, R¹³: methylene group

R⁹, R¹¹: propargyl group, R¹⁰, R¹²: hydrogen group, R¹³: ethylene group

R⁹, R¹¹: propargyl group, R¹⁰, R¹²: hydrogen group, R¹³: trimethylene group

R⁹, R¹¹: propargyl group, R¹⁰, R¹²: hydrogen group, R¹³: tetramethylene group

R⁹, R¹¹: propargyl group, R¹⁰, R¹²: hydrogen group, R¹³: pentamethylene group

R⁹, R¹¹: propargyl group, R¹⁰, R¹²: hydrogen group, R¹³: hexamethylene group

R⁹, R¹¹: propargyl group, R¹⁰, R¹²: hydrogen group, R¹³: 1,2-phenylene group

R⁹, R¹¹: propargyl group, R¹⁰, R¹²: hydrogen group, R¹³: 1,3-phenylene group

R⁹, R¹¹: propargyl group, R¹⁰, R¹²: hydrogen group, R¹³: 1,4-phenylene group

R⁹, R¹¹: propargyl group, R¹⁰, R¹²: hydrogen group, R¹³: 1,2-cyclohexanediyl group

R⁹, R¹¹: propargyl group, R¹⁰, R¹²: hydrogen group, R¹³: 1,3-cyclohexanediyl group

R⁹, R¹¹: propargyl group, R¹⁰, R¹²: hydrogen group, R¹³: 1,4-cyclohexanediyl group

R⁹, R¹¹: propargyl group, R¹⁰, R¹²: hydrogen group, R¹³: cis-vinylene group

R⁹, R¹¹: propargyl group, R¹⁰, R¹²: hydrogen group, R¹³: trans-vinylene group

R⁹, R¹¹: propargyl group, R¹⁰, R¹²: hydrogen group, R¹³: acetylene group

R⁹, R¹¹: allyl group, R¹⁰, R¹²: methyl group, R¹³: direct bond

R⁹, R¹¹: allyl group, R¹⁰, R¹²: methyl group, R¹³: methylene group

R⁹, R¹¹: allyl group, R¹⁰, R¹²: methyl group, R¹³: ethylene group

R⁹, R¹¹: allyl group, R¹⁰, R¹²: methyl group, R¹³: trimethylene group

R⁹, R¹¹: allyl group, R¹⁰, R¹²: methyl group, R¹³: tetramethylene group

R⁹, R¹¹: allyl group, R¹⁰, R¹²: methyl group, R¹³: pentamethylene group

R⁹, R¹¹: allyl group, R¹⁰, R¹²: methyl group, R¹³: hexamethylene group

R⁹, R¹¹: allyl group, R¹⁰, R¹²: methyl group, R¹³: 1,2-phenylene group

R⁹, R¹¹: allyl group, R¹⁰, R¹²: methyl group, R¹³: 1,3-phenylene group

R⁹, R¹¹: allyl group, R¹⁰, R¹²: methyl group, R¹³: 1,4-phenylene group

R⁹, R¹¹: allyl group, R¹⁰, R¹²: methyl group, R¹³: 1,2-cyclohexanediyl group

R⁹, R¹¹: allyl group, R¹⁰, R¹²: methyl group, R¹³: 1,3-cyclohexanediyl group

R⁹, R¹¹: allyl group, R¹⁰, R¹²: methyl group, R¹³: 1,4-cyclohexanediyl group

R⁹, R¹¹: allyl group, R¹⁰, R¹²: methyl group, R¹³: cis-vinylene group

R⁹, R¹¹: allyl group, R¹⁰, R¹²: methyl group, R¹³: trans-vinylene group

R⁹, R¹¹: allyl group, R¹⁰, R¹²: methyl group, R¹³: acetylene group

R⁹, R¹¹: allyl group, R¹⁰, R¹²: ethyl group, R¹³: direct bond

R⁹, R¹¹: allyl group, R¹⁰, R¹²: ethyl group, R¹³: methylene group

R⁹, R¹¹: allyl group, R¹⁰, R¹²: ethyl group, R¹³: ethylene group

R⁹, R¹¹: allyl group, R¹⁰, R¹²: ethyl group, R¹³: trimethylene group

R⁹, R¹¹: allyl group, R¹⁰, R¹²: ethyl group, R¹³: tetramethylene group

R⁹, R¹¹: allyl group, R¹⁰, R¹²: ethyl group, R¹³: pentamethylene group

R⁹, R¹¹: allyl group, R¹⁰, R¹²: ethyl group, R¹³: hexamethylene group

R⁹, R¹¹: allyl group, R¹⁰, R¹²: ethyl group, R¹³: 1,2-phenylene group

R⁹, R¹¹: allyl group, R¹⁰, R¹²: ethyl group, R¹³: 1,3-phenylene group

R⁹, R¹¹: allyl group, R¹⁰, R¹²: ethyl group, R¹³: 1,4-phenylene group

R⁹, R¹¹: allyl group, R¹⁰, R¹²: ethyl group, R¹³: 1,2-cyclohexanediyl group

R⁹, R¹¹: allyl group, R¹⁰, R¹²: ethyl group, R¹³: 1,3-cyclohexanediyl group

R⁹, R¹¹: allyl group, R¹⁰, R¹²: ethyl group, R¹³: 1,4-cyclohexanediyl group

R⁹, R¹¹: allyl group, R¹⁰, R¹²: ethyl group, R¹³: cis-vinylene group

R⁹, R¹¹: allyl group, R¹⁰, R¹²: ethyl group, R¹³: trans-vinylene group

R⁹, R¹¹: allyl group, R¹⁰, R¹²: ethyl group, R¹³: acetylene group

R⁹, R¹⁰: allyl group, R¹¹, R¹²: methyl group, R¹³: direct bond

R⁹, R¹⁰: allyl group, R¹¹, R¹²: methyl group, R¹³: methylene group

R⁹, R¹⁰: allyl group, R¹¹, R¹²: methyl group, R¹³: ethylene group

R⁹, R¹⁰: allyl group, R¹¹, R¹²: methyl group, R¹³: trimethylene group

R⁹, R¹⁰: allyl group, R¹¹, R¹²: methyl group, R¹³: tetramethylene group

R⁹, R¹⁰: allyl group, R¹¹, R¹²: methyl group, R¹³: pentamethylene group

R⁹, R¹⁰: allyl group, R¹¹, R¹²: methyl group, R¹³: hexamethylene group

R⁹, R¹⁰: allyl group, R¹¹, R¹²: ethyl group, R¹³: direct bond

R⁹, R¹⁰: allyl group, R¹¹, R¹²: ethyl group, R¹³: methylene group

R⁹, R¹⁰: allyl group, R¹¹, R¹²: ethyl group, R¹³: ethylene group

R⁹, R¹⁰: allyl group, R¹¹, R¹²: ethyl group, R¹³: trimethylene group

R⁹, R¹⁰: allyl group, R¹¹, R¹²: ethyl group, R¹³: tetramethylene group

R⁹, R¹⁰: allyl group, R¹¹, R¹²: ethyl group, R¹³: pentamethylene group

R⁹, R¹⁰: allyl group, R¹¹, R¹²: ethyl group, R¹³: hexamethylene group

R⁹: allyl group, R¹⁰: hydrogen group, R¹¹, R¹²: methyl group, R¹³: direct bond

R⁹: allyl group, R¹⁰: hydrogen group, R¹¹, R¹²: methyl group, R¹³: methylene group

R⁹: allyl group, R¹⁰: hydrogen group, R¹¹, R¹²: methyl group, R¹³: ethylene group

R⁹: allyl group, R¹⁰: hydrogen group, R¹¹, R¹²: methyl group, R¹³: trimethylene group

R⁹: allyl group, R¹⁰: hydrogen group, R¹¹, R¹²: methyl group, R¹³: tetramethylene group

R⁹: allyl group, R¹⁰: hydrogen group, R¹¹, R¹²: methyl group, R¹³: pentamethylene group

R⁹: allyl group, R¹⁰: hydrogen group, R¹¹, R¹²: methyl group, R¹³: hexamethylene group

R⁹: allyl group, R¹⁰: hydrogen group, R¹¹, R¹²: ethyl group, R¹³: direct bond

R⁹: allyl group, R¹⁰: hydrogen group, R¹¹, R¹²: ethyl group, R¹³: methylene group

R⁹: allyl group, R¹⁰: hydrogen group, R¹¹, R¹²: ethyl group, R¹³: ethylene group

R⁹: allyl group, R¹⁰: hydrogen group, R¹¹, R¹²: ethyl group, R¹³: trimethylene group

R⁹: allyl group, R¹⁰: hydrogen group, R¹¹, R¹²: ethyl group, R¹³: tetramethylene group

R⁹: allyl group, R¹⁰: hydrogen group, R¹¹, R¹²: ethyl group, R³: pentamethylene group

R⁹: allyl group, R¹⁰: hydrogen group, R¹¹, R¹²: ethyl group, R¹³: hexamethylene group

Preferred examples from the viewpoints of suppressing gas generation during high-temperature storage, and improving the charge and discharge characteristics of battery include:

R⁹ to R¹²: allyl group, R¹³: direct bond

R⁹ to R¹²: allyl group, R¹³: methylene group

R⁹ to R¹²: allyl group, R¹³: ethylene group

R⁹ to R¹²: allyl group, R¹³: trimethylene group

R⁹ to R¹²: allyl group, R¹³: tetramethylene group

R⁹ to R¹²: allyl group, R¹³: pentamethylene group

R⁹ to R¹²: allyl group, R¹³: hexamethylene group

R⁹ to R¹²: allyl group, R¹³: 1,2-phenylene group

R⁹ to R¹²: allyl group, R¹³: 1,3-phenylene group

R⁹ to R¹²: allyl group, R¹³: 1,4-phenylene group

R⁹ to R¹²: allyl group, R¹³: 1,2-cyclohexanediyl group

R⁹ to R¹²: allyl group, R¹³: 1,3-cyclohexanediyl group

R⁹ to R¹²: allyl group, R¹³: 1,4-cyclohexanediyl group

R⁹ to R¹²: allyl group, R¹³: cis-vinylene group

R⁹ to R¹²: allyl group, R¹³: trans-vinylene group

R⁹ to R¹²: allyl group, R¹³: acetylene group

R⁹, R¹¹: allyl group, R¹⁰, R¹²: hydrogen group, R¹³: direct bond

R⁹, R¹¹: allyl group, R¹⁰, R¹²: hydrogen group, R¹³: methylene group

R⁹, R¹¹: allyl group, R¹⁰, R¹²: hydrogen group, R¹³: ethylene group

R⁹, R¹¹: allyl group, R¹⁰, R¹²: hydrogen group, R¹³: trimethylene group

R⁹, R¹¹: allyl group, R¹⁰, R¹²: hydrogen group, R¹³: tetramethylene group

R⁹, R¹¹: allyl group, R¹⁰, R¹²: hydrogen group, R¹³: pentamethylene group

R⁹, R¹¹: allyl group, R¹⁰, R¹²: hydrogen group, R¹³: hexamethylene group

R⁹, R¹¹: allyl group, R¹⁰, R¹²: hydrogen group, R¹³: 1,2-phenylene group

R⁹, R¹¹: allyl group, R¹⁰, R¹²: hydrogen group, R¹³: 1,3-phenylene group

R⁹, R¹¹: allyl group, R¹⁰, R¹²: hydrogen group, R¹³: 1,4-phenylene group

R⁹, R¹¹: allyl group, R¹⁰, R¹²: hydrogen group, R¹³: 1,2-cyclohexanediyl group

R⁹, R¹¹: allyl group, R¹⁰, R¹²: hydrogen group, R¹³: 1,3-cyclohexanediyl group

R⁹, R¹¹: allyl group, R¹⁰, R¹²: hydrogen group, R¹³: 1,4-cyclohexanediyl group

R⁹, R¹¹: allyl group, R¹⁰, R¹²: hydrogen group, R¹³: cis-vinylene group

R⁹, R¹¹: allyl group, R¹⁰, R¹²: hydrogen group, R¹³: trans-vinylene group

R⁹, R¹¹: allyl group, R¹⁰, R¹²: hydrogen group, R¹³: acetylene group

R⁹, R¹¹: propargyl group, R¹⁰, R¹²: hydrogen group, R¹³: direct bond

R⁹, R¹¹: propargyl group, R¹⁰, R¹²: hydrogen group, R¹³: methylene group

R⁹, R¹¹: propargyl group, R¹⁰, R¹²: hydrogen group, R¹³: ethylene group

R⁹, R¹¹: propargyl group, R¹⁰, R¹²: hydrogen group, R¹³: trimethylene group

R⁹, R¹¹: propargyl group, R¹⁰, R¹²: hydrogen group, R¹³: tetramethylene group

R⁹, R¹¹: propargyl group, R¹⁰, R¹²: hydrogen group, R¹³: pentamethylene group

R⁹, R¹¹: propargyl group, R¹⁰, R¹²: hydrogen group, R¹³: hexamethylene group

R⁹, R¹¹: propargyl group, R¹⁰, R¹²: hydrogen group, R¹³: 1,2-phenylene group

R⁹, R¹¹: propargyl group, R¹⁰, R¹²: hydrogen group, R¹³: 1,3-phenylene group

R⁹, R¹¹: propargyl group, R¹⁰, R¹²: hydrogen group, R¹³: 1,4-phenylene group

R⁹, R¹¹: propargyl group, R¹⁰, R¹²: hydrogen group, R¹³: 1,2-cyclohexanediyl group

R⁹, R¹¹: propargyl group, R¹⁰, R¹²: hydrogen group, R¹³: 1,3-cyclohexanediyl group

R⁹, R¹¹: propargyl group, R¹⁰, R¹²: hydrogen group, R¹³: 1,4-cyclohexanediyl group

R⁹, R¹¹: propargyl group, R¹⁰, R¹²: hydrogen group, R¹³: cis-vinylene group

R⁹, R¹¹: propargyl group, R¹⁰, R¹²: hydrogen group, R¹³: trans-vinylene group

R⁹, R¹¹: propargyl group, R¹⁰, R¹²: hydrogen group, R¹³: acetylene group

R⁹, R¹¹: allyl group, R¹⁰, R¹²: methyl group, R¹³: direct bond

R⁹, R¹¹: allyl group, R¹⁰, R¹²: methyl group, R¹³: methylene group

R⁹, R¹¹: allyl group, R¹⁰, R¹²: methyl group, R¹³: ethylene group

R⁹, R¹¹: allyl group, R¹⁰, R¹²: methyl group, R¹³: trimethylene group

R⁹, R¹¹: allyl group, R¹⁰, R¹²: methyl group, R¹³: tetramethylene group

R⁹, R¹¹: allyl group, R¹⁰, R¹²: methyl group, R¹³: pentamethylene group

R⁹, R¹¹: allyl group, R¹⁰, R¹²: methyl group, R¹³: hexamethylene group

R⁹, R¹¹: allyl group, R¹⁰, R¹²: methyl group, R¹³: 1,2-phenylene group

R⁹, R¹¹: allyl group, R¹⁰, R¹²: methyl group, R¹³: 1,3-phenylene group

R⁹, R¹¹: allyl group, R¹⁰, R¹²: methyl group, R¹³: 1,4-phenylene group

R⁹, R¹¹: allyl group, R¹⁰, R¹²: methyl group, R¹³: 1,2-cyclohexanediyl group

R⁹, R¹¹: allyl group, R¹⁰, R¹²: methyl group, R¹³: 1,3-cyclohexanediyl group

R⁹, R¹¹: allyl group, R¹⁰, R¹²: methyl group, R¹³: 1,4-cyclohexanediyl group

R⁹, R¹¹: allyl group, R¹⁰, R¹²: methyl group, R¹³: cis-vinylene group

R⁹, R¹¹: allyl group, R¹⁰, R¹²: methyl group, R¹³: trans-vinylene group

R⁹, R¹¹: allyl group, R¹⁰, R¹²: methyl group, R¹³: acetylene group

R⁹, R¹¹: allyl group, R¹⁰, R¹²: ethyl group, R¹³: direct bond

R⁹, R¹¹: allyl group, R¹⁰, R¹²: ethyl group, R¹³: methylene group

R⁹, R¹¹: allyl group, R¹⁰, R¹²: ethyl group, R¹³: ethylene group

R⁹, R¹¹: allyl group, R¹⁰, R¹²: ethyl group, R¹³: trimethylene group

R⁹, R¹¹: allyl group, R¹⁰, R¹²: ethyl group, R¹³: tetramethylene group

R⁹, R¹¹: allyl group, R¹⁰, R¹²: ethyl group, R¹³: pentamethylene group

R⁹, R¹¹: allyl group, Rio, R¹²: ethyl group, R¹³: hexamethylene group

R⁹, R¹¹: allyl group, R¹⁰, R¹²: ethyl group, R¹³: 1,2-phenylene group

R⁹, R¹¹: allyl group, R¹⁰, R¹²: ethyl group, R¹³: 1,3-phenylene group

R⁹, R¹¹: allyl group, R¹⁰, R¹²: ethyl group, R¹³: 1,4-phenylene group

R⁹, R¹¹: allyl group, R¹⁰, R¹²: ethyl group, R¹³: 1,2-cyclohexanediyl group

R⁹, R¹¹: allyl group, R¹⁰, R¹²: ethyl group, R¹³: 1,3-cyclohexanediyl group

R⁹, R¹¹: allyl group, R¹⁰, R¹²: ethyl group, R¹³: 1,4-cyclohexanediyl group

R⁹, R¹¹: allyl group, R¹⁰, R¹²: ethyl group, R¹³: cis-vinylene group

R⁹, R¹¹: allyl group, R¹⁰, R¹²: ethyl group, R¹³: trans-vinylene group

R⁹, R¹¹: allyl group, R¹⁰, R¹²: ethyl group, R¹³: acetylene group

R⁹, R¹⁰: allyl group, R¹¹, R¹²: methyl group, R¹³: direct bond

R⁹, R¹⁰: allyl group, R¹¹, R¹²: methyl group, R¹³: methylene group

R⁹, R¹⁰: allyl group, R¹¹, R¹²: methyl group, R¹³: ethylene group

R⁹, R¹⁰: allyl group, R¹¹, R¹²: methyl group, R¹³: trimethylene group

R⁹, R¹⁰: allyl group, R¹¹, R¹²: methyl group, R¹³: tetramethylene group

R⁹, R¹⁰: allyl group, R¹¹, R¹²: methyl group, R¹³: pentamethylene group

R⁹, R¹⁰: allyl group, R¹¹, R¹²: methyl group, R¹³: hexamethylene group

R⁹, R¹⁰: allyl group, R¹¹, R¹²: ethyl group, R¹³: direct bond

R⁹, R¹⁰: allyl group, R¹¹, R¹²: ethyl group, R¹³: methylene group

R⁹, R¹⁰: allyl group, R¹¹, R¹²: ethyl group, R¹³: ethylene group

R⁹, R¹⁰: allyl group, R¹¹, R¹²: ethyl group, R¹³: trimethylene group

R⁹, R¹⁰: allyl group, R¹¹, R¹²: ethyl group, R¹³: tetramethylene group

R⁹, R¹⁰: allyl group, R¹¹, R¹²: ethyl group, R¹³: pentamethylene group

R⁹, R¹⁰: allyl group, R¹¹, R¹²: ethyl group, R¹³: hexamethylene group

R⁹: allyl group, R¹⁰: hydrogen group, R¹¹, R¹²: methyl group, R¹³: direct bond

R⁹: allyl group, R¹⁰: hydrogen group, R¹¹, R¹²: methyl group, R¹³: methylene group

R⁹: allyl group, R¹⁰: hydrogen group, R¹¹, R¹²: methyl group, R¹³: ethylene group

R⁹: allyl group, R¹⁰: hydrogen group, R¹¹, R¹²: methyl group, R¹³: trimethylene group

R⁹: allyl group, R¹⁰: hydrogen group, R¹¹, R¹²: methyl group, R³: tetramethylene group

R⁹: allyl group, R¹⁰: hydrogen group, R¹¹, R¹²: methyl group, R³: pentamethylene group

R⁹: allyl group, R¹⁰: hydrogen group, R¹¹, R¹²: methyl group, R¹³: hexamethylene group

R⁹: allyl group, R¹⁰: hydrogen group, R¹¹, R¹²: ethyl group, R¹³: direct bond

R⁹: allyl group, R¹⁰: hydrogen group, R¹¹, R¹²: ethyl group, R¹³: methylene group

R⁹: allyl group, R¹⁰: hydrogen group, R¹¹, R¹²: ethyl group, R¹³: ethylene group

R⁹: allyl group, R¹⁰: hydrogen group, R¹¹, R¹²: ethyl group, R¹³: trimethylene group

R⁹: allyl group, R¹⁰: hydrogen group, R¹¹, R¹²: ethyl group, R¹³: tetramethylene group

R⁹: allyl group, R¹⁰: hydrogen group, R¹¹, R¹²: ethyl group, R¹³: pentamethylene group

R⁹: allyl group, R¹⁰: hydrogen group, R¹¹, R¹²: ethyl group, R¹³: hexamethylene group

Further preferred examples include the following.

R⁹ to R¹²: allyl group, R¹³: direct bond

R⁹ to R¹²: allyl group, R¹³: methylene group

R⁹ to R¹²: allyl group, R¹³: ethylene group

R⁹ to R¹²: allyl group, R¹³: trimethylene group

R⁹ to R¹²: allyl group, R¹³: tetramethylene group

R⁹ to R¹²: allyl group, R¹³: pentamethylene group

R⁹ to R¹²: allyl group, R¹³: hexamethylene group

R⁹ to R¹²: allyl group, R¹³: 1,2-phenylene group

R⁹ to R¹²: allyl group, R¹³: 1,3-phenylene group

R⁹ to R¹²: allyl group, R¹³: 1,4-phenylene group

R⁹ to R¹²: allyl group, R¹³: 1,2-cyclohexanediyl group

R⁹ to R¹²: allyl group, R¹³: 1,3-cyclohexanediyl group

R⁹ to R¹²: allyl group, R¹³: 1,4-cyclohexanediyl group

R⁹ to R¹²: allyl group, R¹³: cis-vinylene group

R⁹ to R¹²: allyl group, R¹³: trans-vinylene group

R⁹ to R¹²: allyl group, R¹³: acetylene group

R⁹, R¹¹: allyl group, R¹⁰, R¹²: hydrogen group, R¹³: direct bond

R⁹, R¹¹: allyl group, R¹⁰, R¹²: hydrogen group, R¹³: methylene group

R⁹, R¹¹: allyl group, R¹⁰, R¹²: hydrogen group, R¹³: ethylene group

R⁹, R¹¹: allyl group, R¹⁰, R¹²: hydrogen group, R¹³: trimethylene group

R⁹, R¹¹: allyl group, R¹⁰, R¹²: hydrogen group, R¹³: tetramethylene group

R⁹, R¹¹: allyl group, R¹⁰, R¹²: hydrogen group, R¹³: pentamethylene group

R⁹, R¹¹: allyl group, R¹⁰, R¹²: hydrogen group, R¹³: hexamethylene group

R⁹, R¹¹: allyl group, R¹⁰, R¹²: hydrogen group, R¹³: 1,2-phenylene group

R⁹, R¹¹: allyl group, R¹⁰, R¹²: hydrogen group, R¹³: 1,3-phenylene group

R⁹, R¹¹: allyl group, R¹⁰, R¹²: hydrogen group, R¹³: 1,4-phenylene group

R⁹, R¹¹: allyl group, R¹⁰, R¹²: hydrogen group, R¹³: 1,2-cyclohexanediyl group

R⁹, R¹¹: allyl group, R¹⁰, R¹²: hydrogen group, R¹³: 1,3-cyclohexanediyl group

R⁹, R¹¹: allyl group, R¹⁰, R¹²: hydrogen group, R¹³: 1,4-cyclohexanediyl group

R⁹, R¹¹: allyl group, R¹⁰, R¹²: hydrogen group, R¹³: cis-vinylene group

R⁹, R¹¹: allyl group, R¹⁰, R¹²: hydrogen group, R¹³: trans-vinylene group

R⁹, R¹¹: allyl group, R¹⁰, R¹²: hydrogen group, R¹³: acetylene group

R⁹, R¹¹: propargyl group, R¹⁰, R¹²: hydrogen group, R¹³: direct bond

R⁹, R¹¹: propargyl group, R¹⁰, R¹²: hydrogen group, R¹³: methylene group

R⁹, R¹¹: propargyl group, R¹⁰, R¹²: hydrogen group, R¹³: ethylene group

R⁹, R¹¹: propargyl group, R¹⁰, R¹²: hydrogen group, R¹³: trimethylene group

R⁹, R¹¹: propargyl group, R¹⁰, R¹²: hydrogen group, R¹³: tetramethylene group

R⁹, R¹¹: propargyl group, R¹⁰, R¹²: hydrogen group, R¹³: pentamethylene group

R⁹, R¹¹: propargyl group, R¹⁰, R¹²: hydrogen group, R¹³: hexamethylene group

R⁹, R¹¹: propargyl group, R¹⁰, R¹²: hydrogen group, R¹³: 1,2-phenylene group

R⁹, R¹¹: propargyl group, R¹⁰, R¹²: hydrogen group, R¹³: 1,3-phenylene group

R⁹, R¹¹: propargyl group, R¹⁰, R¹²: hydrogen group, R¹³: 1,4-phenylene group

R⁹, R¹¹: propargyl group, R¹⁰, R¹²: hydrogen group, R¹³: 1,2-cyclohexanediyl group

R⁹, R¹¹: propargyl group, R¹⁰, R¹²: hydrogen group, R¹³: 1,3-cyclohexanediyl group

R⁹, R¹¹: propargyl group, R¹⁰, R¹²: hydrogen group, R¹³: 1,4-cyclohexanediyl group

R⁹, R¹¹: propargyl group, R¹⁰, R¹²: hydrogen group, R¹³: cis-vinylene group

R⁹, R¹¹: propargyl group, R¹⁰, R¹²: hydrogen group, R¹³: trans-vinylene group

R⁹, R¹¹: propargyl group, R¹⁰, R¹²: hydrogen group, R¹³: acetylene group

### 4. Dicarboxylic Acid Amide of Diamine

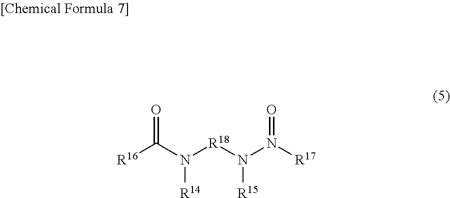

Examples of R¹⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹⁵ include an allyl group, a propargyl group, a hydrogen group, a methyl group, an ethyl group, a propyl group, and an isopropyl group.

Examples of R¹⁶ and R¹⁷ include a hydrogen group, a methyl group, an ethyl group, and a trifluoromethyl group.

Examples of R¹⁸ include methylene, ethylene, trimethylene, and tetramethylene.

Preferred as combinations of R¹⁴ to R¹⁸ from the viewpoint of battery characteristics are those in which R¹⁴ is an allyl group or a propargyl group. Examples include the following.

R¹⁴, R¹⁵: allyl group, R¹⁶, R¹⁷: hydrogen group, R¹⁸: methylene

R¹⁴, R¹⁵: allyl group, R¹⁶, R¹⁷: hydrogen group, R¹⁸: ethylene

R¹⁴, R¹⁵: allyl group, R¹⁶, R¹⁷: hydrogen group, R¹⁸: trimethylene

R¹⁴, R¹⁵: allyl group, R¹⁶, R¹⁷: hydrogen group, R¹⁸: tetramethylene

R¹⁴, R¹⁵: allyl group, R¹⁶, R¹⁷: methyl group, R¹⁸: methylene

R¹⁴, R¹⁵: allyl group, R¹⁶, R¹⁷: methyl group, R¹⁸: ethylene

R¹⁴, R¹⁵: allyl group, R¹⁶, R¹⁷: methyl group, R¹⁸: trimethylene

R¹⁴, R¹⁵: allyl group, R¹⁶, R¹⁷: methyl group, R¹⁸: tetramethylene

R¹⁴, R¹⁵: allyl group, R¹⁶, R¹⁷: ethyl group, R¹⁸: methylene

R¹⁴, R¹⁵: allyl group, R¹⁶, R¹⁷: ethyl group, R¹⁸: ethylene

R¹⁴, R¹⁵: allyl group, R¹⁶, R¹⁷: ethyl group, R¹⁸: trimethylene

R¹⁴, R¹⁵: allyl group, R¹⁶, R¹⁷: ethyl group, R¹⁸: tetramethylene

R¹⁴, R¹⁵: allyl group, R¹⁶, R¹⁷: trifluoromethyl group, R¹⁸: methylene

R¹⁴, R¹⁵: allyl group, R¹⁶, R¹⁷: trifluoromethyl group, R¹⁸: ethylene

R¹⁴, R¹⁵: allyl group, R¹⁶, R¹⁷: trifluoromethyl group, R¹⁸: trimethylene

R¹⁴, R¹⁵: allyl group, R¹⁶, R¹⁷: trifluoromethyl group, R¹⁸: tetramethylene

R¹⁴, R¹⁵: propargyl group, R¹⁶, R¹⁷: hydrogen group, R¹⁸: methylene

R¹⁴, R¹⁵: propargyl group, R¹⁶, R¹⁷: hydrogen group, R¹⁸: ethylene

R¹⁴, R¹⁵: propargyl group, R¹⁶, R¹⁷: hydrogen group, R¹⁸: trimethylene

R¹⁴, R¹⁵: propargyl group, R¹⁶, R¹⁷: hydrogen group, R¹⁸: tetramethylene

R¹⁴, R¹⁵: propargyl group, R¹⁶, R¹⁷: methyl group, R¹⁸: methylene

R¹⁴, R¹⁵: propargyl group, R¹⁶, R¹⁷: methyl group, R¹⁸: ethylene

R¹⁴, R¹⁵: propargyl group, R¹⁶, R¹⁷: methyl group, R¹⁸: trimethylene

R¹⁴, R¹⁵: propargyl group, R¹⁶, R¹⁷: methyl group, R¹⁸: tetramethylene

R¹⁴, R¹⁵: propargyl group, R¹⁶, R¹⁷: ethyl group, R¹⁸: methylene

R¹⁴, R¹⁵: propargyl group, R¹⁶, R¹⁷: ethyl group, R¹⁸: ethylene

R¹⁴, R¹⁵: propargyl group, R¹⁶, R¹⁷: ethyl group, R¹⁸: trimethylene

R¹⁴, R¹⁵: propargyl group, R¹⁶, R¹⁷: ethyl group, R¹⁸: tetramethylene

R¹⁴, R¹⁵: propargyl group, R¹⁶, R¹⁷: trifluoromethyl group, R¹⁸: methylene

R¹⁴, R¹⁵: propargyl group, R¹⁶, R¹⁷: trifluoromethyl group, R¹⁸: ethylene

R¹⁴, R¹⁵: propargyl group, R¹⁶, R¹⁷: trifluoromethyl group, R¹⁸: trimethylene

R¹⁴, R¹⁵: propargyl group, R¹⁶, R¹⁷: trifluoromethyl group, R¹⁸: tetramethylene

Preferred examples from the viewpoints of suppressing gas generation during high-temperature storage, and improving the charge and discharge characteristics of battery include:

R¹⁴, R¹⁵: allyl group, R¹⁶, R¹⁷: hydrogen group, R¹⁸: methylene

R¹⁴, R¹⁵: allyl group, R¹⁶, R¹⁷: hydrogen group, R¹⁸: ethylene

R¹⁴, R¹⁵: allyl group, R¹⁶, R¹⁷: hydrogen group, R¹⁸: trimethylene

R¹⁴, R¹⁵: allyl group, R¹⁶, R¹⁷: hydrogen group, R¹⁸: tetramethylene

R¹⁴, R¹⁵: allyl group, R¹⁶, R¹⁷: methyl group, R¹⁸: methylene

R¹⁴, R¹⁵: allyl group, R¹⁶, R¹⁷: methyl group, R¹⁸: ethylene

R¹⁴, R¹⁵: allyl group, R¹⁶, R¹⁷: methyl group, R¹⁸: trimethylene

R¹⁴, R¹⁵: allyl group, R¹⁶, R¹⁷: methyl group, R¹⁸: tetramethylene

R¹⁴, R¹⁵: allyl group, R¹⁶, R¹⁷: ethyl group, R¹⁸: methylene

R¹⁴, R¹⁵: allyl group, R¹⁶, R¹⁷: ethyl group, R¹⁸: ethylene

R¹⁴, R¹⁵: allyl group, R¹⁶, R¹⁷: ethyl group, R¹⁸: trimethylene

R¹⁴, R¹⁵: allyl group, R¹⁶, R¹⁷: ethyl group, R¹⁸: tetramethylene

R¹⁴, R¹⁵: allyl group, R¹⁶, R¹⁷: trifluoromethyl group, R¹⁸: methylene

R¹⁴, R¹⁵: allyl group, R¹⁶, R¹⁷: trifluoromethyl group, R¹⁸: ethylene

R¹⁴, R¹⁵: allyl group, R¹⁶, R¹⁷: trifluoromethyl group, R¹⁸: trimethylene

R¹⁴, R¹⁵: allyl group, R¹⁶, R¹⁷: trifluoromethyl group, R¹⁸: tetramethylene

### 5. Chain Carbamic Acid Ester

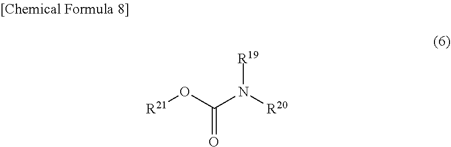

Examples of R¹⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R²⁰ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R²¹ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, a 2-cyanoethyl group, and 2-cyano-1-(cyanomethyl)ethyl.

Preferred as combinations of R¹⁹ to R²¹ from the viewpoint of battery characteristics are those in which R¹⁹ is an allyl group or a propargyl group. Specific examples include the following.

R¹⁹: allyl group, R²⁰: allyl group, R²¹: methyl group

R¹⁹: allyl group, R²⁰: allyl group, R²¹: ethyl group

R¹⁹: allyl group, R²⁰: allyl group, R²¹: cyclohexyl group

R¹⁹: allyl group, R²⁰: allyl group, R²¹: phenyl group

R¹⁹: allyl group, R²⁰: allyl group, R²¹: 2,2,2-trifluoroethyl group

R¹⁹: allyl group, R²⁰: allyl group, R²¹: 2-cyanoethyl group

R¹⁹: propargyl group, R²⁰: propargyl group, R²¹: methyl group

R¹⁹: propargyl group, R²⁰: propargyl group, R²¹: ethyl group

R¹⁹: propargyl group, R²⁰: propargyl group, R²¹: cyclohexyl group

R¹⁹: propargyl group, R²⁰: propargyl group, R²¹: phenyl group

R¹⁹: propargyl group, R²⁰: propargyl group, R²: 2,2,2-trifluoroethyl group

R¹⁹: propargyl group, R²⁰: propargyl group, R²¹: 2-cyanoethyl group

R¹⁹: allyl group, R²⁰: hydrogen group, R²¹: methyl group

R¹⁹: allyl group, R²⁰: hydrogen group, R²¹: ethyl group

R¹⁹: allyl group, R²⁰: hydrogen group, R²¹: cyclohexyl group

R¹⁹: allyl group, R²⁰: hydrogen group, R²¹: phenyl group

R¹⁹: allyl group, R²⁰: hydrogen group, R²¹: 2,2,2-trifluoroethyl group

R¹⁹: allyl group, R²⁰: hydrogen group, R²¹: 2-cyanoethyl group

R¹⁹: propargyl group, R²⁰: hydrogen group, R²¹: methyl group

R¹⁹: propargyl group, R²⁰: hydrogen group, R²¹: ethyl group

R¹⁹: propargyl group, R²⁰: hydrogen group, R²¹: cyclohexyl group

R¹⁹: propargyl group, R²⁰: hydrogen group, R²¹: phenyl group

R¹⁹: propargyl group, R²⁰: hydrogen group, R²¹: 2,2,2-trifluoroethyl group

R¹⁹: propargyl group, R²⁰: hydrogen group, R²¹: 2-cyanoethyl group

Preferred examples from the viewpoints of suppressing gas generation during high-temperature storage, and improving the charge and discharge characteristics of battery include:

R¹⁹: allyl group, R²⁰: allyl group, R²¹: methyl group

R¹⁹: allyl group, R²⁰: allyl group, R²¹: ethyl group

R¹⁹: allyl group, R²⁰: allyl group, R²¹: cyclohexyl group

R¹⁹: allyl group, R²⁰: allyl group, R²¹: phenyl group

R¹⁹: allyl group, R²⁰: allyl group, R²¹: 2,2,2-trifluoroethyl group

R¹⁹: allyl group, R²⁰: allyl group, R²¹: 2-cyanoethyl group

R¹⁹: allyl group, R²⁰: hydrogen group, R²¹: methyl group

R¹⁹: allyl group, R²⁰: hydrogen group, R²¹: ethyl group

R¹⁹: allyl group, R²⁰: hydrogen group, R²¹: cyclohexyl group

R¹⁹: allyl group, R²⁰: hydrogen group, R²¹: phenyl group

R¹⁹: allyl group, R²⁰: hydrogen group, R²¹: 2,2,2-trifluoroethyl group

R¹⁹: allyl group, R²⁰: hydrogen group, R²¹: 2-cyanoethyl group

R⁹: propargyl group, R²⁰: hydrogen group, R²¹: methyl group

R¹⁹: propargyl group, R²⁰: hydrogen group, R²¹: ethyl group

R¹⁹: propargyl group, R²⁰: hydrogen group, R²¹: cyclohexyl group

R¹⁹: propargyl group, R²⁰: hydrogen group, R²¹: phenyl group

R¹⁹: propargyl group, R²⁰: hydrogen group, R²¹: 2,2,2-trifluoroethyl group

R¹⁹: propargyl group, R²⁰: hydrogen group, R²¹: 2-cyanoethyl group

### 6. Cyclic Carbamic Acid Ester

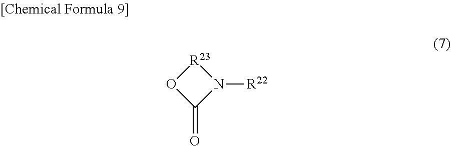

Examples of R²² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R²³ include an ethylene group, a trimethylene group, a 1-methyltrimethylene group, a 2-methyltrimethylene group, a 3-methyltrimethylene group, a 2,2-dimethyltrimethylene group, a tetramethylene group, a 1-methyltetramethylene group, a 4-methyltetramethylene group, and a pentamethylene group.

Preferred as combinations of R²² and R²³ from the viewpoint of improving battery characteristics are those in which R²² is an allyl group or a propargyl group. Examples in which R²² is an allyl group include N-allyl-2-oxazolidone, and N-allyl-1,3-oxazin-2-one. Examples in which R²³ is an propargyl group include N-propargyl-2-oxazolidone, and N-propargyl-1,3-oxazin-2-one.

Preferred examples from viewpoints of suppressing gas generation during high-temperature storage, and improving the charge and discharge characteristics of battery include N-allyl-2-oxazolidone, and N-allyl-1,3-oxazin-2-one.

### 7. Dicarbamate

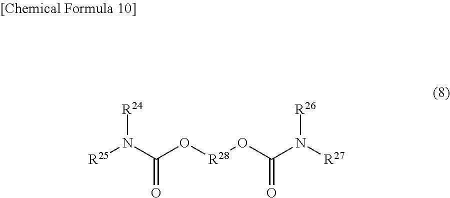

Examples of R²⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of improving battery characteristics.

Examples of R²⁵ to R²⁷ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of improving battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R²⁸ include a methylene group, an ethylene group, a propylene group, a trimethylene group, a tetramethylene group, a pentamethylene group, a hexamethylene group, a heptamethylene group, an octamethylene group, a nonamethylene group, a decamethylene group, a vinylene group, an acetylene group, a 1,2-phenylene group, a 1,3-phenylene group, a 1,4-phenylene group, a 1,1′-biphenylene group, a 3,3′-biphenylene group, a 4,4′-biphenylene group, a 1,2-cyclohexanediyl group, a 1,3-cyclohexanediyl group, and a 1,4-cyclohexanediyl group.

Preferred as combinations of R²⁴ to R²⁸ from the viewpoints of improving battery characteristics are those in which R²⁴ is an allyl group or a propargyl group.

R²⁴ to R²⁷: allyl group, R²⁸: methylene group

R²⁴ to R²⁷: allyl group, R²⁸: ethylene group

R²⁴ to R²⁷: allyl group, R²⁸: trimethylene group

R²⁴ to R²⁷: allyl group, R²⁸: tetramethylene group

R²⁴ to R²⁷: allyl group, R²⁸: pentamethylene group

R²⁴ to R²⁷: allyl group, R²⁸: hexamethylene group

R²⁴ to R²⁷: allyl group, R²⁹: 1,2-phenylene group

R²⁴ to R²⁷: allyl group, R²⁸: 1,3-phenylene group

R²⁴ to R²⁷: allyl group, R²⁸: 1,4-phenylene group

R²⁴ to R²⁷: allyl group, R²⁸: 1,2-cyclohexanediyl group

R²⁴ to R²⁷: allyl group, R²⁸: 1,3-cyclohexanediyl group

R²⁴ to R²⁷: allyl group, R²⁸: 1,4-cyclohexanediyl group

R²⁴ to R²⁷: propargyl group, R²⁸: methylene group

R²⁴ to R²⁷: propargyl group, R²⁸: ethylene group

R²⁴ to R²⁷: propargyl group, R²⁸: trimethylene group

R²⁴ to R²⁷: propargyl group, R²⁸: tetramethylene group

R²⁴ to R²⁷: propargyl group, R²⁸: pentamethylene group

R²⁴ to R²⁷: propargyl group, R²⁸: hexamethylene group

R²⁴ to R²⁷: propargyl group, R²⁸: 1,2-phenylene group

R²⁴ to R²⁷: propargyl group, R²⁸: 1,3-phenylene group

R²⁴ to R²⁷: propargyl group, R²⁸: 1,4-phenylene group

R²⁴ to R²⁷: propargyl group, R²⁸: 1,2-cyclohexanediyl group

R²⁴ to R²⁷: propargyl group, R²⁸: 1,3-cyclohexanediyl group

R²⁴ to R²⁷: propargyl group, R²⁸: 1,4-cyclohexanediyl group

R²⁴, R²⁶: allyl group, R²⁵, R²⁷: hydrogen group, R²⁸: methylene group

R²⁴, R²⁶: allyl group, R²⁵, R²⁷: hydrogen group, R²⁸: ethylene group

R²⁴, R²⁶: allyl group, R²⁵, R²⁷: hydrogen group, R²⁸: trimethylene group

R²⁴, R²⁶: allyl group, R²⁵, R²⁷: hydrogen group, R²⁸: tetramethylene group

R²⁴, R²⁶: allyl group, R²⁵, R²⁷: hydrogen group, R²⁸: pentamethylene group

R²⁴, R²⁶: allyl group, R²⁵, R²⁷: hydrogen group, R²⁸: hexamethylene group

R²⁴, R²⁶: allyl group, R²⁵, R²⁷: hydrogen group, R²⁸: 1,2-phenylene group

R²⁴, R²⁶: allyl group, R²⁵, R²⁷: hydrogen group, R²⁸: 1,3-phenylene group

R²⁴, R²⁶: allyl group, R²⁵, R²⁷: hydrogen group, R²⁸: 1,4-phenylene group

R²⁴, R²⁶: allyl group, R²⁵, R²⁷: hydrogen group, R²⁸: 1,2-cyclohexanediyl group

R²⁴, R²⁶: allyl group, R²⁵, R²⁷: hydrogen group, R²⁸: 1,3-cyclohexanediyl group

R²⁴, R²⁶: allyl group, R²⁵, R²⁷: hydrogen group, R²⁸: 1,4-cyclohexanediyl group

R²⁴, R²⁶: propargyl group, R²⁵, R²⁷: hydrogen group, R²⁸: methylene group

R²⁴, R²⁶: propargyl group, R²⁵, R²⁷: hydrogen group, R²⁸: ethylene group

R²⁴, R²⁶: propargyl group, R²⁵, R²⁷: hydrogen group, R²⁸: trimethylene group

R²⁴, R²⁶: propargyl group, R²⁵, R²⁷: hydrogen group, R²⁸: tetramethylene group

R²⁴, R²⁶: propargyl group, R²⁵, R²⁷: hydrogen group, R²⁸: pentamethylene group

R²⁴, R²⁶: propargyl group, R²⁵, R²⁷: hydrogen group, R²⁸: hexamethylene group

R²⁴, R²⁶: propargyl group, R²⁵, R²⁷: hydrogen group, R²⁸: 1,2-phenylene group

R²⁴, R²⁶: propargyl group, R²⁵, R²⁷: hydrogen group, R²⁸: 1,3-phenylene group

R²⁴, R²⁶: propargyl group, R²⁵, R²⁷: hydrogen group, R²⁸: 1,4-phenylene group

R²⁴, R²⁶: propargyl group, R²⁵, R²⁷: hydrogen group, R²⁸: 1,2-cyclohexanediyl group

R²⁴, R²⁶: propargyl group, R²⁵, R²⁷: hydrogen group, R²⁸: 1,3-cyclohexanediyl group

R²⁴, R²⁶: propargyl group, R²⁵, R²⁷: hydrogen group, R²⁸: 1,4-cyclohexanediyl group

Preferred examples from the viewpoints of suppressing gas generation during high-temperature storage, and improving the charge and discharge characteristics of battery include:

R²⁴ to R²⁷: allyl group, R²⁸: methylene group

R²⁴ to R²⁷: allyl group, R²⁸: ethylene group

R²⁴ to R²⁷: allyl group, R²⁸: trimethylene group

R²⁴ to R²⁷: allyl group, R²⁸: tetramethylene group

R²⁴ to R²⁷: allyl group, R²⁸: pentamethylene group

R²⁴ to R²⁷: allyl group, R²⁸: hexamethylene group

R²⁴ to R²⁷: allyl group, R²⁸: 1,2-phenylene group

R²⁴ to R²⁷: allyl group, R²⁸: 1,3-phenylene group

R²⁴ to R²⁷: allyl group, R²⁸: 1,4-phenylene group

R²⁴ to R²⁷: allyl group, R²⁸: 1,2-cyclohexanediyl group

R²⁴ to R²⁷: allyl group, R²⁸: 1,3-cyclohexanediyl group

R²⁴ to R²⁷: allyl group, R²⁸: 1,4-cyclohexanediyl group

R²⁴, R²⁶: allyl group, R²⁵, R²⁷: hydrogen group, R²⁸: methylene group

R²⁴, R²⁶: allyl group, R²⁵, R²⁷: hydrogen group, R²⁸: ethylene group

R²⁴, R²⁶: allyl group, R²⁵, R²⁷: hydrogen group, R²⁸: trimethylene group

R²⁴, R²⁶: allyl group, R²⁵, R²⁷: hydrogen group, R²⁸: tetramethylene group

R²⁴, R²⁶: allyl group, R²⁵, R²⁷: hydrogen group, R²⁸: pentamethylene group

R²⁴, R²⁶: allyl group, R²⁵, R²⁷: hydrogen group, R²⁸: hexamethylene group

R²⁴, R²⁶: allyl group, R²⁵, R²⁷: hydrogen group, R²⁸: 1,2-phenylene group

R²⁴, R²⁶: allyl group, R²⁵, R²⁷: hydrogen group, R²⁸: 1,3-phenylene group

R²⁴, R²⁶: allyl group, R²⁵, R²⁷: hydrogen group, R²⁸: 1,4-phenylene group

R²⁴, R²⁶: allyl group, R²⁵, R²⁷: hydrogen group, R²⁸: 1,2-cyclohexanediyl group

R²⁴, R²⁶: allyl group, R²⁵, R²⁷: hydrogen group, R²⁸: 1,3-cyclohexanediyl group

R²⁴, R²⁶: allyl group, R²⁵, R²⁷: hydrogen group, R²⁸: 1,4-cyclohexanediyl group

R²⁴, R²⁶: propargyl group, R²⁵, R²⁷: hydrogen group, R²⁸: methylene group

R²⁴, R²⁶: propargyl group, R²⁵, R²⁷: hydrogen group, R²⁸: ethylene group

R²⁴, R²⁶: propargyl group, R²⁵, R²⁷: hydrogen group, R²⁸: trimethylene group

R²⁴, R²⁶: propargyl group, R²⁵, R²⁷: hydrogen group, R²⁸: tetramethylene group

R²⁴, R²⁶: propargyl group, R²⁵, R²⁷: hydrogen group, R²⁸: pentamethylene group

R²⁴, R²⁶: propargyl group, R²⁵, R²⁷: hydrogen group, R²⁸: hexamethylene group

R²⁴, R²⁶: propargyl group, R²⁵, R²⁷: hydrogen group, R²⁸: 1,2-phenylene group

R²⁴, R²⁶: propargyl group, R²⁵, R²⁷: hydrogen group, R²⁹: 1,3-phenylene group

R²⁴, R²⁶: propargyl group, R²⁵, R²⁷: hydrogen group, R²⁸: 1,4-phenylene group

R²⁴, R²⁶: propargyl group, R²⁵, R²⁷: hydrogen group, R²⁸: 1,2-cyclohexanediyl group

R²⁴, R²⁶: propargyl group, R²⁵, R²⁷: hydrogen group, R²⁸: 1,3-cyclohexanediyl group

R²⁴, R²⁶: propargyl group, R²⁵, R²⁷: hydrogen group, R²⁸: 1,4-cyclohexanediyl group

Further preferred examples include the following.

R²⁴ to R²⁷: allyl group, R²⁸: methylene group

R²⁴ to R²⁷: allyl group, R²⁸: ethylene group

R²⁴ to R²⁷: allyl group, R²⁸: trimethylene group

R²⁴ to R²⁷: allyl group, R²⁸: tetramethylene group

R²⁴ to R²⁷: allyl group, R²⁸: pentamethylene group

R²⁴ to R²⁷: allyl group, R²⁸: hexamethylene group

R²⁴ to R²⁷: allyl group, R²⁸: 1,2-phenylene group

R²⁴ to R²⁷: allyl group, R²⁸: 1,3-phenylene group

R²⁴ to R²⁷: allyl group, R²⁸: 1,4-phenylene group

R²⁴ to R²⁷: allyl group, R²⁸: 1,2-cyclohexanediyl group

R²⁴ to R²⁷: allyl group, R²⁸: 1,3-cyclohexanediyl group

R²⁴ to R²⁷: allyl group, R²⁸: 1,4-cyclohexanediyl group

R²⁴, R²⁶: allyl group, R²⁵, R²⁷: hydrogen group, R²⁸: methylene group

R²⁴, R²⁶: allyl group, R²⁵, R²⁷: hydrogen group, R²⁸: ethylene group

R²⁴, R²⁶: allyl group, R²⁵, R²⁷: hydrogen group, R²⁸: trimethylene group

R²⁴, R²⁶: allyl group, R²⁵, R²⁷: hydrogen group, R²⁸: tetramethylene group

R²⁴, R²⁶: allyl group, R²⁵, R²⁷: hydrogen group, R²⁸: pentamethylene group

R²⁴, R²⁶: allyl group, R²⁵, R²⁷: hydrogen group, R²⁸: hexamethylene group

R²⁴, R²⁶: allyl group, R²⁵, R²⁷: hydrogen group, R²⁸: 1,2-phenylene group

R²⁴, R²⁶: allyl group, R²⁵, R²⁷: hydrogen group, R²⁸: 1,3-phenylene group

R²⁴, R²⁶: allyl group, R²⁵, R²⁷: hydrogen group, R²⁸: 1,4-phenylene group

R²⁴, R²⁶: allyl group, R²⁵, R²⁷: hydrogen group, R²⁸: 1,2-cyclohexanediyl group

R²⁴, R²⁶: allyl group, R²⁵, R²⁷: hydrogen group, R²⁸: 1,3-cyclohexanediyl group

R²⁴, R²⁶: allyl group, R²⁵, R²⁷: hydrogen group, R²⁸: 1,4-cyclohexanediyl group

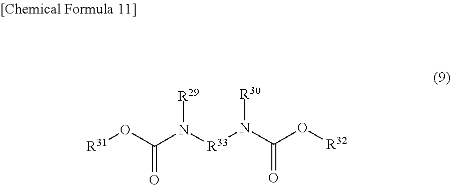

Examples of R²⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R³⁰ include an allyl group, a propargyl group, a hydrogen group, a methyl group, an ethyl group, a propyl group, and an isopropyl group.

Examples of R³¹ and R³² include a methyl group, an ethyl group, and a 2,2,2-trifluoroethyl group.

Examples of R³³ include methylene, ethylene, trimethylene, and tetramethylene.

Preferred as combinations of R²⁹ to R³³ from the viewpoint of improving battery characteristics are those in which R²⁹ is an allyl group or a propargyl group. Examples include the following.

R²⁹, R³⁰: allyl group, R³¹, R³²: methyl group, R³³: methylene group

R²⁹, R³⁰: allyl group, R³¹, R³²: ethyl group, R³³: methylene group

R²⁹, R³⁰: allyl group, R³¹, R³²: 2,2,2-trifluoroethyl group, R³³: methylene group

R²⁹, R³⁰: allyl group, R³¹, R³²: methyl group, R³³: ethylene group

R²⁹, R³⁰: allyl group, R³¹, R³²: ethyl group, R³³: ethylene group

R²⁹, R³⁰: allyl group, R³¹, R³²: 2,2,2-trifluoroethyl group, R³³: ethylene group

R²⁹, R³⁰: allyl group, R³¹, R³²: methyl group, R³³: trimethylene group

R²⁹, R³⁰: allyl group, R³¹, R³²: ethyl group, R³³: trimethylene group

R²⁹, R³⁰: allyl group, R³¹, R³²: 2,2,2-trifluoroethyl group, R³³: trimethylene group

R²⁹, R³⁰: allyl group, R³¹, R³²: methyl group, R³³: tetramethylene group

R²⁹, R³⁰: allyl group, R³¹, R³²: ethyl group, R³³: tetramethylene group

R²⁹, R³⁰: allyl group, R³¹, R³²: 2,2,2-trifluoroethyl group, R³³: tetramethylene group

R²⁹, R³⁰: propargyl group, R³¹, R³²: methyl group, R³³: methylene group

R²⁹, R³⁰: propargyl group, R³¹, R³²: ethyl group, R³³: methylene group

R²⁹, R³⁰: propargyl group, R³¹, R³²: 2,2,2-trifluoroethyl group, R³³: methylene group

R²⁹, R³⁰: propargyl group, R³¹, R³²: methyl group, R³³: ethylene group

R²⁹, R³⁰: propargyl group, R³¹, R³²: ethyl group, R³³: ethylene group

R²⁹, R³⁰: propargyl group, R³¹, R³²: 2,2,2-trifluoroethyl group, R³³: ethylene group

R²⁹, R³⁰: propargyl group, R³¹, R³²: methyl group, R³³: trimethylene group

R²⁹, R³⁰: propargyl group, R³¹, R³²: ethyl group, R³³: trimethylene group

R²⁹, R³⁰: propargyl group, R³¹, R³²: 2,2,2-trifluoroethyl group, R³³: trimethylene group

R²⁹, R³⁰: propargyl group, R³¹, R³²: methyl group, R³³: tetramethylene group

R²⁹, R³⁰: propargyl group, R³¹, R³²: ethyl group, R³³: tetramethylene group

R²⁹, R³⁰: propargyl group, R³¹, R³²: 2,2,2-trifluoroethyl group, R³³: tetramethylene group

Preferred examples from the viewpoints of suppressing gas generation during high-temperature storage, and improving the charge and discharge characteristics of battery include the following.

R²⁹, R³⁰: allyl group, R³¹, R³²: methyl group, R³³: methylene group

R²⁹, R³⁰: allyl group, R³¹, R³²: ethyl group, R³³: methylene group

R²⁹, R³⁰: allyl group, R³¹, R³²: 2,2,2-trifluoroethyl group, R³³: methylene group

R²⁹, R³⁰: allyl group, R³¹, R³²: methyl group, R³³: ethylene group

R²⁹, R³⁰: allyl group, R³¹, R³²: ethyl group, R³³: ethylene group

R²⁹, R³⁰: allyl group, R³¹, R³²: 2,2,2-trifluoroethyl group, R³³: ethylene group

R²⁹, R³⁰: allyl group, R³¹, R³²: methyl group, R³³: trimethylene group

R²⁹, R³⁰: allyl group, R³¹, R³²: ethyl group, R³³: trimethylene group

R²⁹, R³⁰: allyl group, R³¹, R³²: 2,2,2-trifluoroethyl group, R³³: trimethylene group

R²⁹, R³⁰: allyl group, R³¹, R³²: methyl group, R³³: tetramethylene group

R²⁹, R³⁰: allyl group, R³¹, R³²: ethyl group, R³³: tetramethylene group

R²⁹, R³⁰: allyl group, R³¹, R³²: 2,2,2-trifluoroethyl group, R³³: tetramethylene group

Further preferred examples include the following:

R²⁹, R³⁰: allyl group, R³¹, R³²: methyl group, R³³: ethylene group

R²⁹, R³⁰: allyl group, R³¹, R³²: ethyl group, R³³: ethylene group

R²⁹, R³⁰: allyl group, R³¹, R³²: 2,2,2-trifluoroethyl group, R³³: ethylene group

R²⁹, R³⁰: allyl group, R³¹, R³²: methyl group, R³³: trimethylene group

R²⁹, R³⁰: allyl group, R³¹, R³²: ethyl group, R³³: trimethylene group

R²⁹, R³⁰: allyl group, R³¹, R³²: 2,2,2-trifluoroethyl group, R³³: trimethylene group

R²⁹, R³⁰: allyl group, R³¹, R³²: methyl group, R³³: tetramethylene group

R²⁹, R³⁰: allyl group, R³¹, R³²: ethyl group, R³³: tetramethylene group

R²⁹, R³⁰: allyl group, R³¹, R³²: 2,2,2-trifluoroethyl group, R³³: tetramethylene group

### 8. Urea

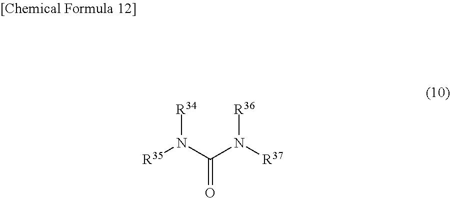

Examples of R³⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R³⁵ to R³⁷ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Preferred as combinations of R⁴ to R³⁷ from the viewpoint of battery characteristics include those in which R³ is an allyl group or a propargyl group. Examples include the following.

R³⁴ to R³⁷: allyl group

R³⁴ to R³⁷: propargyl group

R³⁴, R³⁶: allyl group, R³⁵, R³⁷: hydrogen group

R³⁴, R³⁶: propargyl group, R³⁵, R³⁷: hydrogen group

R³⁴, R³⁶: allyl group, R³⁵, R³⁷: methyl group

R³⁴, R³⁶: propargyl group, R³⁵, R³⁷: methyl group

R³⁴, R³⁶: allyl group, R³⁵, R³⁷: ethyl group

R³⁴, R³⁶: propargyl group, R³⁵, R³⁷: ethyl group

R³⁴, R³⁶: allyl group, R³⁵, R³⁷: propyl group

R³⁴, R³⁶: propargyl group, R³⁵, R³⁷: propyl group

R³⁴, R³⁶: allyl group, R³⁵, R³⁷: methyl group

R³⁴: allyl group, R³⁵: hydrogen group, R³⁶, R³⁷: methyl group

R³⁴, R³⁵: propargyl group, R³⁶, R³⁷: methyl group

R³⁴: propargyl group, R³⁵: hydrogen group, R³⁶, R³⁷: methyl group

R³⁴, R³⁵: allyl group, R³⁶, R³⁷: ethyl group

R³⁴: allyl group, R³⁵: hydrogen group, R³⁶, R³⁷: ethyl group

R³⁴, R³⁵: propargyl group, R³⁶, R³⁷: ethyl group

R³⁴: propargyl group, R³⁵: hydrogen group, R³⁶, R³⁷: ethyl group

R³⁴, R³⁵: allyl group, R³⁶, R³⁷: propyl group

R³⁴: allyl group, R³⁵: hydrogen group, R³⁶, R³⁷: propyl group

R³⁴, R³⁵: propargyl group, R³⁶, R³⁷: propyl group

R³⁴: propargyl group, R³⁵: hydrogen group, R³⁶, R³⁷: propyl group

Preferred examples from the viewpoint of suppressing gas generation during high-temperature storage, and improving the charge and discharge characteristics of battery include the following.

R³⁴ to R³⁷: allyl group

R³⁴, R³⁶: allyl group, R³⁵, R³⁷: hydrogen group

R³⁴, R³⁶: propargyl group, R³⁵, R³⁷: hydrogen group

R³⁴, R³⁵: allyl group, R³⁶, R³⁷: methyl group

R³⁴: allyl group, R³⁵: hydrogen group, R³⁶, R³⁷: methyl group

R³⁴: propargyl group, R³⁵: hydrogen group, R³⁶, R³⁷: methyl group

R³⁴, R³⁵: allyl group, R³⁶, R³⁷: ethyl group

R³⁴: allyl group, R³⁵: hydrogen group, R³⁶, R³⁷: ethyl group

R³⁴: propargyl group, R³⁵: hydrogen group, R³⁶, R³⁷: ethyl group

R³⁴, R³⁵: allyl group, R³⁶, R³⁷: propyl group

R³⁴: allyl group, R³⁵: hydrogen group, R³⁶, R³⁷: propyl group

R³⁴: propargyl group, R³⁵: hydrogen group, R³⁶, R³⁷: propyl group

### 9. Cyclic Urea

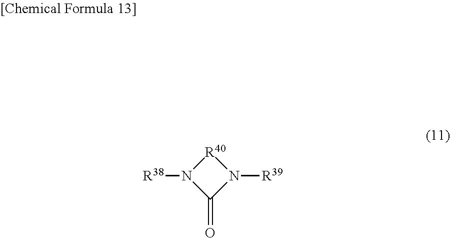

Examples of R³⁸ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R³⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁴⁰ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R³⁸ to R⁴⁰ from the viewpoint of battery characteristics are those in which R³⁸ is an allyl group or a propargyl group. Examples include the following.

R³⁸, R³⁹: allyl group, R⁴⁰: ethylene group

R³⁸, R³⁹: propargyl group, R⁴⁰: ethylene group

R³⁸: allyl group, R³⁹: hydrogen group, R⁴⁰: ethylene group

R³⁸: propargyl group, R³⁹: hydrogen group, R⁴⁰: ethylene group

R³⁸, R³⁹: allyl group, R⁴⁰: trimethylene group

R³⁸, R³⁹: propargyl group, R⁴⁰: trimethylene group

R³⁸: allyl group, R³⁹: hydrogen group, R⁴⁰: trimethylene group

R³⁸: propargyl group, R³⁹: hydrogen group, R⁴⁰: trimethylene group

R³⁸, R³⁹: allyl group, R⁴⁰: 2,2-dimethyltrimethylene group

R³⁸, R³⁹: propargyl group, R⁴⁰: 2,2-dimethyltrimethylene group

R³⁸: allyl group, R³⁹: hydrogen group, R⁴⁰: 2,2-dimethyltrimethylene group

R³⁸: propargyl group, R³⁹: hydrogen group, R⁴⁰: 2,2-dimethyltrimethylene group

Preferred examples from the viewpoint of suppressing gas generation during high-temperature storage, and improving the charge and discharge characteristics of battery include the following.

R³⁸, R³⁹: allyl group, R⁴⁰: ethylene group

R³⁸, R³⁹: propargyl group, R⁴⁰: ethylene group

R³⁸, R³⁹: allyl group, R⁴⁰: trimethylene group

R³⁸, R³⁹: propargyl group, R⁴⁰: trimethylene group

R³⁸, R³⁹: allyl group, R⁴⁰: 2,2-dimethyltrimethylene group

R³⁸, R³⁹: propargyl group, R⁴⁰: 2,2-dimethyltrimethylene group

### 10. Sulfonamide

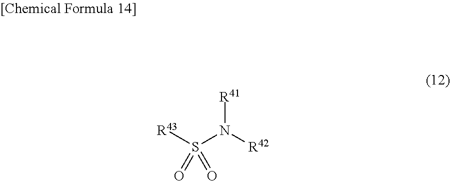

Examples of R⁴¹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁴² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁴³ include a methyl group, an ethyl group, a propyl group, an isopropyl group, a butyl group, a t-butyl group, a cyclohexyl group, a trifluoromethyl group, a 2,2,2-trifluoroethyl group, a pentafluoroethyl group, a heptafluoropropyl group, a vinyl group, an allyl group, a phenyl group, a nonafluorobutyl group, a 4-tolyl group, a 3-tolyl group, and a 2-tolyl group.

Preferred as combinations of R⁴¹ to R⁴³ from the viewpoint of battery characteristics are those in which R⁴¹ is an allyl group or a propargyl group. Specific examples include the following.

R⁴¹, R⁴²: allyl group, R⁴³: methyl group

R⁴¹, R⁴²: allyl group, R⁴³: ethyl group

R⁴¹, R⁴²: allyl group, R⁴³: cyclohexyl group

R⁴¹, R⁴²: allyl group, R⁴³: trifluoromethyl group

R⁴¹, R⁴²: allyl group, R¹³: 2,2,2-trifluoroethyl group

R⁴¹, R⁴²: allyl group, R⁴³: vinyl group

R⁴¹, R⁴²: allyl group, R⁴³: allyl group

R⁴¹, R⁴²: allyl group, R⁴³: phenyl group

R⁴¹, R⁴²: allyl group, R⁴³: 4-tolyl group

R⁴¹, R⁴²: propargyl group, R⁴³: methyl group

R⁴¹, R⁴²: propargyl group, R⁴³: ethyl group

R⁴¹, R⁴²: propargyl group, R⁴³: cyclohexyl group

R⁴¹, R⁴²: propargyl group, R⁴³: trifluoromethyl group

R⁴¹, R⁴²: propargyl group, R⁴³: 2,2,2-trifluoroethyl group

R⁴¹, R⁴²: propargyl group, R⁴³: vinyl group

R⁴¹, R⁴²: propargyl group, R⁴³: allyl group

R⁴¹, R⁴²: propargyl group, R⁴³: phenyl group

R⁴¹, R⁴²: propargyl group, R⁴³: 4-tolyl group

R⁴¹: allyl group, R⁴²: hydrogen group, R⁴³: methyl group

R⁴¹: allyl group, R⁴²: hydrogen group, R⁴³: ethyl group

R⁴¹: allyl group, R⁴²: hydrogen group, R⁴³: cyclohexyl group

R⁴¹: allyl group, R⁴²: hydrogen group, R⁴³: trifluoromethyl group

R⁴¹: allyl group, R⁴²: hydrogen group, R⁴³: 2,2,2-trifluoroethyl group

R⁴¹: allyl group, R⁴²: hydrogen group, R⁴³: vinyl group

R⁴¹: allyl group, R⁴²: hydrogen group, R⁴³: allyl group

R⁴¹: allyl group, R⁴²: hydrogen group, R⁴³: phenyl group

R⁴¹: allyl group, R⁴²: hydrogen group, R⁴³: 4-tolyl group

R⁴¹: propargyl group, R⁴²: hydrogen group, R⁴³: methyl group

R⁴¹: propargyl group, R⁴²: hydrogen group, R⁴³: ethyl group

R⁴¹: propargyl group, R⁴²: hydrogen group, R⁴³: cyclohexyl group

R⁴¹: propargyl group, R⁴²: hydrogen group, R⁴³: trifluoromethyl group

R⁴¹: propargyl group, R⁴²: hydrogen group, R⁴³: 2,2,2-trifluoroethyl group

R⁴¹: propargyl group, R⁴²: hydrogen group, R⁴³: vinyl group

R⁴¹: propargyl group, R⁴²: hydrogen group, R⁴³: allyl group

R⁴¹: propargyl group, R⁴²: hydrogen group, R⁴³: phenyl group

R⁴¹: propargyl group, R⁴²: hydrogen group, R⁴³: 4-tolyl group

Preferred examples from the viewpoint of suppressing gas generation during high-temperature storage, and improving the charge and discharge characteristics of battery include the following.

R⁴¹, R⁴²: allyl group, R⁴³: methyl group

R⁴¹, R⁴²: allyl group, R⁴³: ethyl group

R⁴¹, R⁴²: allyl group, R⁴³: cyclohexyl group

R⁴¹, R⁴²: allyl group, R⁴³: trifluoromethyl group

R⁴¹, R⁴²: allyl group, R⁴³: 2,2,2-trifluoroethyl group

R⁴¹, R⁴²: allyl group, R⁴³: vinyl group

R⁴¹, R⁴²: allyl group, R⁴³: allyl group

R⁴¹, R⁴²: allyl group, R⁴³: phenyl group

R⁴¹, R⁴²: allyl group, R⁴³: 4-tolyl group

R⁴¹: allyl group, R⁴²: hydrogen group, R⁴³: methyl group

R⁴¹: allyl group, R⁴²: hydrogen group, R⁴³: ethyl group

R⁴¹: allyl group, R⁴²: hydrogen group, R⁴³: cyclohexyl group

R⁴¹: allyl group, R⁴²: hydrogen group, R⁴³: trifluoromethyl group

R⁴¹: allyl group, R⁴²: hydrogen group, R⁴³: 2,2,2-trifluoroethyl group

R⁴¹: allyl group, R⁴²: hydrogen group, R⁴³: vinyl group

R⁴¹: allyl group, R⁴²: hydrogen group, R⁴³: allyl group

R⁴¹: allyl group, R⁴²: hydrogen group, R⁴³: phenyl group

R⁴¹: allyl group, R⁴²: hydrogen group, R⁴³: 4-tolyl group

R⁴¹: propargyl group, R⁴²: hydrogen group, R⁴³: methyl group

R⁴¹: propargyl group, R⁴²: hydrogen group, R⁴³: ethyl group

R⁴¹: propargyl group, R⁴²: hydrogen group, R⁴³: cyclohexyl group

R⁴¹: propargyl group, R⁴²: hydrogen group, R⁴³: trifluoromethyl group

R⁴¹: propargyl group, R⁴²: hydrogen group, R⁴³: 2,2,2-trifluoroethyl group

R⁴¹: propargyl group, R⁴²: hydrogen group, R⁴³: vinyl group

R⁴¹: propargyl group, R⁴²: hydrogen group, R⁴³: allyl group

R⁴¹: propargyl group, R⁴²: hydrogen group, R⁴³: phenyl group

R⁴¹: propargyl group, R⁴²: hydrogen group, R⁴³: 4-tolyl group

Further preferred examples include the following.

R⁴¹, R⁴²: allyl group, R⁴³: methyl group

R⁴¹, R⁴²: allyl group, R⁴³: ethyl group

R⁴¹, R⁴²: allyl group, R⁴³: cyclohexyl group

R⁴¹, R⁴²: allyl group, R⁴³: trifluoromethyl group

R⁴¹, R⁴²: allyl group, R⁴³: 2,2,2-trifluoroethyl group

R⁴¹, R⁴²: allyl group, R⁴³: vinyl group

R⁴¹, R⁴²: allyl group, R⁴³: allyl group

R⁴¹, R⁴²: allyl group, R⁴³: phenyl group

R⁴¹, R⁴²: allyl group, R⁴³: 4-tolyl group

### 11. Sultam

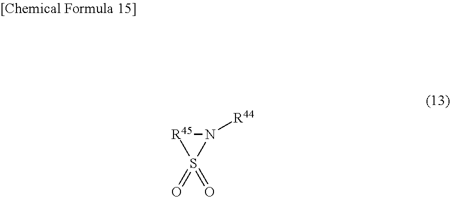

Examples of R⁴⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁴⁵ include an ethylene group, a trimethylene group, a 1-methyltrimethylene group, a 2-methyltrimethylene group, a 3-methyltrimethylene group, a 2,2-dimethyltrimethylene group, a tetramethylene group, a 1-methyltetramethylene group, a 4-methyltetramethylene group, and a pentamethylene group.

Preferred as combinations of R⁴⁴ and R⁴⁵ from the viewpoint of battery characteristics are those in which R⁴⁴ is an allyl group or a propargyl group. Examples include the following.

R⁴⁴: allyl group, R⁴⁵: trimethylene group

R⁴⁴: allyl group, R⁴⁵: tetramethylene group

R⁴⁴: allyl group, R⁴⁵: pentamethylene group

R⁴⁴: propargyl group, R⁴⁵: trimethylene group

R⁴⁴: propargyl group, R⁴⁵: tetramethylene group

R⁴⁴: propargyl group, R⁴⁵: pentamethylene group

More preferred examples from the viewpoints of suppressing gas generation during high-temperature storage, and improving the charge and discharge characteristics of battery include the following.

R⁴⁴: allyl group, R⁴⁵: trimethylene group

R⁴⁴: allyl group, R⁴⁵: tetramethylene group

R⁴⁴: propargyl group, R⁴⁵: trimethylene group

R⁴⁴: propargyl group, R⁴⁵: tetramethylene group

### 12. Disulfonic Acid Amide

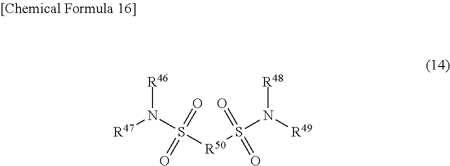

Examples of R⁴⁶ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁴⁷ to R⁴⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁵⁰ include a direct bond, a methylene group, an ethylene group, a trimethylene group, a tetramethylene group, a pentamethylene group, a hexamethylene group, a heptamethylene group, an octamethylene group, a nonamethylene group, a decamethylene group, a vinylene group, an acetylene group, a 1,2-phenylene group, a 1,3-phenylene group, a 1,4-phenylene group, a 4,4′-biphenylene group, a 1,2-cyclohexanediyl group, a 1,3-cyclohexanediyl group, and a 1,4-cyclohexanediyl group.

Preferred as combinations of R⁴⁶ to R⁵⁰ from the viewpoint of battery characteristics are those in which R⁴⁶ is an allyl group or a propargyl group. Specific Examples include the following.

R⁴⁶ to R⁴⁹: allyl group, R⁵⁰: direct bond

R⁴⁶ to R⁴⁹: allyl group, R⁵⁰: methylene group

R⁴⁶ to R⁴⁹: allyl group, R⁵⁰: ethylene group

R⁴⁶ to R⁴⁹: allyl group, R⁵⁰: trimethylene group

R⁴⁶ to R⁴⁹: allyl group, R⁵⁰: tetramethylene group

R⁴⁶ to R⁴⁹: allyl group, R⁵⁰: pentamethylene group

R⁴⁶ to R⁴⁹: allyl group, R⁵⁰: hexamethylene group

R⁴⁶ to R⁴⁹: propargyl group, R⁵⁰: direct bond

R⁴⁶ to R⁴⁹: propargyl group, R⁵⁰: methylene group

R⁴⁶ to R⁴⁹: propargyl group, R⁵⁰: ethylene group

R⁴⁶ to R⁴⁹: propargyl group, R⁵⁰: trimethylene group

R⁴⁶ to R⁴⁹: propargyl group, R⁵⁰: tetramethylene group

R⁴⁶ to R⁴⁹: propargyl group, R⁵⁰: pentamethylene group

R⁴⁶ to R⁴⁹: propargyl group, R⁵⁰: hexamethylene group

R⁴⁶, R⁴⁸: allyl group, R⁴⁷, R⁴⁹: hydrogen group, R⁵⁰: direct bond

R⁴⁶, R⁴⁸: allyl group, R⁴⁷, R⁴⁹: hydrogen group, R⁵⁰: methylene group

R⁴⁶, R⁴⁸: allyl group, R⁴⁷, R⁴⁹: hydrogen group, R⁵⁰: ethylene group

R⁴⁶, R⁴⁸: allyl group, R⁴⁷, R⁴⁹: hydrogen group, R⁵⁰: trimethylene group

R⁴⁶, R⁴⁸: allyl group, R⁴⁷, R⁴⁹: hydrogen group, R⁵⁰: tetramethylene group

R⁴⁶, R⁴⁸: allyl group, R⁴⁷, R⁴⁹: hydrogen group, R⁵⁰: pentamethylene group

R⁴⁶, R⁴⁸: allyl group, R⁴⁷, R⁴⁹: hydrogen group, R⁵⁰: hexamethylene group

R⁴⁶, R⁴⁸: propargyl group, R⁴⁷, R⁴⁹: hydrogen group, R⁵⁰: direct bond

R⁴⁶, R⁴⁸: propargyl group, R⁴⁷, R⁴⁹: hydrogen group, R⁵⁰: methylene group

R⁴⁶, R⁴⁸: propargyl group, R⁴⁷, R⁴⁹: hydrogen group, R⁵⁰: ethylene group

R⁴⁶, R⁴⁸: propargyl group, R⁴⁷, R⁴⁹: hydrogen group, R⁵⁰: trimethylene group

R⁴⁶, R⁴⁸: propargyl group, R⁴⁷, R⁴⁹: hydrogen group, R⁵⁰: tetramethylene group

R⁴⁶, R⁴⁸: propargyl group, R⁴⁷, R⁴⁹: hydrogen group, R⁵⁰: pentamethylene group

R⁴⁶, R⁴⁸: propargyl group, R⁴⁷, R⁴⁹: hydrogen group, R⁵⁰: hexamethylene group

R⁴⁶, R⁴⁸: allyl group, R⁴⁷, R⁴⁹: methyl group, R⁵⁰: direct bond

R⁴⁶, R⁴⁸: allyl group, R⁴⁷, R⁴⁹: methyl group, R⁵⁰: methylene group

R⁴⁶, R⁴⁸: allyl group, R⁴⁷, R⁴⁹: methyl group, R⁵⁰: ethylene group

R⁴⁶, R⁴⁸: allyl group, R⁴⁷, R⁴⁹: methyl group, R⁵⁰: trimethylene group

R⁴⁶, R⁴⁸: allyl group, R⁴⁷, R⁴⁹: methyl group, R⁵⁰: tetramethylene group

R⁴⁶, R⁴⁸: allyl group, R⁴⁷, R⁴⁹: methyl group, R⁵⁰: pentamethylene group

R⁴⁶, R⁴⁸: allyl group, R⁴⁷, R⁴⁹: methyl group, R⁵⁰: hexamethylene group

R⁴⁶, R⁴⁸: allyl group, R⁴⁷, R⁴⁹: ethyl group, R⁵⁰: direct bond

R⁴⁶, R⁴⁸: allyl group, R⁴⁷, R⁴⁹: ethyl group, R⁵⁰: methylene group

R⁴⁶, R⁴⁸: allyl group, R⁴⁷, R⁴⁹: ethyl group, R⁵⁰: ethylene group

R⁴⁶, R⁴⁸: allyl group, R⁴⁷, R⁴⁹: ethyl group, R⁵⁰: trimethylene group

R⁴⁶, R⁴⁸: allyl group, R⁴⁷, R⁴⁹: ethyl group, R⁵⁰: tetramethylene group

R⁴⁶, R⁴⁸: allyl group, R⁴⁷, R⁴⁹: ethyl group, R⁵⁰: pentamethylene group

R⁴⁶, R⁴⁸: allyl group, R⁴⁷, R⁴⁹: ethyl group, R⁵⁰: hexamethylene group

Preferred examples from the viewpoint of suppressing gas generation during high-temperature storage, and improving the charge and discharge characteristics of battery include the following.

R⁴⁶ to R⁴⁹: allyl group, R⁵⁰: direct bond

R⁴⁶ to R⁴⁹: allyl group, R⁵⁰: methylene group

R⁴⁶ to R⁴⁹: allyl group, R⁵⁰: ethylene group

R⁴⁶ to R⁴⁹: allyl group, R⁵⁰: trimethylene group

R⁴⁶ to R⁴⁹: allyl group, R⁵⁰: tetramethylene group

R⁴⁶ to R⁴⁹: allyl group, R⁵⁰: pentamethylene group

R⁴⁶ to R⁴⁹: allyl group, R⁵⁰: hexamethylene group

R⁴⁶, R⁴⁸: allyl group, R⁴⁷, R⁴⁹: hydrogen group, R⁵⁰: direct bond

R⁴⁶, R⁴⁸: allyl group, R⁴⁷, R⁴⁹: hydrogen group, R⁵⁰: methylene group

R⁴⁶, R⁴⁸: allyl group, R⁴⁷, R⁴⁹: hydrogen group, R⁵⁰: ethylene group

R⁴⁶, R⁴⁸: allyl group, R⁴⁷, R⁴⁹: hydrogen group, R⁵⁰: trimethylene group

R⁴⁶, R⁴⁸: allyl group, R⁴⁷, R⁴⁹: hydrogen group, R⁵⁰: tetramethylene group

R⁴⁶, R⁴⁸: allyl group, R⁴⁷, R⁴⁹: hydrogen group, R⁵⁰: pentamethylene group

R⁴⁶, R⁴⁸: allyl group, R⁴⁷, R⁴⁹: hydrogen group, R⁵⁰: hexamethylene group

R⁴⁶, R⁴⁸: propargyl group, R⁴⁷, R⁴⁹: hydrogen group, R⁵⁰: direct bond

R⁴⁶, R⁴⁸: propargyl group, R⁴⁷, R⁴⁹: hydrogen group, R⁵⁰: methylene group

R⁴⁶, R⁴⁸: propargyl group, R⁴⁷, R⁴⁹: hydrogen group, R⁵⁰: ethylene group

R⁴⁶, R⁴⁸: propargyl group, R⁴⁷, R⁴⁹: hydrogen group, R⁵⁰: trimethylene group

R⁴⁶, R⁴⁸: propargyl group, R⁴⁷, R⁴⁹: hydrogen group, R⁵⁰: tetramethylene group

R⁴⁶, R⁴⁸: propargyl group, R⁴⁷, R⁴⁹: hydrogen group, R⁵⁰: pentamethylene group

R⁴⁶, R⁴⁸: propargyl group, R⁴⁷, R⁴⁹: hydrogen group, R⁵⁰: hexamethylene group

Further preferred examples include the following.

R⁴⁶ to R⁴⁹: allyl group, R⁵⁰: direct bond

R⁴⁶ to R⁴⁹: allyl group, R⁵⁰: methylene group

R⁴⁶ to R⁴⁹: allyl group, R⁵⁰: ethylene group

R⁴⁶ to R⁴⁹: allyl group, R⁵⁰: trimethylene group

R⁴⁶ to R⁴⁹: allyl group, R⁵⁰: tetramethylene group

R⁴⁶ to R⁴⁹: allyl group, R⁵⁰: pentamethylene group

R⁴⁶ to R⁴⁹: allyl group, R⁵⁰: hexamethylene group

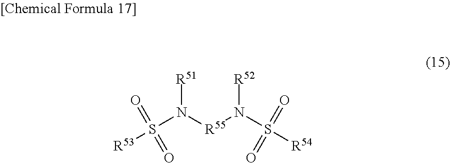

Examples of R⁵¹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁵² include an allyl group, a propargyl group, a hydrogen group, a methyl group, an ethyl group, a propyl group, and an isopropyl group.

Examples of R⁵³ and R⁵⁴ include a methyl group, an ethyl group, and a trifluoromethyl group.

Examples of R⁵⁵ include methylene, ethylene, trimethylene, and tetramethylene.

Preferred as combinations of R⁵¹ to R⁵⁵ from the viewpoint of battery characteristics are those in which R⁵¹ is an allyl group or a propargyl group. Examples include the following.

R⁵¹, R⁵²: allyl group, R⁵³, R⁵⁴: methyl group, R⁵⁵: methylene

R⁵¹, R⁵²: allyl group, R⁵³, R⁵⁴: methyl group, R⁵⁵: ethylene

R⁵¹, R⁵²: allyl group, R⁵³, R⁵⁴: methyl group, R⁵⁵: trimethylene

R⁵¹, R⁵²: allyl group, R⁵³, R⁵⁴: methyl group, R⁵⁵: tetramethylene

R⁵¹, R⁵²: allyl group, R⁵³, R⁵⁴: ethyl group, R⁵⁵: methylene

R⁵¹, R⁵²: allyl group, R⁵³, R⁵⁴: ethyl group, R⁵⁵: ethylene

R⁵¹, R⁵²: allyl group, R⁵³, R⁵⁴: ethyl group, R⁵⁵: trimethylene

R⁵¹, R⁵²: allyl group, R⁵³, R⁵⁴: ethyl group, R⁵⁵: tetramethylene

R⁵¹, R⁵²: allyl group, R⁵³, R⁵⁴: trifluoromethyl group, R⁵⁵: methylene

R⁵¹, R⁵²: allyl group, R⁵³, R⁵⁴: trifluoromethyl group, R⁵⁵: ethylene

R⁵¹, R⁵²: allyl group, R⁵³, R⁵⁴: trifluoromethyl group, R⁵⁵: trimethylene

R⁵¹, R⁵²: allyl group, R⁵³, R⁵⁴: trifluoromethyl group, R⁵⁵: tetramethylene

R⁵¹, R⁵²: propargyl group, R⁵³, R⁵⁴: methyl group, R⁵⁵: methylene

R⁵¹, R⁵²: propargyl group, R⁵³, R⁵⁴: methyl group, R⁵⁵: ethylene

R⁵¹, R⁵²: propargyl group, R⁵³, R⁵⁴: methyl group, R⁵⁵: trimethylene

R⁵¹, R⁵²: propargyl group, R⁵³, R⁵⁴: methyl group, R⁵⁵: tetramethylene

R⁵¹, R⁵²: propargyl group, R⁵³, R⁵⁴: ethyl group, R⁵⁵: methylene

R⁵¹, R⁵²: propargyl group, R⁵³, R⁵⁴: ethyl group, R⁵⁵: ethylene

R⁵¹, R⁵²: propargyl group, R⁵³, R⁵⁴: ethyl group, R⁵⁵: trimethylene

R⁵¹, R⁵²: propargyl group, R⁵³, R⁵⁴: ethyl group, R⁵⁵: tetramethylene

R⁵¹, R⁵²: propargyl group, R⁵³, R⁵⁴: trifluoromethyl group, R⁵⁵: methylene

R⁵¹, R⁵²: propargyl group, R⁵³, R⁵⁴: trifluoromethyl group, R⁵⁵: ethylene

R⁵¹, R⁵²: propargyl group, R⁵³, R⁵⁴: trifluoromethyl group, R⁵⁵: trimethylene

R⁵¹, R⁵²: propargyl group, R⁵³, R⁵⁴: trifluoromethyl group, R⁵⁵: tetramethylene

Preferred examples from the viewpoint of suppressing gas generation during high-temperature storage, and improving the charge and discharge characteristics of battery include the following.

R⁵¹, R⁵²: allyl group, R⁵³, R⁵⁴: methyl group, R⁵⁵: methylene

R⁵¹, R⁵²: allyl group, R⁵³, R⁵⁴: methyl group, R⁵⁵: ethylene

R⁵¹, R⁵²: allyl group, R⁵³, R⁵⁴: methyl group, R⁵⁵: trimethylene

R⁵¹, R⁵²: allyl group, R⁵³, R⁵⁴: methyl group, R⁵⁵: tetramethylene

R⁵¹, R⁵²: allyl group, R⁵³, R⁵⁴: ethyl group, R⁵⁵: methylene

R⁵¹, R⁵²: allyl group, R⁵³, R⁵⁴: ethyl group, R⁵⁵: ethylene

R⁵¹, R⁵²: allyl group, R⁵³, R⁵⁴: ethyl group, R⁵⁵: trimethylene

R⁵¹, R⁵²: allyl group, R⁵³, R⁵⁴: ethyl group, R⁵⁵: tetramethylene

R⁵¹, R⁵²: allyl group, R⁵³, R⁵⁴: trifluoromethyl group, R⁵⁵: methylene

R⁵¹, R⁵²: allyl group, R⁵³, R⁵⁴: trifluoromethyl group, R⁵⁵: ethylene

R⁵¹, R⁵²: allyl group, R⁵³, R⁵⁴: trifluoromethyl group, R⁵⁵: trimethylene

R⁵¹, R⁵²: allyl group, R⁵³, R⁵⁴: trifluoromethyl group, R⁵⁵: tetramethylene

### 13. Sulfamic Acid Ester

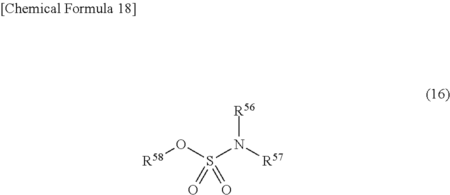

Examples of R⁵⁶ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁵⁷ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁵⁸ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, a 2-cyanoethyl group, and 2-cyano-1-(cyanomethyl)ethyl.

Preferred as combinations of R⁵⁶ to R⁵⁸ from the viewpoint of battery characteristics are those in which R⁵⁶ is an allyl group or a propargyl group. Specific examples include the following.

R⁵⁶: allyl group, R⁵⁷: allyl group, R⁵⁸: methyl group

R⁵⁶: allyl group, R⁵⁷: allyl group, R⁵⁸: ethyl group

R⁵⁶: allyl group, R⁵⁷: allyl group, R⁵⁸: cyclohexyl group

R⁵⁶: allyl group, R⁵⁷: allyl group, R⁵⁸: phenyl group

R⁵⁶: allyl group, R⁵⁷: allyl group, R⁵⁸: 2,2,2-trifluoroethyl group

R⁵⁶: allyl group, R⁵⁷: allyl group, R⁵⁸: 2-cyanoethyl group

R⁵⁶: propargyl group, R⁵⁷: propargyl group, R⁵⁸: methyl group

R⁵⁶: propargyl group, R⁵⁷: propargyl group, R⁵⁸: ethyl group

R⁵⁶: propargyl group, R⁵⁷: propargyl group, R⁵⁸: cyclohexyl group

R⁵⁶: propargyl group, R⁵⁷: propargyl group, R⁵⁸: phenyl group

R⁵⁶: propargyl group, R⁵⁷: propargyl group, R⁵⁸: 2,2,2-trifluoroethyl group

R⁵⁶: propargyl group, R⁵⁷: propargyl group, R⁵⁸: 2-cyanoethyl group

R⁵⁶: allyl group, R⁵⁷: hydrogen group, R⁵⁸: methyl group

R⁵⁶: allyl group, R⁵⁷: hydrogen group, R⁵⁸: ethyl group

R⁵⁶: allyl group, R⁵⁷: hydrogen group, R⁵⁸: cyclohexyl group

R⁵⁶: allyl group, R⁵⁷: hydrogen group, R⁵⁸: phenyl group

R⁵⁶: allyl group, R⁵⁷: hydrogen group, R⁵⁸: 2,2,2-trifluoroethyl group

R⁵⁶: allyl group, R⁵⁷: hydrogen group, R⁵⁸: 2-cyanoethyl group

R⁵⁶: propargyl group, R⁵⁷: hydrogen group, R⁵⁸: methyl group

R⁵⁶: propargyl group, R⁵⁷: hydrogen group, R⁵⁸: ethyl group

R⁵⁶: propargyl group, R⁵⁷: hydrogen group, R⁵⁸: cyclohexyl group

R⁵⁶: propargyl group, R⁵⁷: hydrogen group, R⁵⁸: phenyl group

R⁵⁶: propargyl group, R⁵⁷: hydrogen group, R⁵⁸: 2,2,2-trifluoroethyl group

R⁵⁶: propargyl group, R⁵⁷: hydrogen group, R⁵⁸: 2-cyanoethyl group

Preferred examples from the viewpoint of suppressing gas generation during high-temperature storage, and improving the charge and discharge characteristics of battery include the following.

R⁵⁶: allyl group, R⁵⁷: allyl group, R⁵⁸: methyl group

R⁵⁶: allyl group, R⁵⁷: allyl group, R⁵⁸: ethyl group

R⁵⁶: allyl group, R⁵⁷: allyl group, R⁵⁸: cyclohexyl group

R⁵⁶: allyl group, R⁵⁷: allyl group, R⁵⁸: phenyl group

R⁵⁶: allyl group, R⁵⁷: allyl group, R⁵⁸: 2,2,2-trifluoroethyl group

R⁵⁶: allyl group, R⁵⁷: allyl group, R⁵⁸: 2-cyanoethyl group

R⁵⁶: allyl group, R⁵⁷: hydrogen group, R⁵⁸: methyl group

R⁵⁶: allyl group, R⁵⁷: hydrogen group, R⁵⁸: ethyl group

R⁵⁶: allyl group, R⁵⁷: hydrogen group, R⁵⁸: cyclohexyl group

R⁵⁶: allyl group, R⁵⁷: hydrogen group, R⁵⁸: phenyl group

R⁵⁶: allyl group, R⁵⁷: hydrogen group, R⁵⁸: 2,2,2-trifluoroethyl group

R⁵⁶: allyl group, R⁵⁷: hydrogen group, R⁵⁸: 2-cyanoethyl group

R⁵⁶: propargyl group, R⁵⁷: hydrogen group, R⁵⁸: methyl group

R⁵⁶: propargyl group, R⁵⁷: hydrogen group, R⁵⁸: ethyl group

R⁵⁶: propargyl group, R⁵⁷: hydrogen group, R⁵⁸: cyclohexyl group

R⁵⁶: propargyl group, R⁵⁷: hydrogen group, R⁵⁸: phenyl group

R⁵⁶: propargyl group, R⁵⁷: hydrogen group, R⁵⁸: 2,2,2-trifluoroethyl group

R⁵⁶: propargyl group, R⁵⁷: hydrogen group, R⁵⁸: 2-cyanoethyl group

Further preferred examples include the following.

R⁵⁶: allyl group, R⁵⁷: allyl group, R⁵⁸: methyl group

R⁵⁶: allyl group, R⁵⁷: allyl group, R⁵⁸: ethyl group

R⁵⁶: allyl group, R⁵⁷: allyl group, R⁵⁸: cyclohexyl group

R⁵⁶: allyl group, R⁵⁷: allyl group, R⁵⁸: phenyl group

R⁵⁶: allyl group, R⁵⁷: allyl group, R⁵⁸: 2,2,2-trifluoroethyl group

R⁵⁶: allyl group, R⁵⁷: allyl group, R⁵⁸: 2-cyanoethyl group

### 14. Cyclic Sulfamic Acid Ester

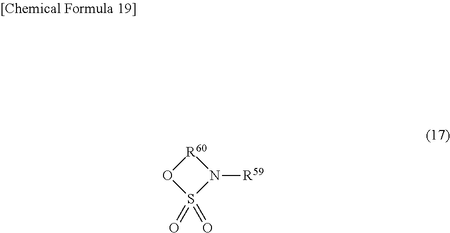

Examples of R⁵⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁶⁰ include an ethylene group, a trimethylene group, a 1-methyltrimethylene group, a 2-methyltrimethylene group, a 3-methyltrimethylene group, a 2,2-dimethyltrimethylene group, a tetramethylene group, a 1-methyltetramethylene group, a 4-methyltetramethylene group, and a pentamethylene group.

Preferred as combinations of R⁵⁹ to R⁶⁰ from the viewpoint of improving battery characteristics are those in which R⁵⁹ is an allyl group or a propargyl group. Specific examples include the following.

R⁵⁹: allyl group, R⁶⁰: ethylene group

R⁵⁹: allyl group, R⁶⁰: trimethylene group

R⁵⁹: allyl group, R⁶⁰: tetramethylene group

R⁵⁹: propargyl group, R⁶⁰: ethylene group

R⁵⁹: propargyl group, R⁶⁰: trimethylene group

R⁵⁹: propargyl group, R⁶⁰: tetramethylene group

Preferred examples from the viewpoint of suppressing gas generation during high-temperature storage, and improving the charge and discharge characteristics of battery include the following.

R⁵⁹: allyl group, R⁶⁰: ethylene group

R⁵⁹: allyl group, R⁶⁰: trimethylene group

R⁵⁹: propargyl group, R⁶⁰: ethylene group

R⁵⁹: propargyl group, R⁶⁰: trimethylene group

### 15. Sulfamide

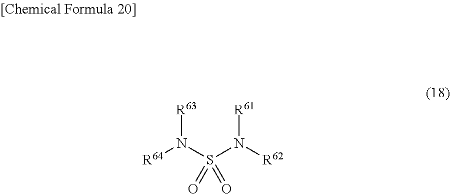

Examples of R⁶¹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁶² to R⁶⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Preferred as combinations of R⁶¹ to R⁶⁴ from the viewpoint of battery characteristics are those in which R⁶¹ is an allyl group or a propargyl group. Examples include the following.

R⁶¹ to R⁶⁴: allyl group

R⁶¹ to R⁶⁴: propargyl group

R⁶¹, R⁶³: allyl group, R⁶², R⁶⁴: hydrogen group

R⁶¹, R⁶³: propargyl group, R⁶², R⁶⁴: hydrogen group

R⁶¹, R⁶³: allyl group, R⁶², R⁶⁴: methyl group

R⁶¹, R⁶³: propargyl group, R⁶², R⁶⁴: methyl group

R⁶¹, R⁶³: allyl group, R⁶², R⁶⁴: ethyl group

R⁶¹, R⁶³: propargyl group, R⁶², R⁶⁴: ethyl group

R⁶¹, R⁶³: allyl group, R⁶², R⁶⁴: propyl group

R⁶¹, R⁶³: propargyl group, R⁶², R⁶⁴: propyl group

R⁶¹, R⁶²: allyl group, R⁶³, R⁶⁴: methyl group

R⁶¹: allyl group, R⁶²: hydrogen group, R⁶³, R⁶⁴: methyl group

R⁶¹, R⁶²: propargyl group, R⁶³, R⁶⁴: methyl group

R⁶¹: propargyl group, R⁶²: hydrogen group, R⁶³, R⁶⁴: methyl group

R⁶¹, R⁶²: allyl group, R⁶³, R⁶⁴: ethyl group

R⁶¹: allyl group, R⁶²: hydrogen group, R⁶³, R⁶⁴: ethyl group

R⁶¹, R⁶²: propargyl group, R⁶³, R⁶⁴: ethyl group

R⁶¹: propargyl group, R⁶²: hydrogen group, R⁶³, R⁶⁴: ethyl group

R⁶¹, R⁶²: allyl group, R⁶³, R⁶⁴: propyl group

R⁶¹: allyl group, R⁶²: hydrogen group, R⁶³, R⁶⁴: propyl group

R⁶¹, R⁶²: propargyl group, R⁶³, R⁶⁴: propyl group

R⁶¹: propargyl group, R⁶²: hydrogen group, R⁶³, R⁶⁴: propyl group

Preferred examples from the viewpoint of suppressing gas generation during high-temperature storage, and improving the charge and discharge characteristics of battery include the following.

R⁶¹ to R⁶⁴: allyl group

R⁶¹, R⁶³: allyl group, R⁶², R⁶⁴: hydrogen group

R⁶¹, R⁶³: propargyl group, R⁶², R⁶⁴: hydrogen group

R⁶¹, R⁶²: allyl group, R⁶³, R⁶⁴: methyl group

R⁶¹: allyl group, R⁶²: hydrogen group, R⁶³, R⁶⁴: methyl group

R⁶¹: propargyl group, R⁶²: hydrogen group, R⁶³, R⁶⁴: methyl group

R⁶¹, R⁶²: allyl group, R⁶³, R⁶⁴: ethyl group

R⁶¹: allyl group, R⁶²: hydrogen group, R⁶³, R⁶⁴: ethyl group

R⁶¹: propargyl group, R⁶²: hydrogen group, R⁶³, R⁶⁴: ethyl group

R⁶¹, R⁶²: allyl group, R⁶³, R⁶⁴: propyl group

R⁶¹: allyl group, R⁶²: hydrogen group, R⁶³, R⁶⁴: propyl group

R⁶¹: propargyl group, R⁶²: hydrogen group, R⁶³, R⁶⁴: propyl group

Further preferred examples include the following.

R⁶¹ to R⁶⁴: allyl group

R⁶¹, R⁶²: allyl group, R⁶³, R⁶⁴: methyl group

R⁶¹, R⁶²: allyl group, R⁶³, R⁶⁴: ethyl group

R⁶¹, R⁶²: allyl group, R⁶³, R⁶⁴: propyl group

### 16. Cyclic Sulfamide

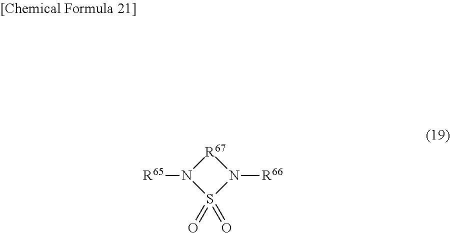

Examples of R⁶⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁶⁶ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁶⁷ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R⁶⁵ to R⁶⁷ from the viewpoint of battery characteristics are those in which R⁶⁵ is an allyl group or a propargyl group. Specific examples include the following.

R⁶⁵, R⁶⁶: allyl group, R⁶⁷: ethylene group

R⁶⁵, R⁶⁶: propargyl group, R⁶⁷: ethylene group

R⁶⁵: allyl group, R⁶⁶: hydrogen group, R⁶⁷: ethylene group

R⁶⁵: propargyl group, R⁶⁶: hydrogen group, R⁶⁷: ethylene group

R⁶⁵, R⁶⁶: allyl group, R⁶⁷: trimethylene group

R⁶⁵, R⁶⁶: propargyl group, R⁶⁷: trimethylene group

R⁶⁵: allyl group, R⁶⁶: hydrogen group, R⁶⁷: trimethylene group

R⁶⁵: propargyl group, R⁶⁶: hydrogen group, R⁶⁷: trimethylene group

R⁶⁵, R⁶⁶: allyl group, R⁶⁷: 2,2-dimethyltrimethylene group

R⁶⁵, R⁶⁶: propargyl group, R⁶⁷: 2,2-dimethyltrimethylene group

R⁶⁵: allyl group, R⁶⁶: hydrogen group, R⁶⁷: 2,2-dimethyltrimethylene group

R⁶⁵: propargyl group, R⁶⁶: hydrogen group, R⁶⁷: 2,2-dimethyltrimethylene group

Preferred examples from the viewpoint of suppressing gas generation during high-temperature storage, and improving the charge and discharge characteristics of battery include the following.

R⁶⁵, R⁶⁶: allyl group, R⁶⁷: ethylene group

R⁶⁵, R⁶⁶: propargyl group, R⁶⁷: ethylene group

R⁶⁵, R⁶⁶: allyl group, R⁶⁷: trimethylene group

R⁶⁵, R⁶⁶: propargyl group, R⁶⁷: trimethylene group

R⁶⁵, R⁶⁶: allyl group, R⁶⁷: 2,2-dimethyltrimethylene group

R⁶⁵, R⁶⁶: propargyl group, R⁶⁷: 2,2-dimethyltrimethylene group

### 17. Phosphoric Acid Monoamide

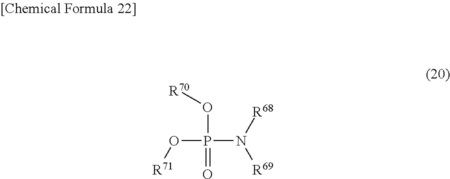

Examples of R⁶⁸ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁶⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁷⁰ and R⁷¹ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, and a 2-cyanoethyl group.

Preferred as combinations of R⁶⁸ to R⁷¹ from the viewpoint of battery characteristics are those in which R⁶⁸ is an allyl group or a propargyl group. Specific examples include the following.

R⁶⁸: allyl group, R⁶⁹: allyl group, R⁷⁰, R⁷¹: methyl group

R⁶⁸: allyl group, R⁶⁹: allyl group, R⁷⁰, R⁷¹: ethyl group

R⁶⁸: allyl group, R⁶⁹: allyl group, R⁷⁰, R⁷¹: cyclohexyl group

R⁶⁸: allyl group, R⁶⁹: allyl group, R⁷⁰, R⁷¹: phenyl group

R⁶⁸: allyl group, R⁶⁹: allyl group, R⁷⁰, R⁷¹: 2,2,2-trifluoroethyl group

R⁶⁸: allyl group, R⁶⁹: allyl group, R⁷⁰, R⁷¹: 2-cyanoethyl group

R⁶⁸: propargyl group, R⁶⁹: propargyl group, R⁷⁰, R⁷¹: methyl group

R⁶⁸: propargyl group, R⁶⁹: propargyl group, R⁷⁰, R⁷¹: ethyl group

R⁶⁸: propargyl group, R⁶⁹: propargyl group, R⁷⁰, R⁷¹: cyclohexyl group

R⁶⁸: propargyl group, R⁶⁹: propargyl group, R⁷⁰, R⁷¹: phenyl group

R⁶⁸: propargyl group, R⁶⁹: propargyl group, R⁷⁰, R⁷¹: 2,2,2-trifluoroethyl group

R⁶⁸: propargyl group, R⁶⁹: propargyl group, R⁷⁰, R⁷¹: 2-cyanoethyl group

R⁶⁸: allyl group, R⁶⁹: hydrogen group, R⁷⁰, R⁷¹: methyl group

R⁶⁸: allyl group, R⁶⁹: hydrogen group, R⁷⁰, R⁷¹: ethyl group

R⁶⁸: allyl group, R⁶⁹: hydrogen group, R⁷⁰, R⁷¹: cyclohexyl group

R⁶⁸: allyl group, R⁶⁹: hydrogen group, R⁷⁰, R⁷¹: phenyl group

R⁶⁸: allyl group, R⁶⁹: hydrogen group, R⁷⁰, R⁷¹: 2,2,2-trifluoroethyl group

R⁶⁸: allyl group, R⁶⁹: hydrogen group, R⁷⁰, R⁷¹: 2-cyanoethyl group

R⁶⁸: propargyl group, R⁶⁹: hydrogen group, R⁷⁰, R⁷¹: methyl group

R⁶⁸: propargyl group, R⁶⁹: hydrogen group, R⁷⁰, R⁷¹: ethyl group

R⁶⁸: propargyl group, R⁶⁹: hydrogen group, R⁷⁰, R⁷¹: cyclohexyl group

R⁶⁸: propargyl group, R⁶⁹: hydrogen group, R⁷⁰, R⁷¹: phenyl group

R⁶⁸: propargyl group, R⁶⁹: hydrogen group, R⁷⁰, R⁷¹: 2,2,2-trifluoroethyl group

R⁶⁸: propargyl group, R⁶⁹: hydrogen group, R⁷⁰, R⁷¹: 2-cyanoethyl group

Preferred examples from the viewpoint of suppressing gas generation during high-temperature storage, and improving the charge and discharge characteristics of battery include the following.

R⁶⁸: allyl group, R⁶⁹: allyl group, R⁷⁰, R⁷¹: methyl group

R⁶⁸: allyl group, R⁶⁹: allyl group, R⁷⁰, R⁷¹: ethyl group

R⁶⁸: allyl group, R⁶⁹: allyl group, R⁷⁰, R⁷¹: cyclohexyl group

R⁶⁸: allyl group, R⁶⁹: allyl group, R⁷⁰, R⁷¹: phenyl group

R⁶⁸: allyl group, R⁶⁹: allyl group, R⁷⁰, R⁷¹: 2,2,2-trifluoroethyl group

R⁶⁸: allyl group, R⁶⁹: allyl group, R⁷⁰, R⁷¹: 2-cyanoethyl group

R⁶⁸: allyl group, R⁶⁹: hydrogen group, R⁷⁰, R⁷¹: methyl group

R⁶⁸: allyl group, R⁶⁹: hydrogen group, R⁷⁰, R⁷¹: ethyl group

R⁶⁸: allyl group, R⁶⁹: hydrogen group, R⁷⁰, R⁷¹: cyclohexyl group

R⁶⁸: allyl group, R⁶⁹: hydrogen group, R⁷⁰, R⁷¹: phenyl group

R⁶⁸: allyl group, R⁶⁹: hydrogen group, R⁷⁰, R⁷¹: 2,2,2-trifluoroethyl group

R⁶⁸: allyl group, R⁶⁹: hydrogen group, R⁷⁰, R⁷¹: 2-cyanoethyl group

R⁶⁸: propargyl group, R⁶⁹: hydrogen group, R⁷⁰, R⁷¹: methyl group

R⁶⁸: propargyl group, R⁶⁹: hydrogen group, R⁷⁰, R⁷¹: ethyl group

R⁶⁸: propargyl group, R⁶⁹: hydrogen group, R⁷⁰, R⁷¹: cyclohexyl group

R⁶⁸: propargyl group, R⁶⁹: hydrogen group, R⁷⁰, R⁷¹: phenyl group

R⁶⁸: propargyl group, R⁶⁹: hydrogen group, R⁷⁰, R⁷¹: 2,2,2-trifluoroethyl group

R⁶⁸: propargyl group, R⁶⁹: hydrogen group, R⁷⁰, R⁷¹: 2-cyanoethyl group

Further preferred examples include the following.

R⁶⁸: allyl group, R⁶⁹: allyl group, R⁷⁰, R⁷¹: methyl group

R⁶⁸: allyl group, R⁶⁹: allyl group, R⁷⁰, R⁷¹: ethyl group

R⁶⁸: allyl group, R⁶⁹: allyl group, R⁷⁰, R⁷¹: cyclohexyl group

R⁶⁸: allyl group, R⁶⁹: allyl group, R⁷⁰, R⁷¹: phenyl group

R⁶⁸: allyl group, R⁶⁹: allyl group, R⁷⁰, R⁷¹: 2,2,2-trifluoroethyl group

R⁶⁸: allyl group, R⁶⁹: allyl group, R⁷⁰, R⁷¹: 2-cyanoethyl group

### 18. Cyclic Phosphoric Acid Monoamide

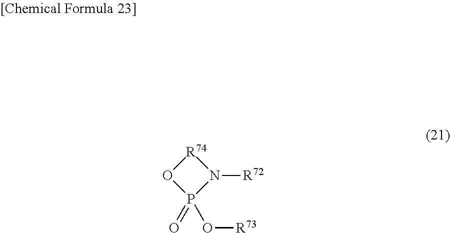

Examples of R⁷² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁷³ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, a 2-cyanoethyl group, and 2-cyano-1-(cyanomethyl)ethyl.

Examples of R⁷⁴ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R⁷² to R⁷⁴ from the viewpoint of battery characteristics are those in which R⁷² is an allyl group or a propargyl group. Examples include the following.

R⁷²: allyl group, R⁷³: methyl group, R⁷⁴: ethylene group

R⁷²: allyl group, R⁷³: ethyl group, R⁷⁴: ethylene group

R⁷²: allyl group, R⁷³: methyl group, R⁷⁴: trimethylene group

R⁷²: allyl group, R⁷³: ethyl group, R⁷⁴: trimethylene group

R⁷²: allyl group, R⁷³: methyl group, R⁷⁴: 2,2-dimethyltrimethylene group

R⁷²: allyl group, R⁷³: ethyl group, R⁷⁴: 2,2-dimethyltrimethylene group

R⁷²: propargyl group, R⁷³: methyl group, R⁷⁴: ethylene group

R⁷²: propargyl group, R⁷³: ethyl group, R⁷⁴: ethylene group

R⁷²: propargyl group, R⁷³: methyl group, R⁷⁴: trimethylene group

R⁷²: propargyl group, R⁷³: ethyl group, R⁷⁴: trimethylene group

R⁷²: propargyl group, R⁷³: methyl group, R⁷⁴: 2,2-dimethyltrimethylene group

R⁷²: propargyl group, R⁷³: ethyl group, R⁷⁴: 2,2-dimethyltrimethylene group

Preferred examples from the viewpoint of suppressing gas generation during high-temperature storage, and improving the charge and discharge characteristics of battery include the following.

R⁷²: allyl group, R⁷³: methyl group, R⁷⁴: ethylene group

R⁷²: allyl group, R⁷³: ethyl group, R⁷⁴: ethylene group

R⁷²: propargyl group, R⁷³: methyl group, R⁷⁴: ethylene group

R⁷²: propargyl group, R⁷³: ethyl group, R⁷⁴: ethylene group

### 19. Phosphoric Acid Diamide

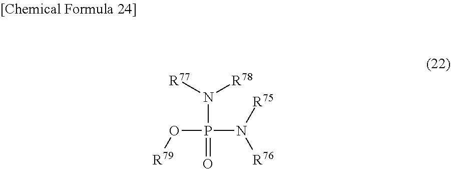

Examples of R⁷⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁷⁶ to R⁷⁸ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁷⁹ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, and a 2-cyanoethyl group.

Preferred as combinations of R⁷⁵ to R⁷⁹ from the viewpoint of battery characteristics are those in which R⁷⁵ is an allyl group or a propargyl group. Specific examples include the following.

R⁷⁵ to R⁷⁸: allyl group, R⁷⁹: methyl group

R⁷⁵, R⁷⁷: allyl group, R⁷⁶, R⁷⁸: hydrogen group, R⁷⁹: methyl group

R⁷⁵ to R⁷⁸: propargyl group, R⁷⁹: methyl group

R⁷⁵, R⁷⁷: propargyl group, R⁷⁶, R⁷⁸: hydrogen group, R⁷⁹: methyl group

R⁷⁵ to R⁷⁸: allyl group, R⁷⁹: ethyl group

R⁷⁵, R⁷⁷: allyl group, R⁷⁶, R⁷⁸: hydrogen group, R⁷⁹: ethyl group

R⁷⁵ to R⁷⁸: propargyl group, R⁷⁹: ethyl group

R⁷⁵, R⁷⁷: propargyl group, R⁷⁶, R⁷⁸: hydrogen group, R⁷⁹: ethyl group

R⁷⁵ to R⁷⁸: allyl group, R⁷⁹: 2,2,2-trifluoroethyl group

R⁷⁵, R⁷⁷: allyl group, R⁷⁶, R⁷⁸: hydrogen group, R⁷⁹: 2,2,2-trifluoroethyl group

R⁷⁵ to R⁷⁸: propargyl group, R⁷⁹: 2,2,2-trifluoroethyl group

R⁷⁵, R⁷⁷: propargyl group, R⁷⁶, R⁷⁸: hydrogen group, R⁷⁹: 2,2,2-trifluoroethyl group

Preferred examples from the viewpoint of suppressing gas generation during high-temperature storage, and improving the charge and discharge characteristics of battery include the following.

R⁷⁵ to R⁷⁸: allyl group, R⁷⁹: methyl group

R⁷⁵, R⁷⁷: allyl group, R⁷⁶, R⁷⁸: hydrogen group, R⁷⁹: methyl group

R⁷⁵, R⁷⁷: propargyl group, R⁷⁶, R⁷⁸: hydrogen group, R⁷⁹: methyl group

R⁷⁵ to R⁷⁸: allyl group, R⁷⁹: ethyl group

R⁷⁵, R⁷⁷: allyl group, R⁷⁶, R⁷⁸: hydrogen group, R⁷⁹: ethyl group

R⁷⁵, R⁷⁷: propargyl group, R⁷⁶, R⁷⁸: hydrogen group, R⁷⁹: ethyl group

R⁷⁵ to R⁷⁸: allyl group, R⁷⁹: 2,2,2-trifluoroethyl group

R⁷⁵, R⁷⁷: allyl group, R⁷⁶, R⁷⁸: hydrogen group, R⁷⁹: 2,2,2-trifluoroethyl group

R⁷⁵, R⁷⁷: propargyl group, R⁷⁶, R⁷⁸: hydrogen group, R⁷⁹: 2,2,2-trifluoroethyl group

### 20. Cyclic Phosphoric Acid Diamide

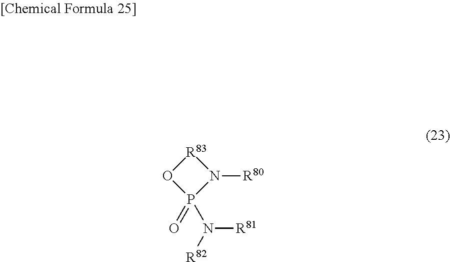

Examples of R⁸⁰ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁸¹ and R⁸² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁸³ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R⁸⁰ to R⁸³ from the viewpoint of battery characteristics are those in which R⁸⁰ is an allyl group or a propargyl group. Specific examples include the following.

R⁸⁰: allyl group, R⁸¹, R⁸²: methyl group, R⁸³: ethylene group

R⁸⁰: propargyl group, R⁸¹, R⁸²: methyl group, R⁸³: ethylene group

R⁸⁰: allyl group, R⁸¹, R⁸²: ethyl group, R⁸³: ethylene group

R⁸⁰: propargyl group, R⁸¹, R⁸²: ethyl group, R⁸³: ethylene group

R⁸⁰: allyl group, R⁸¹, R⁸²: allyl group, R⁸³: ethylene group

R⁸⁰: propargyl group, R⁸¹, R⁸²: allyl group, R⁸³: ethylene group

R⁸⁰: allyl group, R⁸¹, R⁸²: propargyl group, R⁸³: ethylene group

R⁸⁰: propargyl group, R⁸¹, R⁸²: propargyl group, R⁸³: ethylene group

R⁸⁰: allyl group, R⁸¹: allyl group, R⁸²: hydrogen group, R⁸³: ethylene group

R⁸⁰: propargyl group, R⁸¹: allyl group, R⁸²: hydrogen group, R⁸³: ethylene group

R⁸⁰: allyl group, R⁸¹: propargyl group, R⁸²: hydrogen group, R⁸³: ethylene group

R⁸⁰: propargyl group, R⁸¹: propargyl group, R⁸²: hydrogen group, R⁸³: ethylene group

Preferred examples from the viewpoint of suppressing gas generation during high-temperature storage, and improving the charge and discharge characteristics of battery include the following.

R⁸⁰: allyl group, R⁸¹, R⁸²: methyl group, R⁸³: ethylene group

R⁸⁰: allyl group, R⁸¹, R⁸²: ethyl group, R⁸³: ethylene group

R⁸⁰: allyl group, R⁸¹, R⁸²: allyl group, R⁸³: ethylene group

R⁸⁰: allyl group, R⁸¹: allyl group, R⁸²: hydrogen group, R⁸³: ethylene group

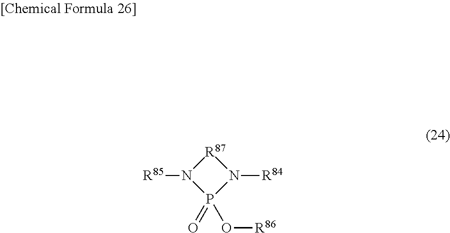

Examples of R⁸⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁸⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁸⁶ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, and a 2-cyanoethyl group.

Examples of R⁸⁷ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R⁸⁴ to R⁸⁷ from the viewpoint of battery characteristics are those in which R⁸⁴ is an allyl group or a propargyl group. Specific examples include the following.

R⁸⁴, R⁸⁵: allyl group, R⁸⁶: methyl group, R⁸⁷: ethylene group

R⁸⁴, R⁸⁵: propargyl group, R⁸⁶: methyl group, R⁸⁷: ethylene group

R⁸⁴: allyl group, R⁸⁵: hydrogen group, R⁸⁶: methyl group, R⁸⁷: ethylene group

R⁸⁴: propargyl group, R⁸⁵: hydrogen group, R⁸⁶: methyl group, R⁸⁷: ethylene group

R⁸⁴, R⁸⁵: allyl group, R⁸⁶: ethyl group, R⁸⁷: ethylene group

R⁸⁴, R⁸⁵: propargyl group, R⁸⁶: ethyl group, R⁸⁷: ethylene group

R⁸⁴: allyl group, R⁸⁵: hydrogen group, R⁸⁶: ethyl group, R⁸⁷: ethylene group

R⁸⁴: propargyl group, R⁸⁵: hydrogen group, R⁸⁶: ethyl group, R⁸⁷: ethylene group

R⁸⁴, R⁸⁵: allyl group, R⁸⁶: 2,2,2-trifluoroethyl group, R⁸⁷: ethylene group

R⁸⁴, R⁸⁵: propargyl group, R⁸⁶: 2,2,2-trifluoroethyl group, R⁸⁷: ethylene group

R⁸⁴: allyl group, R⁸⁵: hydrogen group, R⁸⁶: 2,2,2-trifluoroethyl group, R⁸⁷: ethylene group

R⁸⁴: propargyl group, R⁸⁵: hydrogen group, R⁸⁶: 2,2,2-trifluoroethyl group, R⁸⁷: ethylene group

Preferred examples from the viewpoint of suppressing gas generation during high-temperature storage, and improving the charge and discharge characteristics of battery include the following.

R⁸⁴, R⁸⁵: allyl group, R⁸⁶: methyl group, R⁸⁷: ethylene group

R⁸⁴: allyl group, R⁸⁵: hydrogen group, R⁸⁶: methyl group, R⁸⁷: ethylene group

R⁸⁴, R⁸⁵: allyl group, R⁸⁶: ethyl group, R⁸⁷: ethylene group

R⁸⁴: allyl group, R⁸⁵: hydrogen group, R⁸⁶: ethyl group, R⁸⁷: ethylene group

R⁸⁴, R⁸⁵: allyl group, R⁸⁶: 2,2,2-trifluoroethyl group, R⁸⁷: ethylene group R⁸⁴: allyl group, R⁸⁵: hydrogen group, R⁸⁶: 2,2,2-trifluoroethyl group, R⁸⁷: ethylene group

### 21. Phosphoric Acid Triamide

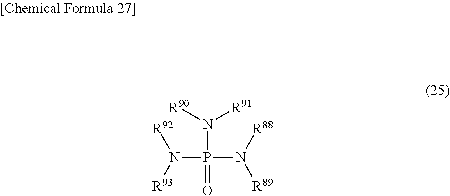

Examples of R⁸⁸ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁸⁹ to R⁹³ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Preferred as combinations of R⁸⁸ to R⁹³ from the viewpoint of battery characteristics are those in which R⁸⁸ is an allyl group or a propargyl group. Examples include the following.

R⁸⁸ to R⁹³: allyl group

R⁸⁸, R⁹⁰, R⁹²: allyl group, R⁸⁹, R⁹¹, R⁹³: hydrogen group

R⁸⁸ to R⁹³: propargyl group

R⁸⁸, R⁹⁰, R⁹²: propargyl group, R⁸⁹, R⁹¹, R⁹³: hydrogen group

R⁸⁸, R⁸⁹: allyl group, R⁹⁰ to R⁹³: methyl group

R⁸⁸: allyl group, R⁸⁹: hydrogen group, R⁹⁰ to R⁹³: methyl group

R⁸⁸ to R⁹¹: allyl group, R⁹², R⁹³: methyl group

R⁸⁸, R⁹⁰: allyl group, R⁸⁹, R⁹¹: hydrogen group, R⁹², R⁹³: methyl group

R⁸⁸, R⁹: propargyl group, R⁹⁰ to R⁹³: methyl group

R⁸⁸: propargyl group, R⁸⁹: hydrogen group, R⁹⁰ to R⁹³: methyl group

R⁸⁸ to R⁹¹: propargyl group, R⁹², R⁹³: methyl group

R⁸⁸, R⁹⁰: propargyl group, R⁸⁹, R⁹¹: hydrogen group, R⁹², R⁹³: methyl group

R⁸⁸, R⁸⁹: allyl group, R⁹⁰ to R⁹³: ethyl group

R⁸⁸: allyl group, R⁸⁹: hydrogen group, R⁹⁰ to R⁹³: ethyl group

R⁸⁸ to R⁹¹: allyl group, R⁹², R⁹³: ethyl group

R⁸⁸, R⁹⁰: allyl group, R⁸⁹, R⁹¹: hydrogen group, R⁹², R⁹³: ethyl group

R⁸⁸, R⁸⁹: propargyl group, R⁹⁰ to R⁹³: ethyl group

R⁸⁸: propargyl group, R⁸⁹: hydrogen group, R⁹⁰ to R⁹³: ethyl group

R⁸⁸ to R⁹¹: propargyl group, R⁹², R⁹³: ethyl group

R⁸⁸, R⁹⁰: propargyl group, R⁸⁹, R⁹¹: hydrogen group, R⁹², R⁹³: ethyl group

Preferred examples from the viewpoint of suppressing gas generation during high-temperature storage, and improving the charge and discharge characteristics of battery include the following.

R⁸⁸ to R⁹³: allyl group

R⁸⁸, R⁹⁰, R⁹²: allyl group, R⁸⁹, R⁹¹, R⁹³: hydrogen group

R⁸⁸, R⁹⁰, R⁹²: propargyl group, R⁸⁹, R⁹¹, R⁹³: hydrogen group

R⁸⁸, R⁸⁹: allyl group, R⁹⁰ to R⁹³: methyl group

R⁸⁸: allyl group, R⁸⁹: hydrogen group, R⁹⁰ to R⁹³: methyl group

R⁸⁸ to R⁹¹: allyl group, R⁹², R⁹³: methyl group

R⁸⁸, R⁹⁰: allyl group, R⁸⁹, R⁹¹: hydrogen group, R⁹², R⁹³: methyl group

R⁸⁸: propargyl group, R⁸⁹: hydrogen group, R⁹⁰ to R⁹³: methyl group

R⁸⁸, R⁹⁰: propargyl group, R⁸⁹, R⁹¹: hydrogen group, R⁹², R⁹³: methyl group

R⁸⁸, R⁸⁹: allyl group, R⁹⁰ to R⁹³: ethyl group

R⁸⁸: allyl group, R⁸⁹: hydrogen group, R⁹⁰ to R⁹³: ethyl group

R⁸⁸ to R⁹¹: allyl group, R⁹², R⁹³: ethyl group

R⁸⁸, R⁹⁰: allyl group, R⁸⁹, R⁹¹: hydrogen group, R⁹², R⁹³: ethyl group

R⁸⁸: propargyl group, R⁸⁹: hydrogen group, R⁹⁰ to R⁹³: ethyl group

R⁸⁸, R⁹⁰: propargyl group, R⁸⁹, R⁹¹: hydrogen group, R⁹², R⁹³: ethyl group

Further preferred examples include the following.

R⁸⁸ to R⁹³: allyl group

R⁸⁸, R⁹⁰, R⁹²: allyl group, R⁸⁹, R⁹¹, R⁹³: hydrogen group

R⁸⁸, R⁸⁹: allyl group, R⁹⁰ to R⁹³: methyl group

R⁸⁸: allyl group, R⁸⁹: hydrogen group, R⁹⁰ to R⁹³: methyl group

R⁸⁸ to R⁹¹: allyl group, R⁹², R⁹³: methyl group

R⁸⁸, R⁹⁰: allyl group, R⁸⁹, R⁹¹: hydrogen group, R⁹², R⁹³: methyl group

R⁸⁸, R⁸⁹: allyl group, R⁹⁰ to R⁹³: ethyl group

R⁸⁸: allyl group, R⁸⁹: hydrogen group, R⁹⁰ to R⁹³: ethyl group

R⁸⁸ to R⁹¹: allyl group, R⁹², R⁹³: ethyl group

R⁸⁸, R⁹⁰: allyl group, R⁸⁹, R⁹¹: hydrogen group, R⁹², R⁹³: ethyl group

### 22. Cyclic Phosphoric Acid Triamide

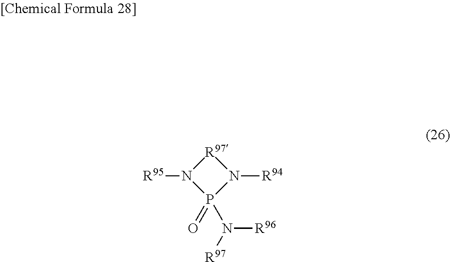

Examples of R⁹⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁹⁵ to R⁹⁷ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R⁹⁷′ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R⁹⁴ to R⁹⁷′ from the viewpoint of battery characteristics are those in which R⁹⁴ is an allyl group or a propargyl group. Examples include the following.

R⁹⁴, R⁹⁵: allyl group, R⁹⁶, R⁹⁷: methyl group, R⁷′: ethylene group

R⁹⁴, R⁹⁵: propargyl group, R⁹⁶, R⁹⁷: methyl group, R⁹⁷′: ethylene group

R⁹⁴, R⁹⁵: allyl group, R⁹⁶, R⁹⁷: ethyl group, R⁹⁷′: ethylene group

R⁹⁴, R⁹⁵: propargyl group, R⁹⁶, R⁹⁷: ethyl group, R⁹⁷′: ethylene group

R⁹⁴, R⁹⁵: allyl group, R⁹⁶, R⁹⁷: allyl group, R⁹⁷′: ethylene group

R⁹⁴, R⁹⁵: propargyl group, R⁹⁶, R⁹⁷: allyl group, R⁹⁷′: ethylene group

R⁹⁴, R⁹⁵: allyl group, R⁹⁶: allyl group, R⁹⁷: hydrogen group, R⁹⁷′: ethylene group

R⁹⁴, R⁹⁵: propargyl group, R⁹⁶: allyl group, R⁹⁷: hydrogen group, R⁹⁷′: ethylene group

R⁹⁴, R⁹⁵: allyl group, R⁹⁶: propargyl group, R⁹⁷: hydrogen group, R⁹⁷′: ethylene group

R⁹⁴, R⁹⁵: propargyl group, R⁹⁶: propargyl group, R⁹⁷: hydrogen group, R⁹⁷′: ethylene group

Preferred examples from the viewpoint of suppressing gas generation during high-temperature storage, and improving the charge and discharge characteristics of battery include the following.

R⁹⁴, R⁹⁵: allyl group, R⁹⁶, R⁹⁷: methyl group, R⁹⁷′: ethylene group

R⁹⁴, R⁹⁵: allyl group, R⁹⁶, R⁹⁷: ethyl group, R⁹⁷′: ethylene group

R⁹⁴, R⁹⁵: allyl group, R⁹⁶, R⁹⁷: allyl group, R⁹⁷′: ethylene group

R⁹⁴, R⁹⁵: allyl group, R⁹⁶: allyl group, R⁹⁷: hydrogen group, R⁹⁷′: ethylene group

### 23. Phosphonic Acid Monoamide

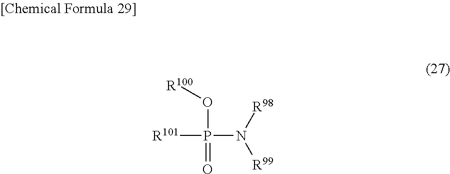

Examples of R⁹⁸ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R⁹⁹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R¹⁰⁰ include methyl, an ethyl group, a propyl group, an isopropyl group, a butyl group, a t-butyl group, a pentyl group, a hexyl group, a cyclohexyl group, a 2,2,2-trifluoroethyl group, an allyl group, a phenyl group, a benzyl group, and a phenethyl group. Examples of substituents containing a heteroatom include methoxyethyl, ethoxyethyl, and a 2-cyanoethyl group.

Examples of R¹⁰¹ include a hydrogen group, methyl, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of substituents containing a heteroatom include methoxymethyl, ethoxymethyl, an acetylmethyl group, a cyanomethyl group, a 1-cyanoethyl group, and a 2-cyanoethyl group.

Preferred as combinations of R⁹⁸ to R¹⁰¹ from the viewpoint of battery characteristics are those in which R⁹⁸ is an allyl group or a propargyl group. Examples include the following.

R⁹⁸, R⁹⁹: allyl group, R¹⁰⁰: methyl group, R¹⁰¹: methyl group

R⁹⁸, R⁹⁹: allyl group, R¹⁰⁰: ethyl group, R¹⁰¹: methyl group

R⁹⁸, R⁹⁹: allyl group, R¹⁰⁰: methyl group, R¹⁰¹: ethyl group

R⁹⁸, R⁹⁹: allyl group, R¹⁰⁰: 2,2,2-trifluoroethyl group, R¹⁰¹: methyl group

R⁹⁸, R⁹⁹: allyl group, R¹⁰⁰: 2,2,2-trifluoroethyl group, R¹⁰¹: ethyl group

R⁹⁸: allyl group, R⁹⁹: hydrogen group, R¹⁰⁰: methyl group, R¹⁰¹: methyl group

R⁹⁸: allyl group, R⁹⁹: hydrogen group, R¹⁰⁰: ethyl group, R¹⁰¹: methyl group

R⁹⁸: allyl group, R⁹⁹: hydrogen group, R¹⁰⁰: methyl group, R¹⁰¹: ethyl group

R⁹⁸: allyl group, R⁹⁹: hydrogen group, R¹⁰⁰: 2,2,2-trifluoroethyl group, R¹⁰¹: methyl group

R⁹⁸: allyl group, R⁹⁹: hydrogen group, R¹⁰⁰: 2,2,2-trifluoroethyl group, R¹⁰¹: ethyl group

R⁹⁸, R⁹⁹: propargyl group, R¹⁰⁰: methyl group, R¹⁰¹: methyl group

R⁹⁸, R⁹⁹: propargyl group, R¹⁰⁰: ethyl group, R¹⁰¹: methyl group

R⁹⁸, R⁹⁹: propargyl group, R¹⁰⁰: methyl group, R¹⁰¹: ethyl group

R⁹⁸, R⁹⁹: propargyl group, R¹⁰⁰: 2,2,2-trifluoroethyl group, R¹⁰¹: methyl group

R⁹⁸, R⁹⁹: propargyl group, R¹⁰⁰: 2,2,2-trifluoroethyl group, R¹⁰¹: ethyl group

R⁹⁸: propargyl group, R⁹⁹: hydrogen group, R¹⁰⁰: methyl group, R¹⁰¹: methyl group

R⁹⁸: propargyl group, R⁹⁹: hydrogen group, R¹⁰⁰: ethyl group, R¹⁰¹: methyl group

R⁹⁸: propargyl group, R⁹⁹: hydrogen group, R¹⁰⁰: methyl group, R¹⁰¹: ethyl group

R⁹⁸: propargyl group, R⁹⁹: hydrogen group, R¹⁰⁰: 2,2,2-trifluoroethyl group, R¹⁰¹: methyl group

R⁹⁸: propargyl group, R⁹⁹: hydrogen group, R¹⁰⁰: 2,2,2-trifluoroethyl group, R¹⁰¹: ethyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸: allyl group, R⁹⁹: hydrogen group, R¹⁰⁰: methyl group, R¹⁰¹: phenyl group

R⁹⁸: allyl group, R⁹⁹: hydrogen group, R¹⁰⁰: ethyl group, R¹⁰¹: phenyl group

R⁹⁸, R⁹⁹: propargyl group, R¹⁰⁰: methyl group, R¹⁰¹: phenyl group

R⁹⁸, R⁹⁹: propargyl group, R¹⁰⁰: ethyl group, R¹⁰¹: phenyl group

R⁹⁸, R⁹⁹: propargyl group, R¹⁰⁰: methyl group, R¹⁰¹: phenyl group

R⁹⁸, R⁹⁹: propargyl group, R¹⁰⁰: ethyl group, R¹⁰¹: phenyl group

R⁹⁸: propargyl group, R⁹⁹: hydrogen group, R¹⁰⁰: methyl group, R¹⁰¹: phenyl group

R⁹⁸: propargyl group, R⁹⁹: hydrogen group, R¹⁰⁰: ethyl group, R¹⁰¹: phenyl group

R⁹⁸, R⁹⁹: allyl group, R¹⁰⁰: methyl group, R¹⁰¹: vinyl group

R⁹⁸, R⁹⁹: allyl group, R¹⁰⁰: ethyl group, R¹⁰¹: vinyl group

R⁹⁸, R⁹⁹: allyl group, R¹⁰⁰: methyl group, R¹⁰¹: vinyl group

R⁹⁸, R⁹⁹: allyl group, R¹⁰⁰: ethyl group, R¹⁰¹: vinyl group

R⁹⁸: allyl group, R⁹⁹: hydrogen group, R¹⁰⁰: methyl group, R¹⁰¹: vinyl group

R⁹⁸: allyl group, R⁹⁹: hydrogen group, R¹⁰⁰: ethyl group, R¹⁰¹: vinyl group

R⁹⁸, R⁹⁹: propargyl group, R¹⁰⁰: methyl group, R¹⁰¹: vinyl group

R⁹⁸, R⁹⁹: propargyl group, R¹⁰⁰: ethyl group, R¹⁰¹: vinyl group

R⁹⁸, R⁹⁹: propargyl group, R¹⁰⁰: methyl group, R¹⁰¹: vinyl group

R⁹⁸, R⁹⁹: propargyl group, R¹⁰⁰: ethyl group, R¹⁰¹: vinyl group

R⁹⁸: propargyl group, R⁹⁹: hydrogen group, R¹⁰⁰: methyl group, R¹⁰¹: vinyl group

R⁹⁸: propargyl group, R⁹⁹: hydrogen group, R¹⁰⁰: ethyl group, R¹⁰¹: phenyl group

Preferred examples from the viewpoint of suppressing gas generation during high-temperature storage, and improving the charge and discharge characteristics of battery include the following.

R⁹⁸, R⁹⁹: allyl group, R¹⁰⁰: methyl group, R¹⁰¹: methyl group

R⁹⁸, R⁹⁹: allyl group, R¹⁰⁰: ethyl group, R¹⁰¹: methyl group

R⁹⁸, R⁹⁹: allyl group, R¹⁰⁰: methyl group, R¹⁰¹: ethyl group

R⁹⁸, R⁹⁹: allyl group, R¹⁰⁰: 2,2,2-trifluoroethyl group, R¹⁰¹: methyl group

R⁹⁸, R⁹⁹: allyl group, R¹⁰⁰: 2,2,2-trifluoroethyl group, R¹⁰¹: ethyl group

R⁹⁸: allyl group, R⁹⁹: hydrogen group, R¹⁰⁰: methyl group, R¹⁰¹: methyl group

R⁹⁸: allyl group, R⁹⁹: hydrogen group, R¹⁰⁰: ethyl group, R¹⁰¹: methyl group

R⁹⁸: allyl group, R⁹⁹: hydrogen group, R¹⁰⁰: methyl group, R¹⁰¹: ethyl group

R⁹⁸: allyl group, R⁹⁹: hydrogen group, R¹⁰⁰: 2,2,2-trifluoroethyl group, R¹⁰¹: methyl group

R⁹⁸: allyl group, R⁹⁹: hydrogen group, R¹⁰⁰: 2,2,2-trifluoroethyl group, R¹⁰¹: ethyl group

R⁹⁸: propargyl group, R⁹⁹: hydrogen group, R¹⁰⁰: methyl group, R¹⁰¹: methyl group

R⁹⁸: propargyl group, R⁹⁹: hydrogen group, R¹⁰⁰: ethyl group, R¹⁰¹: methyl group

R⁹⁸: propargyl group, R⁹⁹: hydrogen group, R¹⁰⁰: methyl group, R¹⁰¹: ethyl group

R⁹⁸: propargyl group, R⁹⁹: hydrogen group, R¹⁰⁰: 2,2,2-trifluoroethyl group, R¹⁰¹: methyl group

R⁹⁸: propargyl group, R⁹⁹: hydrogen group, R¹⁰⁰: 2,2,2-trifluoroethyl group, R¹⁰¹: ethyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸: propargyl group, R⁹⁹: hydrogen group, R¹⁰⁰: methyl group, R¹⁰¹: phenyl group

R⁹⁸: propargyl group, R⁹⁹: hydrogen group, R¹⁰⁰: ethyl group, R¹⁰¹: phenyl group

R⁹⁸, R⁹⁹: allyl group, R¹⁰⁰: methyl group, R¹⁰¹: vinyl group

R⁹⁸, R⁹⁹: allyl group, R¹⁰⁰: ethyl group, R¹⁰¹: vinyl group

R⁹⁸, R⁹⁹: allyl group, R¹⁰⁰: methyl group, R¹⁰¹: vinyl group

R⁹⁸, R⁹⁹: allyl group, R¹⁰⁰: ethyl group, R¹⁰¹: vinyl group

R⁹⁸: allyl group, R⁹⁹: hydrogen group, R¹⁰⁰: methyl group, R¹⁰¹: vinyl group

R⁹⁸: allyl group, R⁹⁹: hydrogen group, R¹⁰⁰: ethyl group, R¹⁰¹: vinyl group

R⁹⁸: propargyl group, R⁹⁹: hydrogen group, R¹⁰⁰: methyl group, R¹⁰¹: vinyl group

R⁹⁸: propargyl group, R⁹⁹: hydrogen group, R¹⁰⁰: ethyl group, R¹⁰¹: phenyl group

Further preferred examples include the following.

R⁹⁸, R⁹⁹: allyl group, R¹⁰⁰: methyl group, R¹⁰¹: methyl group

R⁹⁸, R⁹⁹: allyl group, R¹⁰⁰: ethyl group, R¹⁰¹: methyl group

R⁹⁸, R⁹⁹: allyl group, R¹⁰⁰: methyl group, R¹⁰¹: ethyl group

R⁹⁸, R⁹⁹: allyl group, R¹⁰⁰: 2,2,2-trifluoroethyl group, R¹⁰¹: methyl group

R⁹⁸, R⁹⁹: allyl group, R¹⁰⁰: 2,2,2-trifluoroethyl group, R¹⁰¹: ethyl group

R⁹⁸: allyl group, R⁹⁹: hydrogen group, R¹⁰⁰: methyl group, R¹⁰¹: methyl group

R⁹⁸: allyl group, R⁹⁹: hydrogen group, R¹⁰⁰: ethyl group, R¹⁰¹: methyl group

R⁹⁸: allyl group, R⁹⁹: hydrogen group, R¹⁰⁰: methyl group, R¹⁰¹: ethyl group

R⁹⁸: allyl group, R⁹⁹: hydrogen group, R¹⁰⁰: 2,2,2-trifluoroethyl group, R¹⁰¹: methyl group

R⁹⁸: allyl group, R⁹⁹: hydrogen group, R¹⁰⁰: 2,2,2-trifluoroethyl group, R¹⁰¹: ethyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸, R⁹⁹: allyl group, R¹⁰⁰: methyl group, R¹⁰¹: phenyl group

R⁹⁸, R⁹⁹: allyl group, R¹⁰⁰: ethyl group, R¹⁰¹: phenyl group

R⁹⁸: allyl group, R⁹⁹: hydrogen group, R¹⁰⁰: methyl group, R¹⁰¹: phenyl group

R⁹⁸: allyl group, R⁹⁹: hydrogen group, R¹⁰⁰: ethyl group, R¹⁰¹: phenyl group

### 24. Cyclic Phosphonic Acid Monoamide

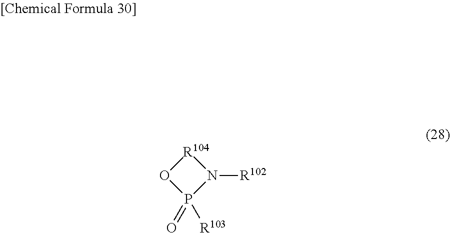

Examples of R¹⁰² include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹⁰³ include a hydrogen group, methyl, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of substituents containing a heteroatom include methoxymethyl, ethoxymethyl, an acetylmethyl group, a cyanomethyl group, a 1-cyanoethyl group, and a 2-cyanoethyl group.

Examples of R¹⁰⁴ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R¹⁰² to R¹⁰⁴ from the viewpoint of improving battery characteristics are those in which R¹⁰² is an allyl group or a propargyl group. Examples include the following.

R¹⁰²: allyl group, R¹⁰³: methyl group, R¹⁰⁴: ethylene group

R¹⁰²: allyl group, R¹⁰³: ethyl group, R¹⁰⁴: ethylene group

R¹⁰²: allyl group, R¹⁰³: phenyl group, R¹⁰⁴: ethylene group

R¹⁰²: allyl group, R¹⁰³: vinyl group, R¹⁰⁴: ethylene group

R¹⁰²: propargyl group, R¹⁰³: methyl group, R¹⁰⁴: ethylene group

R¹⁰²: propargyl group, R¹⁰³: ethyl group, R¹⁰⁴: ethylene group

R¹⁰²: propargyl group, R¹⁰³: phenyl group, R¹⁰⁴: ethylene group

R¹⁰²: propargyl group, R¹⁰³: vinyl group, R¹⁰⁴: ethylene group

Preferred examples from the viewpoint of suppressing gas generation during high-temperature storage, and improving the charge and discharge characteristics of battery include the following.

R¹⁰²: allyl group, R¹⁰³: methyl group, R¹⁰⁴: ethylene group

R¹⁰²: allyl group, R¹⁰³: ethyl group, R¹⁰⁴: ethylene group

R¹⁰²: allyl group, R¹⁰³: phenyl group, R¹⁰⁴: ethylene group

R¹⁰²: propargyl group, R¹⁰³: methyl group, R¹⁰⁴: ethylene group

R¹⁰²: propargyl group, R¹⁰³: ethyl group, R¹⁰⁴: ethylene group

R¹⁰²: propargyl group, R¹⁰³: phenyl group, R¹⁰⁴: ethylene group

### 25. Phosphonic Acid Diamide

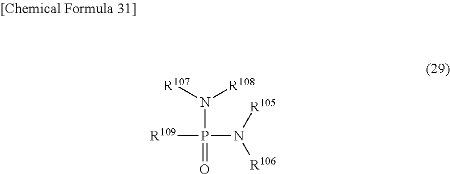

Examples of R¹⁰⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹⁰⁶ to 108 include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R¹⁰⁹ include a hydrogen group, methyl, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of substituents containing a heteroatom include methoxymethyl, ethoxymethyl, an acetylmethyl group, a cyanomethyl group, a 1-cyanoethyl group, and a 2-cyanoethyl group.

Preferred as combinations of R¹⁰⁵ to R¹⁰⁹ from the viewpoint of improving battery characteristics are those in which R¹⁰⁵ is an allyl group or a propargyl group. Examples include the following.

R¹⁰⁵ to R¹⁰⁸: allyl group, R¹¹⁹: methyl group

R¹⁰⁵, R¹⁰⁷: allyl group, R¹⁰⁶, R¹⁰⁸: hydrogen group, R¹⁰⁹: methyl group

R¹⁰⁵ to R¹⁰⁸: propargyl group, R¹⁰⁹: methyl group

R¹⁰⁵, R¹⁰⁷: propargyl group, R¹⁰⁶, R¹⁰⁸: hydrogen group, R¹⁰⁹: methyl group

R¹⁰⁵ to R¹⁰⁸: allyl group, R¹⁰⁹: ethyl group

R¹⁰⁵, R¹⁰⁷: allyl group, R¹⁰⁶, R¹⁰⁸: hydrogen group, R¹⁰⁹: ethyl group

R¹⁰⁵ to R¹⁰⁸: propargyl group, R¹⁰⁹: ethyl group

R¹⁰⁵, R¹⁰⁷: propargyl group, R¹⁰⁶, R¹⁰⁸: hydrogen group, R¹⁰⁹: ethyl group

R¹⁰⁵ to R¹⁰⁸: allyl group, R¹⁰⁹: phenyl group

R¹⁰⁵, R¹⁰⁷: allyl group, R¹⁰⁶, R¹⁰⁸: hydrogen group, R¹⁰⁹: phenyl group

R¹⁰⁵ to R¹⁰⁸: propargyl group, R¹⁰⁹: phenyl group

R¹⁰⁵, R¹⁰⁷: propargyl group, R¹⁰⁶, R¹⁰⁸: hydrogen group, R¹⁰⁹: phenyl group

R¹⁰⁵ to R¹⁰⁸: allyl group, R¹⁰⁹: vinyl group

R¹⁰⁵, R¹⁰⁷: allyl group, R¹⁰⁶, R¹⁰⁸: hydrogen group, R¹⁰⁹: vinyl group

R¹⁰⁵ to R¹⁰⁸: propargyl group, R¹⁰⁹: vinyl group

R¹⁰⁵, R¹⁰⁷: propargyl group, R¹⁰⁶, R¹⁰⁸: hydrogen group, R¹⁰⁹: vinyl group

Preferred examples from the viewpoint of suppressing gas generation during high-temperature storage, and improving the charge and discharge characteristics of battery include the following.

R¹⁰⁵ to R¹⁰⁸: allyl group, R¹⁰⁹: methyl group

R¹⁰⁵, R¹⁰⁷: allyl group, R¹⁰⁶, R¹⁰⁸: hydrogen group, R¹⁰⁹: methyl group

R¹⁰⁵, R¹⁰⁷: propargyl group, R¹⁰⁶, R¹⁰⁸: hydrogen group, R¹⁰⁹: methyl group

R¹⁰⁵ to R¹⁰⁸: allyl group, R¹⁰⁹: ethyl group

R¹⁰⁵, R¹⁰⁷: allyl group, R¹⁰⁶, R¹⁰⁸: hydrogen group, R¹⁰⁹: ethyl group

R¹⁰⁵, R¹⁰⁷: propargyl group, R¹⁰⁶, R¹⁰⁸: hydrogen group, R¹⁰⁹: ethyl group

R¹⁰⁵ to R¹⁰⁸: allyl group, R¹⁰⁹: phenyl group

R¹⁰⁵, R¹⁰⁷: allyl group, R¹⁰⁶, R¹⁰⁸: hydrogen group, R¹⁰⁹: phenyl group

R¹⁰⁵, R¹⁰⁷: propargyl group, R¹⁰⁶, R¹⁰⁸: hydrogen group, R¹⁰⁹: phenyl group

R¹⁰⁵ to R¹⁰⁸: allyl group, R¹⁰⁹: vinyl group

R¹⁰⁵, R¹⁰⁷: allyl group, R¹⁰⁶, R¹⁰⁸: hydrogen group, R¹⁰⁹: vinyl group

R¹⁰⁵, R¹⁰⁷: propargyl group, R¹⁰⁶, R¹⁰⁸: hydrogen group, R¹⁰⁹: vinyl group

Further preferred examples include the following.

R¹⁰⁵ to R¹⁰⁸: allyl group, R¹⁰⁹: methyl group

R¹⁰⁵, R¹⁰⁷: allyl group, R¹⁰⁶, R¹⁰⁸: hydrogen group, R¹⁰⁹: methyl group

R¹⁰⁵ to R¹⁰⁸: allyl group, R¹⁰⁹: ethyl group

R¹⁰⁵, R¹⁰⁷: allyl group, R¹⁰⁶, R¹⁰⁸: hydrogen group, R¹⁰⁹: ethyl group

R¹⁰⁰ to R¹⁰⁸: allyl group, R¹⁰⁹: phenyl group

R¹⁰⁵, R¹⁰⁷: allyl group, R¹⁰⁶, R¹⁰⁸: hydrogen group, R¹⁰⁹: phenyl group

R¹⁰⁵ to R¹⁰⁸: allyl group, R¹⁰⁹: vinyl group

R¹⁰⁵, R¹⁰⁷: allyl group, R¹⁰⁶, R¹⁰⁸: hydrogen group, R¹⁰⁹: vinyl group

### 26. Cyclic Phosphonic Acid Diamide

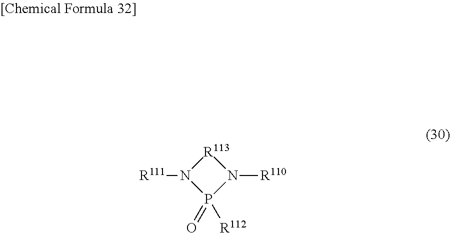

Examples of R¹¹⁰ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹¹¹ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R¹¹² include a hydrogen group, methyl, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of substituents containing a heteroatom include methoxymethyl, ethoxymethyl, an acetylmethyl group, a cyanomethyl group, a 1-cyanoethyl group, and a 2-cyanoethyl group.

Examples of R¹¹³ include an ethylene group, a propylene group, a trimethylene group, a 1-methyltrimethylene group, a 2-methyltrimethylene group, a 3-methyltrimethylene group, and a 2,2-dimethyltrimethylene group.

Preferred as combinations of R¹¹⁰ to R¹¹³ from the viewpoint of battery characteristics are those in which R¹¹⁰ is an allyl group or a propargyl group. Examples include the following.

R¹¹⁰, R¹¹¹: allyl group, R¹¹²: methyl group, R¹¹³: ethylene group

R¹¹⁰, R¹¹¹: allyl group, R¹¹²: ethyl group, R¹¹³: ethylene group

R¹¹⁰, R¹¹¹: allyl group, R¹¹²: phenyl group, R¹¹³: ethylene group

R¹¹⁰, R¹¹¹: allyl group, R¹¹²: vinyl group, R¹¹³: ethylene group

R¹¹⁰, R¹¹¹: propargyl group, R¹¹²: methyl group, R¹¹³: ethylene group

R¹¹⁰, R¹¹¹: propargyl group, R¹¹²: ethyl group, R¹¹³: ethylene group

R¹¹⁰, R¹¹¹: propargyl group, R¹¹²: phenyl group, R¹¹³: ethylene group

R¹¹⁰, R¹¹¹: propargyl group, R¹¹²: vinyl group, R¹¹³: ethylene group

Preferred examples from the viewpoint of suppressing gas generation during high-temperature storage, and improving the charge and discharge characteristics of battery include the following.

R¹¹⁰, R¹¹¹: allyl group, R¹¹²: methyl group, R¹¹³: ethylene group

R¹¹⁰, R¹¹¹: allyl group, R¹¹²: ethyl group, R¹¹³: ethylene group

R¹¹⁰, R¹¹¹: allyl group, R¹¹²: phenyl group, R¹¹³: ethylene group

R¹¹⁰, R¹¹¹: allyl group, R¹¹²: vinyl group, R¹¹³: ethylene group

### 27. Phosphinic Amide

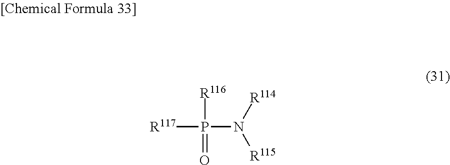

Examples of R¹¹⁴ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of R¹¹⁵ include an allyl group, a propargyl group, a cis-2-butenyl group, a trans-2-butenyl group, a 3-butenyl group, a 2-butynyl group, a 3-butynyl group, a 4-pentenyl group, a 4-pentynyl group, a 5-hexenyl group, a 5-hexynyl group, a 7-octenyl group, a 7-octynyl group, a 9-decenyl group, and a 9-decynyl group, of which groups having a terminal carbon-carbon unsaturated bond such as an allyl group, a propargyl group, a 3-butenyl group, a 3-butynyl group, a 4-pentenyl group, and a 4-pentynyl group are preferred from the viewpoint of battery characteristics.

Examples of other substituents include a hydrogen group, a methyl group, an ethyl group, a propyl group, an isopropyl group, a butyl group, a pentyl group, a hexyl group, an octyl group, a decyl group, a cyclopentyl group, a cyclohexyl group, a phenyl group, a benzyl group, a phenethyl group, a 2-methoxyethyl group, and a 2-ethoxyethyl group.

Examples of R¹¹⁶ and R¹¹⁷ include a hydrogen group, methyl, an ethyl group, a propyl group, an isopropyl group, a butyl group, a t-butyl group, a pentyl group, a hexyl group, a heptyl group, an octyl group, a nonyl group, a decyl group, a cyclohexyl group, a fluoromethyl group, a difluoromethyl group, a trifluoromethyl group, a pentafluoroethyl group, a heptafluoropropyl group, a vinyl group, an allyl group, a 1-propenyl group, an isopropenyl group, a phenyl group, a benzyl group, and a phenethyl group. Examples of substituents containing a heteroatom include methoxymethyl, ethoxymethyl, an acetylmethyl group, a cyanomethyl group, a 1-cyanoethyl group, and a 2-cyanoethyl group.

Preferred as combinations of R¹¹⁴ to R¹¹⁷ from the viewpoint of battery characteristics are those in which R¹¹⁴ is an allyl group or a propargyl group. Examples include the following.

R¹¹⁴, R¹¹⁵: allyl group, R¹¹⁶, R¹¹⁷: methyl group

R¹¹⁴: allyl group, R¹¹⁵: hydrogen group, R¹¹⁶, R¹¹⁷: methyl group

R¹¹⁴, R¹¹⁵: propargyl group, R¹¹⁶, R¹¹⁷: methyl group

R¹¹⁴: propargyl group, R¹¹⁵: hydrogen group, R¹¹⁶, R¹¹⁷: methyl group

R¹¹⁴, R¹¹⁵: allyl group, R¹¹⁶, R¹¹⁷: ethyl group

R¹¹⁴: allyl group, R¹¹⁵: hydrogen group, R¹¹⁶, R¹¹⁷: ethyl group

R¹¹⁴, R¹¹⁵: propargyl group, R¹¹⁶, R¹¹⁷: ethyl group

R¹¹⁴: propargyl group, R¹¹⁵: hydrogen group, R¹¹⁶, R¹¹⁷: ethyl group

R¹¹⁴, R¹¹⁵: allyl group, R¹¹⁶, R¹¹⁷: phenyl group

R¹¹⁴: allyl group, R¹¹⁵: hydrogen group, R¹¹⁶, R¹¹⁷: phenyl group

R¹¹⁴, R¹¹⁵: propargyl group, R¹¹⁶, R¹¹⁷: phenyl group

R¹¹⁴: propargyl group, R¹¹⁵: hydrogen group, R¹¹⁶, R¹¹⁷: phenyl group

Preferred examples from the viewpoint of suppressing gas generation during high-temperature storage, and improving the charge and discharge characteristics of battery include the following.

R¹¹⁴, R¹¹⁵: allyl group, R¹¹⁶, R¹¹⁷: methyl group

R¹¹⁴: allyl group, R¹¹⁵: hydrogen group, R¹¹⁶, R¹¹⁷: methyl group

R¹¹⁴: propargyl group, R¹¹⁵: hydrogen group, R¹¹⁶, R¹¹⁷: methyl group

R¹¹⁴, R¹¹⁵: allyl group, R¹¹⁶, R¹¹⁷: ethyl group

R¹¹⁴: allyl group, R¹¹⁵: hydrogen group, R¹¹⁶, R¹¹⁷: ethyl group

R¹¹⁴: propargyl group, R¹¹⁵: hydrogen group, R¹¹⁶, R¹¹⁷: ethyl group

R¹¹⁴, R¹¹⁵: allyl group, R¹¹⁶, R¹¹⁷: phenyl group

R¹¹⁴: allyl group, R¹¹⁵: hydrogen group, R¹¹⁶, R¹¹⁷: phenyl group

R¹¹⁴: propargyl group, R¹¹⁵: hydrogen group, R¹¹⁶, R¹¹⁷: phenyl group

Further preferred examples include the following.

R¹¹⁴, R¹¹⁵: allyl group, R¹¹⁶, R¹¹⁷: methyl group

R¹¹⁴: allyl group, R¹¹⁵: hydrogen group, R¹¹⁶, R¹¹⁷: methyl group

R¹¹⁴: propargyl group, R¹¹⁵: hydrogen group, R¹¹⁶, R¹¹⁷: methyl group

R¹¹⁴, R¹¹⁵: allyl group, R¹¹⁶, R¹¹⁷: ethyl group

R¹¹⁴: allyl group, R¹¹⁵: hydrogen group, R¹¹⁶, R¹¹⁷: ethyl group

R¹¹⁴: propargyl group, R¹¹⁵: hydrogen group, R¹¹⁶, R¹¹⁷: ethyl group

The content of the compound represented by the general formula (1) is not particularly limited, and is preferably 0.001 mass % or more and 10 mass % or less with respect to the nonaqueous electrolytic solution, further preferably 0.01 mass % or more, particularly preferably 0.1 mass % or more. On the other hand, the content is further preferably 5 mass % or less, and particularly preferably 3 mass % or less. With the content of the compound of the general formula (1) falling in these ranges, the advantages of the present invention can develop more easily, and the deterioration of battery characteristics due to increased resistance can be suppressed.

The compounds of the general formula (1) may be used alone or in a combination of two or more. When used in a combination of two or more, the content is the total content of the compounds.

With the electrolytic solution containing the compound of the general formula (1), the amount of generated gas during high-temperature storage can be reduced, and battery characteristics improve. Though the detailed mechanism remains elusive, it is believed that the compound of the general formula (1), being an amide compound having carbon-carbon unsaturated bond(s), is adsorbed on the positive electrode surface at the amide group moiety, and undergoes a polymerization reaction at the carbon-carbon unsaturated bond moiety to serve protect the positive electrode. Absent either of these factors, the effect of the present invention cannot be obtained. A carbon-carbon unsaturated bond such as a vinyl group is not preferable, because, in the presence of the adjacent amide group, the reactivity of carbon-carbon unsaturated bonds is believed to lower under the influence of the amide group. Further, the carbon-carbon unsaturated bond desirably occurs at the terminal of the substituent, because the polymerization reaction can take place more easily in the presence of a terminal carbon-carbon unsaturated bond.

[1-3. Compound Groups Preferred for Use with Compounds of General Formula (1)]

In the present invention, improved effects can be obtained by containing a specific compound in the electrolytic solution with the compound of general formula (1). The nonaqueous electrolytic solution according to the present invention may contain various compounds as auxiliary agents, including, for example, at least one compound selected from the group consisting of a cyclic carbonate compound having a carbon-carbon unsaturated bond, a cyclic carbonate compound having a fluorine atom, monofluorophosphate, difluorophosphate, a nitrile compound, and an isocyanate compound, and conventionally known overcharge preventing agents, provided that such addition is not harmful to the advantages of the present invention.

It is preferable to contain at least one compound selected from the group consisting of a cyclic carbonate compound having a carbon-carbon unsaturated bond, a cyclic carbonate compound having a fluorine atom, monofluorophosphate, and difluorophosphate, because these compounds form a stable coating on the negative electrode, and can improve cycle characteristics, and battery characteristics after high-temperature storage.

### (Cyclic Carbonate Compound Having Carbon-Carbon Unsaturated Bond)

Examples of the cyclic carbonate compound having a carbon-carbon unsaturated bond include vinylene carbonate compounds such as vinylene carbonate, methylvinylene carbonate, ethylvinylene carbonate, 1,2-dimethylvinylene carbonate, 1,2-diethylvinylene carbonate, fluorovinylene carbonate, and trifluoromethylvinylene carbonate; vinylethylene carbonate compounds such as vinylethylene carbonate, 1-methyl-2-vinylethylene carbonate, 1-ethyl-2-vinylethylene carbonate, 1-n-propyl-2-vinylethylene carbonate, 1-methyl-2-vinylethylene carbonate, 1,1-divinylethylene carbonate, and 1,2-divinylethylene carbonate; and methyleneethylene carbonate compounds such as 1,1-dimethyl-2-methyleneethylene carbonate, and 1,1-diethyl-2-methyleneethylene carbonate.

Of these, vinylene carbonate, vinylethylene carbonate, and 1,2-divinylethylene carbonate are preferred from the viewpoints of cycle characteristics and improving the capacity retention characteristics after high-temperature storage. Vinylene carbonate and vinylethylene carbonate are more preferable, and vinylene carbonate is particularly preferable. These may be used alone, or in a combination of two or more.

When used in a combination of two or more, it is preferable to use vinylene carbonate and vinylethylene carbonate.

When containing a cyclic carbonate compound having a carbon-carbon unsaturated bond, the proportion thereof in the nonaqueous electrolytic solution is typically 0.01 mass % or more, preferably 0.1 mass % or more, particularly preferably 0.3 mass % or more, and typically 10 mass % or less, preferably 8 mass % or less, particularly preferably 6 mass % or less. With the cyclic carbonate compound having a carbon-carbon unsaturated bond falling in the foregoing content ranges, the effects of improving battery cycle characteristics or the capacity retention characteristics after high-temperature storage can be sufficiently exhibited, and an increase of gas generation during high-temperature storage can be suppressed.

### (Cyclic Carbonate Compound Having Fluorine Atom)

Examples of the cyclic carbonate compound having a fluorine atom include fluoroethylene carbonate, 1,2-difluoroethylene carbonate, 1,1-difluoroethylene carbonate, 1,1,2-trifluoroethylene carbonate, tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene carbonate. Of these, fluoroethylene carbonate, 1,2-difluoroethylene carbonate, and 1-fluoro-2-methylethylene carbonate are preferred from the viewpoint of improving cycle characteristics or high-temperature storage characteristics. These may be used alone, or in a combination of two or more.

When containing a cyclic carbonate compound having a fluorine atom in the nonaqueous electrolytic solution, the proportion thereof in the nonaqueous electrolytic solution is typically 0.001 mass % or more, preferably 0.1 mass % or more, more preferably 0.3 mass % or more, particularly preferably 0.5 mass % or more, and typically 10 mass % or less, preferably 5 mass % or less, more preferably 4 mass % or less, particularly preferably 3 mass % or less. The fluoroethylene carbonate may also be used as the solvent, as described in the foregoing section [1-2. Nonaqueous Solvent], and, in this case, the content is not limited to these.

### (Monofluorophosphate and Difluorophosphate)

The counter cations of the monofluorophosphate and the difluorophosphate are not particularly limited, and may be, for example, lithium, sodium, potassium, magnesium, calcium, or ammonium represented by NR¹¹⁸R¹¹⁹R¹²⁰R¹²¹ (where R¹¹⁸ to R¹²¹ each independently represent a hydrogen atom, or an organic group of 1 to 12 carbon atoms).

The organic group of 1 to 12 carbon atoms represented by R¹¹⁸ to R¹²¹ of the ammonium is not particularly limited, and may be, for example, an alkyl group that may be substituted with a halogen atom, a cycloalkyl group that may be substituted with a halogen atom or an alkyl group, an aryl group that may be substituted with a halogen atom or an alkyl group, or an optionally substituted, nitrogen atom-containing heterocyclic group. Preferably, R¹¹⁸ to R¹²¹ each independently represent a hydrogen atom, an alkyl group, a cycloalkyl group, a nitrogen atom-containing heterocyclic group, or the like.

Specific examples of the monofluorophosphate and the difluorophosphate include lithium monofluorophosphate, sodium monofluorophosphate, potassium monofluorophosphate, tetramethylammonium monofluorophosphate, tetraethylammonium monofluorophosphate, lithium difluorophosphate, sodium difluorophosphate, potassium difluorophosphate, tetramethylammonium difluorophosphoate, and tetraethylammonium difluorophosphate, of which lithium monofluorophosphate and lithium difluorophosphate are preferred, and lithium difluorophosphate is more preferred. These may be used alone, or in a combination of two or more.

When containing the monofluorophosphate and/or difluorophosphate in the nonaqueous electrolytic solution, the proportion thereof in the nonaqueous electrolytic solution is typically 0.001 mass % or more, preferably 0.01 mass % or more, particularly preferably 0.1 mass % or more, most preferably 0.2 mass % or more, and typically 5 mass % or less, preferably 3 mass % or less, particularly preferably 2 mass % or less.

It should be noted that when the monofluorophosphate and difluorophosphate are used for the nonaqueous electrolytic solution in the actual secondary battery production, the fluorophosphate content in the nonaqueous electrolytic solution is often found in significantly reduced amounts in a nonaqueous electrolytic solution removed from a disassembled battery. Thus, the monofluorophosphate and the difluorophosphate are regarded as being contained in the nonaqueous electrolytic solution in the predetermined fluorophosphate proportion specified by the present invention when at least one of the monofluorophosphate and the difluorophosphate is detected in a nonaqueous electrolytic solution removed from the battery, regardless of the detected amounts.

### (Nitrile Compound)

Examples of the nitrile compound include mononitriles such as acetonitrile, propionitrile, butyronitrile, valeronitrile, hexanenitrile, heptanenitrile, octanenitrile, nonanenitrile, decanenitrile, dodecanenitrile (lauronitrile), tridecanenitrile, tetradecanenitrile (myristonitrile), hexadecanenitrile, pentadecanenitrile, heptadecanenitrile, octadecanenitrile (steanonitrile), nonadecanenitrile, and icosanenitrile; and dinitriles such as malononitrile, succinonitrile, glutaronitrile, adiponitrile, pimelonitrile, suberonitrile, azelanitrile, sebaconitrile, undecanedinitrile, dodecanedinitrile, methylmalononitrile, ethylmalononitrile, isopropylmalononitrile, tert-butylmalononitrile, methylsuccinonitrile, 2,2-dimethylsuccinonitrile, 2,3-dimethylsuccinonitrile, trimethylsuccinonitrile, tetramethylsuccinonitrile, 3,3′-oxydipropionitrile, 3,3′-thiodipropionitrile, 3,3′-(ethylenedioxy)dipropionitrile, 3,3′-(ethylenedithio)dipropionitrile, 1,2,3-propanetricarbonitrile, 1,3,5-pentanetricarbonitrile, 1,2,3-tris(2-cyanoethoxy)propane, tris(2-cyanoethyl)amine, and 3,9-bis(2-cyanoethyl)-2,4,8,10-tetraoxaspiro[5,5]undecane. Of these, lauronitrile, succinonitrile, glutaronitrile, adiponitrile, pimelonitrile, and suberonitrile are preferred.

These may be used alone, or in a combination of two or more.

When containing the nitrile compound in the nonaqueous electrolytic solution, the proportion thereof in the nonaqueous electrolytic solution is typically 0.001 mass % or more, preferably 0.01 mass % or more, particularly preferably 0.1 mass % or more, most preferably 0.2 mass % or more, and typically 10 mass % or less, preferably 5 mass % or less, particularly preferably 2 mass % or less. With the nitrile compound content falling in these preferred ranges, the auxiliary agent can develop its effect, making it possible to suppress lowering of battery characteristics such as high-load discharge characteristics, and improve capacity retention characteristics and cycle characteristics after high-temperature storage.

### (Isocyanate Compound)

Examples of the isocyanate compound include isocyanate compounds such as 1-isocyanate ethane, 1-isocyanate propane, 1-isocyanate butane, 1-isocyanate pentane, 1-isocyanate hexane, 1-isocyanate heptane, 1-isocyanate octane, 1-isocyanate nonane, 1-isocyanate decane, 1,4-diisocyanate butane, 1,5-diisocyanate pentane, 1,6-diisocyanate hexane, 1,7-diisocyanate heptane, 1,8-diisocyanate octane, 1,9-diisocyanate nonane, 1,10-diisocyanate decane, 1,3-diisocyanate propene, 1,4-diisocyanate-2-butene, 1,4-diisocyanate-2-fluorobutane, 1,4-diisocyanate-2,3-difluorobutane, 1,5-diisocyanate-2-pentene, 1,5-diisocyanate-2-methylpentane, 1,6-diisocyanate-2-hexene, 1,6-diisocyanate-3-hexene, 1,6-diisocyanate-3-fluorohexane, 1,6-diisocyanate-3,4-difluorohexane, toluene diisocyanate, xylene diisocyanate, tolylene diisocyanate, 1,2-bis(isocyanate methyl)cyclohexane, 1,3-bis(isocyanate methyl)cyclohexane, 1,4-bis(isocyanate methyl)cyclohexane, 1,2-diisocyanate cyclohexane, 1,3-diisocyanate cyclohexane, 1,4-diisocyanate cyclohexane, dicyclohexylmethane-1,1′-diisocyanate, dicyclohexylmethane-2,2′-diisocyanate, dicyclohexylmethane-3,3′-diisocyanate, dicyclohexylmethane-4,4′-diisocyanate, isophorone diisocyanate, 1,6,11-triisocyanate undecane, 4-isocyanate methyl-1,8-octamethylenediisocyanate, 1,3,5-triisocyanate methylbenzene, bicyclo[2.2.1]heptane-2,5-diylbis(methyl isocyanate), and bicyclo[2.2.1]heptane-2,6-diylbis(methyl isocyanate).

These may be used alone, or in a combination of two or more.

When containing the isocyanate compound in the nonaqueous electrolytic solution, the proportion thereof in the nonaqueous electrolytic solution is typically 0.001 mass % or more, preferably 0.01 mass % or more, particularly preferably 0.1 mass % or more, most preferably 0.2 mass % or more, and typically 5 mass % or less, preferably 3 mass % or less, particularly preferably 1 mass % or less. With the isocyanate compound content falling in these preferred ranges, the auxiliary agent can develop its effect, making it possible to suppress lowering of battery characteristics such as high-load discharge characteristics, and improve capacity retention characteristics and cycle characteristics after high-temperature storage.

### [1-4. Other Additives]

The nonaqueous electrolytic solution of the present invention may contain various other additives, provided that such addition is not detrimental to the advantages of the present invention. Any known conventional additives may be used as such additives. The additives may be used alone, or two or more may be used in any combination and/or proportion.

Examples of the additives include overcharge preventing agents, and auxiliary agents for improving the capacity retention characteristics and the cycle characteristics after high-temperature storage.

Specific examples of the overcharge preventing agents include aromatic compounds such as biphenyl, alkyl biphenyl (such as 2-methylbiphenyl, and 2-ethylbiphenyl), terphenyl, partially hydrogenated products of terphenyl, cyclopentylbenzene, cyclohexylbenzene, cis-1-propyl-4-phenylcyclohexane, trans-1-propyl-4-phenylcyclohexane, cis-1-butyl-4-phenylcyclohexane, trans-1-butyl-4-phenylcyclohexane, t-butylbenzene, t-amylbenzene, diphenyl ether, dibenzofuran, methylphenyl carbonate, ethylphenyl carbonate, diphenyl carbonate, triphenylphosphate, tris(2-t-butylphenyl)phosphate, tris(3-t-butylphenyl)phosphate, tris(4-t-butylphenyl)phosphate, tris(2-t-amylphenyl)phosphate, tris(3-t-amylphenyl)phosphate, tris(4-t-amylphenyl)phosphate, tris(2-cyclohexylphenyl)phosphate, tris(3-cyclohexylphenyl)phosphate, and tris(4-cyclohexylphenyl)phosphate; partially fluorinated products of these aromatic compounds (such as 2-fluorobiphenyl, 3-fluorobiphenyl, 4-fluorobiphenyl, 4,4′-difluorobiphenyl, 2,4-difluorobiphenyl, o-cyclohexylfluorobenzene, and p-cyclohexylfluorobenzene); and fluorine-containing anisole compounds such as 2,4-difluoroanisole, 2,5-difluoroanisole, 2,6-difluoroanisole, and 3,5-difluoroanisole.

Preferred among these compounds are aromatic compounds such as biphenyl, alkyl biphenyl (such as 2-methylbiphenyl), terphenyl, partially hydrogenated products of terphenyl, cyclopentylbenzene, cyclohexylbenzene, cis-1-propyl-4-phenylcyclohexane, trans-1-propyl-4-phenylcyclohexane, cis-1-butyl-4-phenylcyclohexane, trans-1-butyl-4-phenylcyclohexane, t-butylbenzene, t-amylbenzene, diphenyl ether, dibenzofuran, methylphenyl carbonate, diphenyl carbonate, triphenylphosphate, tris(4-t-butylphenyl)phosphate, and tris(4-cyclohexylphenyl)phosphate; and partially fluorinated products of these aromatic compounds such as 2-fluorobiphenyl, 3-fluorobiphenyl, 4-fluorobiphenyl, 4,4′-difluorobiphenyl, o-cyclohexylfluorobenzene, and p-cyclohexylfluorobenzene. More preferred are partially hydrogenated products of terphenyl, cyclopentylbenzene, cyclohexylbenzene, cis-1-propyl-4-phenylcyclohexane, trans-1-propyl-4-phenylcyclohexane, cis-1-butyl-4-phenylcyclohexane, trans-1-butyl-4-phenylcyclohexane, t-butylbenzene, t-amylbenzene, methylphenyl carbonate, diphenyl carbonate, triphenylphosphate, tris(4-t-butylphenyl)phosphate, tris(4-cyclohexylphenyl)phosphate, o-cyclohexylfluorobenzene, and p-cyclohexylfluorobenzene. Particularly preferred are partially hydrogenated products of terphenyl, and cyclohexylbenzene.

These may be used in a combination of two or more. When used in a combination of two or more, it is preferable, particularly from the balance between overcharge preventing characteristics and high-temperature storage characteristics, to use a partially hydrogenated product of terphenyl or cyclohexylbenzene in combination with t-butylbenzene or t-amylbenzene, or use a compound selected from aromatic compounds containing no oxygen (such as biphenyl, alkyl biphenyl, terphenyl, partially hydrogenated products of terphenyl, cyclohexylbenzene, t-butylbenzene, and t-amylbenzene) in combination with a compound selected from oxygen-containing aromatic compounds such as diphenyl ether, and dibenzofuran.

The proportion of the overcharge preventing agent in the nonaqueous electrolytic solution is typically 0.1 mass % or more, preferably 0.2 mass % or more, more preferably 0.3 mass % or more, particularly preferably 0.5 mass % or more, and typically 5 mass % or less, preferably 3 mass % or less, more preferably 2 mass % or less. In these concentration ranges, the desired effect of the overcharge preventing agent can develop more easily, and lowering of battery characteristics such as high-temperature storage characteristics can be suppressed. Containing the overcharge preventing agent in the nonaqueous electrolytic solution is preferable, because it can suppress burst or fire in the nonaqueous electrolytic solution secondary battery due to overcharging, and improves the safety of the nonaqueous electrolytic solution secondary battery.

Specific examples of the auxiliary agent for improving the capacity retention characteristics and cycle characteristics after high-temperature storage include acid anhydrides such as succinic acid anhydrides, maleic acid anhydrides, phthalic acid anhydrides, and citraconic acid anhydrides; carbonate compounds such as erythritan carbonate, and spiro-bis-dimethylene carbonate; sulfur-containing compounds such as ethylene sulfite, 1,3-propane sultone, 1,3-propenesultone, 1,4-butane sultone, methyl methane sulfonate, busulfan, sulfolane, sulfolene, dimethyl sulfone, diphenyl sulfone, divinyl sulfone, methylphenyl sulfone, diethyl disulfide, dibutyl disulfide, N,N-dimethylmethanesulfoneamide, and N,N-diethylmethanesulfoneamide; nitrogen-containing compounds such as 1-methyl-2-pyrrolidinone, 1-methyl-2-piperidone, 3-methyl-2-oxazolidinone, 1,3-dimethyl-2-imidazolidinone, and N-methylsuccinimide; hydrocarbon compounds such as heptane, octane, and cycloheptane; and fluorine-containing aromatic compounds such as fluorobenzene, difluorobenzene, and benzotrifluoride.

These auxiliary agents may be used alone, or two or more may be used in any combination and/or proportion.

When the nonaqueous electrolytic solution of the present invention contains the auxiliary agent for improving the capacity retention characteristics and cycle characteristics after high-temperature storage, the auxiliary agent may be contained in any concentration, as long as it is not detrimental to the advantages of the present invention, and is contained in typically 0.1 mass % or more and 5 mass % or less with respect to the total nonaqueous electrolytic solution.

Other examples of the auxiliary agent include carbonate compounds such as erythritan carbonate, spiro-bis-dimethylene carbonate, methoxyethyl-methyl carbonate, methoxyethyl-ethyl carbonate, ethoxyethyl-methyl carbonate, and ethoxyethyl-ethyl carbonate; carboxylic acid anhydrides such as succinic acid anhydride, glutaric acid anhydride, maleic acid anhydride, itaconic acid anhydride, citraconic acid anhydride, glutaconic acid anhydride, diglycolic acid anhydride, cyclohexane dicarboxylic acid anhydride, cyclopentanetetracarboxylic dianhydride, and phenylsuccinic acid anhydride; dicarboxylic acid diester compounds such as dimethyl succinate, diethyl succinate, diallyl succinate, dimethyl maleate, diethyl maleate, diallyl maleate, dipropyl maleate, dibutyl maleate, bis(trifluoromethyl) maleate, bis(pentafluoroethyl) maleate, and bis(2,2,2-trifluoroethyl) maleate; spiro compounds such as 2,4,8,10-tetraoxaspiro[5.5]undecane, and 3,9-divinyl-2,4,8,10-tetraoxaspiro[5.5]undecane; sulfur-containing compounds such as ethylene sulfite, propylene sulfite, 1,3-propane sultone, 1,4-butane sultone, 1,3-propenesultone, 1,4-butenesultone, methylmethane sulfonate, ethylmethane sulfonate, methyl-methoxymethane sulfonate, methyl-2-methoxyethanesulfonate, busulfan, diethylene glycol dimethane sulfonate, 1,2-ethanediolbis(2,2,2-trifluoroethanesulfonate), 1,4-butanediolbis(2,2,2-trifluoroethanesulfonate), sulfolane, 3-sulfolene, 2-sulfolene, dimethyl sulfone, diethyl sulfone, divinyl sulfone, diphenyl sulfone, bis(methylsulfonyl)methane, bis(methylsulfonyl)ethane, bis(ethylsulfonyl)methane, bis(ethylsulfonyl)ethane, bis(vinylsulfonyl)methane, bis(vinylsulfonyl)ethane, N,N-dimethylmethanesulfoneamide, N,N-diethylmethanesulfoneamide, N,N-dimethyltrifluoromethanesulfoneamide, and N,N-diethyltrifluoromethanesulfoneamide; nitrogen-containing compounds such as 1-methyl-2-pyrrolidinone, 1-methyl-2-piperidone, 3-methyl-2-oxazolidinone, 1,3-dimethyl-2-imidazolidinone, and N-methylsuccinimide; hydrocarbon compounds such as heptane, octane, nonane, decane, cycloheptane, methylcyclohexane, ethylcyclohexane, propylcyclohexane, n-butylcyclohexane, t-butylcyclohexane, and dicyclohexyl; fluorinated benzene such as fluorobenzene, difluorobenzene, pentafluorobenzene, and hexafluorobenzene; fluorinated toluene such as 2-fluorotoluene, 3-fluorotoluene, 4-fluorotoluene, and benzotrifluoride; and phosphorus-containing compounds such as methyldimethyl phosphinate, ethyldimethyl phosphinate, ethyldiethyl phosphinate, trimethyl phosphonoformate, triethyl phosphonoformate, trimethyl phosphonoacetate, triethyl phosphonoacetate, trimethyl-3-phosphonopropionate, and triethyl-3-phosphonopropionate.

Of these, preferred from the viewpoint of improving the battery characteristics after high-temperature storage are sulfur-containing compounds such as ethylene sulfite, 1,3-propane sultone, 1,4-butane sultone, 1,3-propenesultone, 1,4-butenesultone, busulfan, and 1,4-butanediolbis(2,2,2-trifluoroethanesulfonate).

These may be used in a combination of two or more.

The proportion of the auxiliary agent contained in the nonaqueous electrolytic solution is not particularly limited, and is typically 0.01 mass % or more, preferably 0.1 mass % or more, more preferably 0.2 mass % or more, and typically 8 mass % or less, preferably 5 mass % or less, more preferably 3 mass % or less, particularly preferably 1 mass % or less. Adding the auxiliary agent is preferable, because it improves the capacity retention characteristics and the cycle characteristics after high-temperature storage. In these concentration ranges, the auxiliary agent can more easily exhibit its effect, and lowering of battery characteristics such as high-load discharge characteristics can be suppressed.

### [1-5. Gelatinizer]

When used for the lithium secondary battery of the present invention, the nonaqueous electrolytic solution typically exists in the liquid state. However, for example, the liquid may be gelled with a polymer to obtain a semi-solid electrolyte. Any polymer may be used for gelation, including, for example, polyvinylidene fluoride, a copolymer of polyvinylidene fluoride and hexafluoropropylene, polyethylene oxide, polyacrylate, and polymethacrylate. The polymers used for gelation may be used alone, or two or more may be used in any combination and/or proportion.

When the nonaqueous electrolytic solution is used as a semi-solid electrolyte, the nonaqueous electrolytic solution may have any proportion in the semi-solid electrolyte, as long as it is not detrimental to the advantages of the present invention. Preferably, the proportion of the nonaqueous electrolytic solution with respect to the total amount of the semi-solid electrolyte is typically 30 mass % or more, preferably 50 mass % or more, more preferably 75 mass % or more, and typically 99.95 mass % or less, preferably 99 mass % or less, more preferably 98 mass % or less.

When the nonaqueous electrolytic solution is contained in excess proportions, there is a risk of leakage as it becomes difficult to hold the electrolytic solution. When the content is too small, sufficient charge and discharge efficiency and capacity may not be obtained.

### [1-6. Nonaqueous Electrolytic Solution Producing Process]

The nonaqueous electrolytic solution of the present invention can be prepared by dissolving various components in the nonaqueous solvent, the components including the electrolyte, a halogen-containing phosphoric acid ester compound represented by the general formula (1) of the present invention, at least one compound selected from the group consisting of preferably a cyclic carbonate having a carbon-carbon unsaturated bond, a cyclic carbonate having a halogen atom, monofluorophosphate, difluorophosphate, and a nitrile compound, and optional auxiliary agents.

Water in the nonaqueous electrolytic solution is not preferable, because it may cause undesirable reactions such as electrolysis of water, a reaction of water with lithium metal, and hydrolysis of the lithium salt. For the preparation of the nonaqueous electrolytic solution, it is therefore preferable to dehydrate each component such as the nonaqueous solvent. Specifically, each component is dehydrated to make the water content typically 50 ppm or less, preferably 20 ppm or less. Any technique can be used for dehydration, including, for example, heating under reduced pressure, and passing through a molecular sieve.

### [2. Nonaqueous Electrolytic Solution Secondary Battery]

The nonaqueous electrolytic solution secondary battery of the present invention has the same configuration as conventionally known nonaqueous electrolytic solution secondary batteries, except for the configuration of the nonaqueous electrolytic solution. Typically, the nonaqueous electrolytic solution secondary battery of the present invention is configured to include the positive electrode and the negative electrode laminated via a porous film (separator) impregnated with the nonaqueous electrolytic solution of the present invention, and a casing (outer package) housing the electrodes and the separator. The nonaqueous electrolytic solution secondary battery of the present invention is not limited to a particular shape, and may have any of a cylindrical, a rectangular, a laminated, or a coin, and a large shape.

### [2-1. Nonaqueous Electrolytic Solution]

The nonaqueous electrolytic solution of the present invention is used as the nonaqueous electrolytic solution. The nonaqueous electrolytic solution of the present invention may be used as a mixture with other nonaqueous electrolytic solutions, provided that it does not depart from the gist of the present invention.

### [2-2. Negative Electrode]

The negative electrode active material forming the negative electrode used in the nonaqueous electrolytic solution secondary battery of the present invention is not particularly limited, as long as it can store and release lithium ions electrochemically. Specific examples include carbonaceous materials, alloy materials, and lithium-containing metal composite oxide materials.

### (Carbonaceous Material Negative Electrode)

Preferred as the carbonaceous material used as the negative electrode active material of the carbonaceous material negative electrode (hereinafter, also referred to as “carbon negative electrode”) is one selected from the following (1) to (4), because these provide a good balance between initial irreversible capacity, and high current density charge and discharge characteristics. The carbonaceous materials (1) to (4) may be used alone, or two or more may be used in any combination and/or proportion.

(1) Natural graphite

(2) carbonaceous material obtained after one or more heat treatments of an artificial carbonaceous substance or an artificial graphite substance in a temperature range of 400° C. to 3,200° C.,

(3) carbonaceous material forming a negative electrode active material layer made of carbon materials having at least two different crystallinities, and/or in which there is a contact interface of carbon materials of different crystallinities, and

(4) carbonaceous material forming a negative electrode active material layer made of carbon materials having at least two different orientations, and/or in which there is a contact interface of carbon materials of different orientations.

Specific examples of the artificial carbonaceous substance and artificial graphite substance (2) include natural graphite, coal cokes, petroleum cokes, coal pitches and petroleum pitches (or coal pitches and petroleum pitches after oxidation treatment), needle cokes, pitch cokes, and carbon materials as partially graphitized materials of needle cokes or pitch cokes, pyrolysis products of organic materials such as furnace black, acetylene black, and pitch carbon fibers, carbonizable organic materials and carbides thereof, solutions dissolving carbonizable organic materials in low-molecular organic solvents such as benzene, toluene, xylene, quinoline, and n-hexane, and carbides thereof.

Specific examples of the carbonizable organic materials include coal tar pitches, ranging from soft pitches to hard pitches, coal heavy oils (such as pyrolysis liquefaction oil), direct heavy oils from atmospheric residue and vacuum residue, crude oil, decomposed petroleum heavy oils (such as ethylene tar obtained as a by-product of the pyrolysis of products such as naphtha), aromatic hydrocarbon (such as acenaphthylene, decacyclene, anthracene, and phenanthrene), nitrogen atom-containing heterocyclic compounds (such as phenazine and acridine), sulfur atom-containing heterocyclic compounds (such as thiophene and bithiophene), polyphenylene (such as biphenyl and terphenyl), polyvinyl chloride, polyvinyl alcohol, polyvinyl butyral, insolubilized products of these, organic polymers such as (nitrogen-containing polyacrylonitrile, and polypyrrole), organic polymers (such as sulfur-containing polythiophene, and polystyrene), natural polymers of polysaccharides (such as cellulose, lignin, mannan, polygalacturonic acid, chitosan, and saccharose), thermoplastic resins (such as polyphenylene sulfide, and polyphenylene oxide), and heat-curable resins (such as furfuryl alcohol resin, phenol-formaldehyde resin, and imide resin).

Any known method can be used for carbon negative electrode production, provided that it is not detrimental to the advantages of the present invention. For example, the carbon negative electrode can be formed by adding a binder, a solvent, and optional materials such as a thickener, a conductive material, and a filler to the negative electrode active material, and the resulting slurry is coated over the collector, which is then pressed after being dried.

The thickness of the negative electrode active material layer on one side immediately before the battery nonaqueous electrolytic solution injection step is typically 15 μm or more, preferably 20 μm or more, further preferably 30 μm or more, and typically 150 μm or less, preferably 120 μm or less, further preferably 100 μm or less. A negative electrode active material thickness above these ranges may lower the high current density charge and discharge characteristics because of the difficulty permeating the nonaqueous electrolytic solution to regions in the vicinity of the collector interface. Below these ranges, the volume ratio of the collector to the negative electrode active material increases, and the battery capacity may decrease. The negative electrode active material may be prepared as a sheet electrode by roll molding, or a pellet electrode by compression molding.

The collector holding the negative electrode active material may be any known collector. Examples of the negative electrode collector include metallic materials such as copper, nickel, stainless steel, and nickel-plated steel, of which copper is particularly preferred for processibility and cost.

When made of metallic material, the collector may have a shape of, for example, a metal foil, a metal column, a metal coil, a metal plate, a metallic thin film, an expended metal, a punched metal, or a metal foam. Particularly preferred are metallic thin films, more preferably copper foils, further preferably press-rolled copper foils made by press rolling, and electrolytic copper foils made by using the electrolysis technique. Any one of these can be used as the collector.

When the copper foil has a thickness below 25 μm, copper alloys (such as phosphor bronze, titanium copper, Corson alloy, and Cu—Cr—Zr alloy) stronger than pure copper may be used.

The collector made of copper foils produced by press rolling can preferably be used for small cylindrical batteries, because the copper foil collector, with its copper crystals arranged in the press roll direction, does not easily crack even when the negative electrode is tightly or sharply rolled.

The electrolytic copper foil is obtained, for example, by dipping a metallic drum in a nonaqueous electrolytic solution dissolving copper ions, and current is flown while rotating the solution to cause the copper to deposit on the drum surface. The metal can then be detached to obtain the foil. The copper formed by electrolysis may be deposited on the surface of the press roll copper foil. One or both surfaces of the copper foil may be subjected to a roughening treatment or a surface treatment (for example, such as a chromate treatment down to a thickness of several nanometers to about 1 micrometer, and surface preparation using Ti and the like).

The metallic thin film may have any thickness, and the thickness is typically 1 μm or more, preferably 3 μm or more, further preferably 5 μm or more, and typically 100 μm or less, preferably 50 μm or less, further preferably 30 μm or less.

A metallic thin film thickness less than 1 μm lowers strength, and may make the coating application difficult. A thickness above 100 μm may cause deformation in the shape of battery, such as rolling.

The metallic thin film may be meshed.

The thickness ratio of the collector and the negative electrode active material layer is not particularly limited, and the value of “(the thickness of the negative electrode active material layer on one side immediately before the nonaqueous electrolytic solution injection)/(collector thickness)” is preferably 150 or less, further preferably 20 or less, particularly preferably 10 or less, and preferably 0.1 or more, further preferably 0.4 or more, particularly preferably 1 or more.

A thickness ratio of the collector and the negative electrode active material layer above the foregoing ranges may cause the collector to generate heat by Joule heating during high current density charge and discharge. Below the foregoing ranges, the volume ratio of the collector with respect to the negative electrode active material may increase, and the battery capacity may be reduced.

The electrode structure of the electrode formed from the negative electrode active material is not particularly limited, and the density of the negative electrode active material present on the collector is preferably 1 g·cm⁻³ or more, further preferably 1.2 g·cm³ or more, particularly preferably 1.3 g·cm³ or more, and preferably 2 g·cm⁻³ or less, more preferably 1.9 g·cm³ or less, further preferably 1.8 g·cm³ or less. When the density of the negative electrode active material present on the collector is above the foregoing ranges, the negative electrode active material particles may be destroyed. This may lead to deterioration of high current density charge and discharge characteristics by the increased initial irreversible capacity, and the poor permeation of the nonaqueous electrolytic solution in the vicinity of the collector/negative electrode active material interface. Below the foregoing ranges, the conductivity between the negative electrode active materials decreases and the battery resistance increases, with the result that the capacity per unit volume may decrease.

The binder used to bind the negative electrode active material is not particularly limited, as long as the binder is a stable material against the solvent used for the production of the nonaqueous electrolytic solution and the electrode.

Specific examples include resin polymers such as polyethylene, polypropylene, polyethylene terephthalate, polymethylmethacrylate, aromatic polyamide, cellulose, and nitrocellulose; rubber polymers such as SBR (styrene.butadiene rubber), isoprene rubber, butadiene rubber, fluororubber, NBR (acrylonitrile.butadiene rubber), and ethylene-propylene rubber; styrene-butadiene-styrene block copolymer and hydrogenation products thereof; thermoplastic elastomer polymers such as EPDM (ethylene.propylene.diene ternary copolymer), styrene-ethylene-butadiene-styrene copolymer, styrene.isoprene-styrene block copolymer and hydrogenation products thereof; soft resin polymers such as syndiotactic-1,2-polybutadiene, polyvinyl acetate, ethylene-vinyl acetate copolymer, and propylene.α-olefin copolymer; fluoropolymers such as polyvinylidene fluoride, polytetrafluoroethylene, fluorinatepolyvinylidene fluoride, and polytetrafluoroethylene-ethylene copolymer; and polymer compositions having alkali metal ion (particularly lithium ions) ion conductivity. These may be used alone, or two or more may be used in any combination and/or proportion.

The solvent used to form the slurry is not particularly limited, as long as it is a solvent capable of dissolving or dispersing the negative electrode active material, the binder (binding agent), and the optionally used thickener and conductive material. The solvent may be a water-based solvent or a nonaqueous solvent.

Examples of the water-based solvent include water, and alcohol. Examples of the nonaqueous solvent include N-methylpyrrolidone (NMP), dimethylformamide, dimethylacetoamide, methyl ethyl ketone, cyclohexanone, methyl acetate, methyl acrylate, diethyltriamine, N,N-dimethylaminopropylamine, tetrahydrofuran (THF), toluene, acetone, diethyl ether, dimethyl acetoamide, hexamethyl phosphoramide, dimethyl sulfoxide, benzene, xylene, quinoline, pyridine, methylnaphthalene, and hexane.

When the water-based solvent is used, it is preferable to contain a dispersant or the like with the thickener, and form the slurry with a latex such as SBR. These solvents may be used alone, or two or more may be used in any combination and/or proportion.

The proportion of the binder with respect to the negative electrode active material is preferably 0.1 mass % or more, further preferably 0.5 mass % or more, particularly preferably 0.6 mass % or more, and preferably 20 mass % or less, more preferably 15 mass % or less, further preferably 10 mass % or less, particularly preferably 8 mass % or less. When the proportion of the binder with respect to the negative electrode active material exceeds the foregoing ranges, the binder proportion that does not contribute to battery capacity increases, and the battery capacity may decrease. Below the foregoing ranges, the strength of the negative electrode may decrease.

When the rubber polymer as represented by SBR is contained as a main component, the proportion of the binder with respect to the negative electrode active material is typically 0.1 mass % or more, preferably 0.5 mass % or more, further preferably 0.6 mass % or more, and typically 5 mass % or less, preferably 3 mass % or less, further preferably 2 mass % or less.

When the fluoropolymer as represented by polyvinylidene fluoride is contained as a main component, the proportion with respect to the negative electrode active material is typically 1 mass % or more, preferably 2 mass % or more, further preferably 3 mass % or more, and typically 15 mass % or less, preferably 10 mass % or less, further preferably 8 mass % or less.

Typically, the thickener is used to adjust the viscosity of the slurry. The thickener is not particularly limited. Specific examples include carboxymethylcellulose, methylcellulose, hydroxymethylcellulose, ethylcellulose, polyvinyl alcohol, oxidized starch, phosphorylated starch, casein, and salts thereof. These may be used alone, or two or more may be used in any combination and/or proportion.

When using a thickener, the proportion of the thickener with respect to the negative electrode active material is typically 0.1 mass % or more, preferably 0.5 mass % or more, further preferably 0.6 mass % or more, and typically 5 mass % or less, preferably 3 mass % or less, further preferably 2 mass % or less.

Ease of coating may suffer greatly when the proportion of the thickener with respect to the negative electrode active material is below these ranges. Above the foregoing ranges, the proportion of the negative electrode active material in the negative electrode active material layer decreases, which may cause the problem of low battery capacity, or may increase the resistance between the negative electrode active materials.

### (Alloy Material Negative Electrode)

The negative electrode of the nonaqueous electrolytic solution secondary battery of the present invention may be a negative electrode that contains an alloy material, preferably at least one element selected from the group consisting of Si, Sn, and Pb as a negative electrode active material capable of storing and releasing metal ions (hereinafter, such a negative electrode is also referred to as “alloy material negative electrode”).

The alloy material used as the negative electrode active material of the alloy material negative electrode is not particularly limited, and may be any of a simple substance metal or an alloy forming a lithium alloy, and compounds such as oxides, carbides nitrides, silicides, sulfides, and phosphides thereof, provided that lithium can be stored and released. In the case of a simple substance metal or an alloy forming a lithium alloy, it is preferable to use materials containing the metals and metalloid elements (e.g., elements other than carbon) in groups 13 and 14 of the periodic table, further preferably simple substance metal Si, Sn, or Pb (in the following, these elements are also referred to as “specific metallic elements”), or alloys and compounds containing these atoms.

Examples of the negative electrode active material having at least one atom selected from the specific metallic elements include simple substance metal of any one of the specific metallic elements, an alloy of two or more of the specific metallic elements, an alloy of one or more of the specific metallic elements and one or more other metallic elements, and compounds such as compounds containing one or more specific metallic elements. The battery can have high capacity when these simple substance metals, alloys, and metallic compounds are used as the negative electrode active material.

Examples of the compounds containing one or more specific metallic elements include composite compounds such as carbides, oxides, nitrides, silicides, sulfides, and phosphides containing one or more specific metallic elements.

Other examples include compounds in which composite compounds such as above are bonded to several different elements, such as simple substance metals, alloys, and non-metallic elements, in a complex manner. More specifically, for example, in the case of silicon or tin, an alloy of these elements and metals that do not act as the negative electrode may be used. Further, in the case of tin for example, it is possible to use complex compounds containing 5 to 6 different elements in a combination of tin and silicon, a non-tin and non-lead metal that acts as the negative electrode, a metal that does not act as the negative electrode, and a non-metallic element.

Among these negative electrode active materials, preferred examples include any one of the specific metallic elements as a simple substance metal, an alloy of two or more of the specific metallic elements, and oxides, carbides, and nitrides of the specific metallic elements, particularly preferably silicon and/or tin as simple substance metals, alloys thereof, and oxides, carbides, and nitrides thereof from the viewpoints of capacity per unit mass, and environmental load, because these materials have large capacity per unit mass in the product battery.

It is also preferable to use the following compounds containing silicon and/or tin, because these compounds, despite the inferior capacity per unit mass to that offered by the simple substance metals or alloys, excel in cycle characteristics.
Silicon and/or tin oxide with the silicon- and/or tin-to-oxygen element ratio of typically 0.5 or more, preferably 0.7 or more, further preferably 0.9 or more, and typically 1.5 or less, preferably 1.3 or less, further preferably 1.1 or less
Silicon and/or tin nitride with the silicon- and/or tin-to-nitrogen element ratio of typically 0.5 or more, preferably 0.7 or more, further preferably 0.9 or more, and typically 1.5 or less, preferably 1.3 or less, further preferably 1.1 or less
Silicon and/or tin carbide with the silicon- and/or tin-to-carbon element ratio of typically 0.5 or more, preferably 0.7 or more, further preferably 0.9 or more, and typically 1.5 or less, preferably 1.3 or less, further preferably 1.1 or less

Note that the negative electrode active materials may be used alone, or two or more may be used in any combination and/or proportion.

The alloy material negative electrode may be produced by using any known method. Specifically, the negative electrode may be produced, for example, by using a method in which the negative electrode active material is roller molded into a sheet electrode after adding a binder, a conductive material, and the like, or a method that uses compression molding to form a pellet electrode. Typically, a method is used in which a thin film layer (negative electrode active material layer) that contains the negative electrode active material is formed on a collector for negative electrodes (hereinafter, also referred to as “negative electrode collector”), using a technique such as coating, vapor deposition, sputtering, and plating. In this case, materials such as a binder, a thickener, a conductive material, and a solvent are added to the negative electrode active material to form a slurry material, and this is applied onto the negative electrode collector. After drying, the whole is pressed to increase density and form the negative electrode active material layer on the negative electrode collector.

Examples of the negative electrode collector material include steel, a copper alloy, nickel, a nickel alloy, and stainless steel. Preferred is a copper foil from the standpoint of ease of processing into a thin film, and cost.

The thickness of the negative electrode collector is typically 1 μm or more, preferably 5 μm or more, and typically 100 μm or less, preferably 50 μm or less. When the negative electrode collector is too thick, the capacity of the battery as a whole may become excessively low. When too thin, it may pose difficulties in handling.

In order to improve the bonding with the negative electrode active material layer formed on the collector surface, it is preferable that the surface of the negative electrode collector be subjected to a roughening treatment in advance. Examples of the surface roughening method include a blast treatment, press rolling using a roughening roller, mechanical polishing that polishes the collector surface with a wire brush or the like equipped with, for example, an abrasive particle-bearing coated abrasive, a grinding stone, an emery wheel, or a steel wire, electrolytic polishing, and chemical polishing.

In order to reduce the mass of the negative electrode collector and improve the energy density of the battery per mass, a perforated negative electrode collector, such as an expended metal or a punched metal may also be used. This type of negative electrode collector can freely adjust its mass by varying the percentage of the aperture. Further, by forming the negative electrode active material layer on the both sides of the perforated negative electrode collector, the riveting effect can be provided through the holes, and the negative electrode active material layer does not easily detach. However, when the percentage of the aperture is too high, the contact area between the negative electrode active material layer and the negative electrode collector decreases, and the bonding strength may become weak.

### [2-3. Positive Electrode]

The positive electrode active material contained in the positive electrode used for the nonaqueous electrolytic solution secondary battery of the present invention is not particularly limited, as long as it can electrochemically store and release lithium ions. A preferred example is a substance containing lithium and at least one transition metal. Specific examples include lithium transition metal composite oxides, and lithium-containing transition metal phosphoric acid compounds.

Examples of the lithium transition metal composite oxides include lithium-cobalt composite oxides such as LiCoO₂, lithium-nickel composite oxides such as LiNiO₂, lithium-manganese composite oxides such as LiMnO₂, LiMn₂O₄, and Li₂MnO₄, and lithium transition metal composite oxides in which some of the major transition metal atoms are substituted with other metals such as Al, Ti, V, Cr, Mn, Fe, Co, Li, Ni, Cu, Zn, Mg, Ga, Zr, and Si.

Specific examples of such substituted lithium transition metal composite oxides include LiNi_{0.5}Mn_{0.5}O₂, LiNi_{0.85}Co_{0.10}Al_{0.05}O₂, LiNi_{0.33}Cu_{0.33}Mn_{0.33}O₂, LiMn_{1.8}Al_{0.2}O₄, and LiMn_{1.5}Ni_{0.5}O₄.

Examples of the lithium-containing transition metal phosphoric acid compounds include iron phosphates such as LiFePO₄, Li₃Fe₂(PO₄)₃, LiFeP₂O₇, and Li₂FeP₂O₇, cobalt phosphates such as LiCoPO₄, manganese phosphates such as LiMnPO₄, and lithium transition metal phosphoric acid compounds in which some of the major transition metal atoms are substituted with other metals such as Al, Ti, V, Cr, Mn, Fe, Co, Li, Ni, Cu, Zn, Mg, Ga, Zr, Nb, and Si.

It is preferable that the surface of the composite oxide of transition metal and lithium be coated with oxides of metals such as Al, B, Ti, Zr, V, Cr, Mn, Fe, Co, Ni, Cu, Zn, Mg, Ca, and Ga, because such a coating can suppress oxidation reaction of the solvent under high voltage. Al₂O₃, TiO₂, ZrO₂, and MgO are particularly preferred, because these can provide a strong and stable coating effect.

These positive electrode active materials may be used alone, or two or more may be used in any combination and/or proportion.

The tap density of the positive electrode active material is typically 1.3 g·cm⁻³ or more, preferably 1.5 g·cm⁻³ or more, further preferably 1.6 g·cm⁻³ or more, particularly preferably 1.7 g·cm⁻³ or more, and typically 2.5 g·cm⁻³ or less, preferably 2.4 g·cm⁻³ or less.

A high-density positive electrode active material layer can be formed by using a metal composite oxide powder of high tap density. When the tap density of the positive electrode active material is below the foregoing ranges, the amount of the dispersion medium needed for the positive electrode active material layer formation, and the required amounts of conductive material and binder increase. This may limit the charging rate of the positive electrode active material in the positive electrode active material layer, and the battery capacity. Generally, the tap density should be as large as possible, and the upper limit is not particularly limited. However, above the foregoing ranges, there are cases where the diffusion of the lithium ions using the nonaqueous electrolytic solution as a medium in the positive electrode active material layer becomes rate-limiting, and lowers the load characteristics.

The BET specific surface area of the positive electrode active material is typically 0.2 m²·g⁻¹ or more, preferably 0.3 m²·g⁻¹ or more, further preferably 0.4 m²·g⁻¹ or more, and typically 4.0 m²·g⁻¹ or less, preferably 2.5 m²·g⁻¹ or less, further preferably 1.5 m²·g⁻¹ or less as measured by using the BET method. A BET specific surface area below these ranges tends to lower battery performance. Above the foregoing ranges, it may become difficult to increase tap density, and ease of coating may suffer in the positive electrode active material formation.

The method used to produce the positive electrode active material is not particularly limited, as long as it does not depart from the gist of the present invention. Among a number of methods available, a method commonly used in inorganic compound production can be used.

The configuration of the positive electrode and the method of production thereof used in the present invention are described below.

The positive electrode is produced by forming a positive electrode active material particle- and binder-containing positive electrode active material layer on the collector.

Any known method also can be used to produce the positive electrode that uses the positive electrode active material. As specific examples of producing the positive electrode, the positive electrode active material, a binder, and optional materials (a conductive material and/or a thickener) are dry mixed into a form of a sheet, and press bonded to the positive electrode collector, or a slurry prepared by dissolving or dispersing these materials in a liquid medium is applied to the positive electrode collector, and dried to form the positive electrode active material layer on the collector.

The content of the positive electrode active material in the positive electrode active material layer is typically 10 mass % or more, preferably 30 mass % or more, particularly preferably 50 mass % or more, and typically 99.9 mass % or less, preferably 99 mass % or less. When the positive electrode active material content in the positive electrode active material layer is below these ranges, the electrical capacitance may become insufficient. Above these ranges, the strength of the positive electrode may become insufficient. The positive electrode active material powder may be used alone, or two or more positive electrode active material powders of different compositions or different powder properties may be used in any combination and/or proportion.

The conductive material may be any known conductive material. Specific examples include metallic materials such as copper and nickel; graphites such as natural graphite, and artificial graphite; carbon black such as acetylene black; and carbonaceous materials such as amorphous carbon of needle coke. These may be used alone, or two or more may be used in any combination and/or proportion.

The conductive material is used by being contained in the positive electrode active material layer in typically 0.01 mass % or more, preferably 0.1 mass % or more, more preferably 1 mass % or more, and typically 50 mass % or less, preferably 30 mass % or less, more preferably 15 mass % or less. When the conductive material content is below these ranges, the conductivity may become insufficient. Above these ranges, the battery capacity may suffer.

The binder used for the production of the positive electrode active material layer is not particularly limited, as long as the binder is a stable material against the solvent used in the production of the nonaqueous electrolytic solution and the electrode.

In the case of coating, the binder may be a material that can be dissolved or dispersed in the liquid medium used for electrode production. Specific examples include resin polymers such as polyethylene, polypropylene, polyethylene terephthalate, polymethylmethacrylate, aromatic polyamide, cellulose, and nitrocellulose; rubber polymers such as SBR (styrene-butadiene rubber), NBR (acrylonitrile.butadiene rubber), fluororubber, isoprene rubber, butadiene rubber, and ethylene-propylene rubber; thermoplastic elastomer polymers such as styrene-butadiene-styrene block copolymer and hydrogenation products thereof, EPDM (ethylene.propylene.diene ternary copolymers), styrene-ethylene-butadiene-ethylene copolymer, styrene-isoprene-styrene block copolymer and hydrogenation products thereof; soft resin polymers such as syndiotactic-1,2-polybutadiene, polyvinyl acetate, ethylene.vinyl acetate copolymer, and propylene.α-olefin copolymer; fluoropolymers such as polyvinylidene fluoride (PVdF), polytetrafluoroethylene, fluorinatepolyvinylidene fluoride, and polytetrafluoroethylene.ethylene copolymer; and polymer compositions having alkali metal ion (particularly lithium ions) ion conductivity. These may be used alone, or two or more may be used in any combination and/or proportion.

The proportion of the binder in the positive electrode active material layer is typically 0.1 mass % or more, preferably 1 mass % or more, further preferably 3 mass % or more, and typically 80 mass % or less, preferably 60 mass % or less, further preferably 40 mass % or less, particularly preferably 10 mass % or less.

When the binder proportion is below these ranges, there are cases where the positive electrode active material cannot be held sufficiently, and the mechanical strength of the positive electrode decreases, with the result that battery performance such as cycle characteristics lowers. Above these ranges, battery capacity or conductivity may decrease.

The liquid medium used to form the slurry is not particularly limited, as long as it is a solvent capable of dissolving or dispersing the positive electrode active material, the conductive material, the binder, and the optionally used thickener. The liquid medium may be a water-based solvent or a nonaqueous solvent.

Examples of the water-based solvent include water, and a mixed solvent of alcohol and water. Examples of the nonaqueous solvent include hydrocarbons such as hexane; aromatic hydrocarbons such as benzene, toluene, xylene, and methylnaphthalene; heterocyclic compounds such as quinoline, and pyridine; ketones such as acetone, methyl ethyl ketone, and cyclohexanone; esters such as methyl acetate, and methyl acrylate; amines such as diethylenetriamine, and N,N-dimethylaminopropylamine; ethers such as diethyl ether, and tetrahydrofuran (THF); amides such as N-methylpyrrolidone (NMP), dimethylformamide, and dimethylacetoamide; and aprotic polar solvents such as hexamethyl phosphoramide, and dimethyl sulfoxide. These may be used alone, or two or more may be used in any combination and/or proportion.

When water-based solvent is used as the liquid solvent for forming the slurry, it is preferable to form the slurry with a thickener and a latex such as styrene-butadiene rubber (SBR). Typically, the thickener is used to adjust the viscosity of the slurry.

The thickener is not limited, as long as it is not detrimental to the advantages of the present invention. Specific examples include carboxymethylcellulose, methylcellulose, hydroxymethylcellulose, ethylcellulose, polyvinyl alcohol, oxidized starch, phosphorylated starch, casein, and salts thereof. These may be used alone, or two or more may be used in any combination and/or proportion.

When using a thickener, the proportion of the thickener with respect to the active material is typically 0.1 mass % or more, preferably 0.5 mass % or more, more preferably 0.6 mass % or more, and typically 5 mass % or less, preferably 3 mass % or less, more preferably 2 mass % or less. Below these ranges, ease of coating may suffer greatly. Above these ranges, the proportion of the active material in the positive electrode active material layer decreases, which may cause the problem of low battery capacity, or may increase the resistance between the positive electrode active materials.

Preferably, the positive electrode active material layer obtained by coating and drying the slurry is compacted by methods such as hand pressing and roller pressing to increase the charge density of the positive electrode active material. The density of the positive electrode active material layer is preferably 1 g·cm⁻³ or more, further preferably 1.5 g·cm⁻³ or more, particularly preferably 2 g·cm⁻³ or more, and preferably 4 g·cm⁻³ or less, further preferably 3.5 g·cm⁻³ or less, particularly preferably 3 g·cm⁻³ or less. A positive electrode active material layer density above these ranges may lower the charge and discharge characteristics, particularly high current density charge and discharge characteristics, because of the difficulty permeating the nonaqueous electrolytic solution to regions in the vicinity of the collector/active material interface. Below these ranges, the conductivity between the active materials may decrease, and battery resistance may increase.

The material of the positive electrode collector is not particularly limited, and any known material may be used.

Specific examples include metallic materials such as aluminum, stainless steel, nickel plate, titanium, and tantalum; and carbonaceous materials such as carbon cloth, and carbon paper. Metallic materials are preferred, and aluminum is particularly preferred.

In the case of metallic material, the collector may have a form of, for example, a metal foil, a metal column, a metal coil, a metal plate, a metallic thin film, an expended metal, a punched metal, and a metal foam. In the case of carbonaceous material, the collector may have a form of, for example, a carbon plate, a carbon thin film, and a carbon column. Preferred is a form of a metallic thin film. The thin film may be meshed, as appropriate.

The metallic thin film of the collector may have any thickness, and is typically 1 μm or more, preferably 3 μm or more, further preferably 5 μm or more, and typically 1 mm or less, preferably 100 μm or less, further preferably 50 μm or less. A metallic thin film thinner than these ranges may fail to provide a sufficient strength as a collector. Ease of handling may be lost, or the overall battery capacity may decrease with a thin film thicker than the foregoing ranges.

The thickness ratio of the collector and the positive electrode active material layer is not particularly limited (the thickness of the active material layer on one side immediately before the injection of the nonaqueous electrolytic solution)/(collector thickness), and is typically 150 or less, preferably 20 or less, particularly preferably 10 or less, and typically 0.1 or more, preferably 0.4 or more, particularly preferably 1 or more. A thickness ratio of the collector and the positive electrode active material layer above the foregoing ranges may cause the collector to generate heat by Joule heating during high current density charge and discharge. Below the foregoing ranges, the volume ratio of the collector with respect to the positive electrode active material may increase, and the battery capacity may be reduced.

### [2-4. Separator]

A separator is typically interposed between the positive electrode and the negative electrode to prevent shorting.

The material and shape of the separator are not particularly limited, and any known materials and shapes may be used, provided that they are not detrimental to the advantages of the present invention. For example, a resin, a glass fiber, and an inorganic product formed of a stable material against the nonaqueous electrolytic solution of the present invention are used, and products having a form of a porous sheet or a nonwoven fabric with excellent liquid retention are preferably used.

Examples of the materials of the resin separator and the glass fiber separator include polyolefins (such as polyethylene, and polypropylene), polytetrafluoroethylene, polyethersulfone, and a glass filter. A glass filter and polyolefin are preferred, and polyolefin is further preferred. These materials may be used alone, or two or more may be used in any combination and/or proportion.

The separator may have any thickness, and is typically 1 μm or more, preferably 5 μm or more, further preferably 10 μm or more, and typically 50 μm or less, preferably 40 μm or less, further preferably 30 μm or less. With a separator thickness below these ranges, insulation and mechanical strength may suffer. Above these ranges, battery performance such as rate characteristics, and the energy density of the nonaqueous electrolytic solution secondary battery as a whole may decrease.

When a porous products such as a porous sheet and a nonwoven fabric is used as the separator, the separator may have any percentage of the pores, and the percentage pore is typically 20% or more, preferably 35% or more, further preferably 45% or more, and typically 90% or less, preferably 85% or less, further preferably 75% or less. When the percentage pore is below these ranges, the film resistance tends to increase, and the rate characteristics tend to suffer. Above these ranges, the mechanical strength of the separator, and insulation tend to decrease.

The separator may have any average pore size, and the average pore size of the separator is typically 0.5 μm or less, preferably 0.2 μm or less, and typically 0.05 μm or more. When the average pore size is above these ranges, shorting is likely to occur. Below these ranges, there are cases where the film resistance increases, and the rate characteristics decrease.

Examples of the inorganic materials include oxides such as alumina and silicon dioxide, nitrides such as aluminum nitride and silicon nitride, and sulfates such as barium sulfate and calcium sulfate. Particulate or fibrous inorganic materials are preferably used. The separator may have a form of a thin film, for example, such as a form of a nonwoven fabric, a woven fabric, and a microporous film. In the case of the thin-film separator, the separator preferably has a pore size of 0.01 to 1 μm, and a thickness of 5 to 50 μm. Aside from the independent thin film form, the separator may be one in which a composite porous layer containing particles of the inorganic material is formed on the surface of the positive electrode and/or negative electrode by using a resin binder. For example, porous layers containing alumina particles with a 90% particle size of less than 1 μm may be formed on the both surfaces of the positive electrode by using a fluororesin binder.

### EXAMPLES

The present invention is described below in greater detail using Examples and Comparative Examples. The present invention should not be construed as being limited to these Examples, unless the descriptions below depart from the gist of the invention.

### Example A

### Preparation of Nonaqueous Electrolytic Solution

### Examples 1 to 4, Comparative Example 1

LiPF₆ was added to a mixture of ethylene carbonate (hereinafter, “EC”; cyclic carbonate) and dimethyl carbonate (volume ratio 3:7) in 1 mol/L under dry argon atmosphere after being sufficiently dried, and dissolved therein in varying concentrations in the combinations of compounds presented in Table 1 to prepare nonaqueous electrolytic solutions of Examples and Comparative Examples.

### Examples 5 to 24, Comparative Examples 2 to 5

LiPF₆ was added to a mixture of monofluoroethylene carbonate (hereinafter, “MFEC”; cyclic carbonate) and dimethyl carbonate (volume ratio 3:7) in 1 mol/L after being sufficiently dried, and the dissolved therein in varying concentrations in the combinations of compounds presented in Tables 2 and 3 to prepare nonaqueous electrolytic solutions of Examples and Comparative Examples.

### <Production of Positive Electrode>

97 mass % of lithium cobalt oxide (LiCoO₂) used as positive electrode active material was mixed with 1.5 mass % of acetylene black (conductive material) and 1.5 mass % of polyvinylidene fluoride (PVdF; binder) in an N-methylpyrrolidone solvent, and the mixture was slurried. The slurry was applied to the both surfaces of a 12 μm-thick aluminum foil to make the negative electrode capacity 90%, dried, and press rolled with a pressing machine to make the thickness 85 μm. The film was then cut into an active material size (a width of 30 mm, and a length of 40 mm) to obtain a positive electrode. The positive electrode was used after being dried at 80 degrees Celsius for 12 hours under reduced pressure.

### <Production of Carbon Negative Electrode>

One part by mass of a carboxymethylcellulose sodium aqueous dispersion (1 mass % carboxymethylcellulose sodium; thickener), and one part by mass of a styrene-butadiene rubber aqueous dispersion (50 mass % styrene-butadiene rubber; binder) were added to 98 parts by mass of a graphite powder (negative electrode active material), and mixed with a disperser to form a slurry. The slurry was applied to the both surfaces of a 12 μm-thick copper foil, dried, and press rolled with a pressing machine to make the thickness 75 μm. The film was then cut into an active material size (a width of 30 mm, and a length of 40 mm) to obtain a negative electrode. The negative electrode was used after being dried at 60 degrees Celsius for 12 hours under reduced pressure.

### <Production of Secondary Battery>

The positive electrode, the negative electrode, and a polyethylene separator were laminated in order of the positive electrode, the separator, the negative electrode, the separator, and the positive electrode. These battery elements were inserted into a bag of a laminate film prepared by coating the both surfaces of aluminum (thickness 40 μm) with a resin layer, with the positive and negative electrodes extending out of the bag. The nonaqueous electrolytic solution (0.6 mL) was then injected into the bag, and the bag was vacuum sealed to produce a sheet-like battery. For improved adhesion between the electrodes, the sheet-like battery was pressurized between glass plates.

### <Battery Evaluation>

### [High-Temperature Storage Test at 4.33 V]

The sheet-like battery was charged and discharged at a final charge voltage of 4.33 V and a final discharge voltage of 3 V under a constant current equivalent of 0.2 C at 25° C. The charge and discharge cycle was repeated several times to stabilize the battery. After 4.33 V constant current-constant voltage charging (0.05 C cut), the battery was subjected to a high-temperature storage test at 85° C. for 1 day. The sheet-like battery was dipped in an ethanol bath before and after the high-temperature storage, and a generated gas amount (high-temperature storage gas amount) was determined from the volume change. The battery voltage after the high-temperature storage, and the remaining capacity were also measured.

TABLE 1
Composition of electrolytic solution (EC-based)

| | | | | Other compound | |
|---|---|---|---|---|---|
| | | Compound of general formula (1), or comparative compound | | | Concen- |
| | Cyclic | | Concentration | | tration |
| | carbonate | Type | (mass %) | Type | (mass %) |
| Ex. 1 | EC | 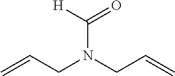 | 0.5 | Vinylene carbonate | 2 |
| Ex. 2 | EC | 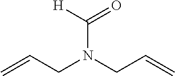 | 1.0 | Vinylene carbonate | 2 |
| Ex. 3 | EC | 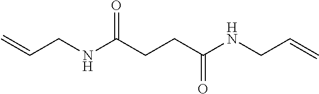 | 0.5 | Vinylene carbonate | 2 |
| Ex. 4 | EC | 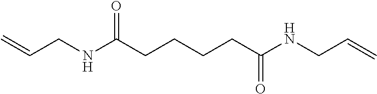 [SMILES: C=CCNC(=O)CCCCC(=O)NCC=C] | 0.5 | Vinylene carbonate | 2 |
| Com. | EC | — | — | Vinylene carbonate | 2 |
| Ex. 1 | | | | | |

TABLE 2
Composition of electrolytic solution (MFEC-based)

| | | | | Other compound | |
|---|---|---|---|---|---|
| | | Compound of general formula (1), or comparative compound | | | Concen- |
| | Cyclic | | Concentration | | tration |
| | carbonate | Type | (mass %) | Type | (mass %) |
| Ex. 5 | MFEC | 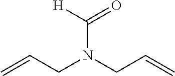 | 0.5 | Vinylene carbonate | 1 |
| Ex. 6 | MFEC | 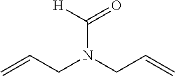 | 1.0 | Vinylene carbonate | 1 |
| Ex. 7 | MFEC | 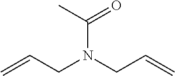 | 0.5 | Vinylene carbonate | 1 |
| Ex. 8 | MFEC | 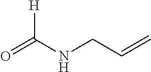 | 0.5 | Vinylene carbonate | 1 |
| Ex. 9 | MFEC | 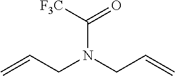 | 0.5 | Vinylene carbonate | 1 |
| Ex. 10 | MFEC | 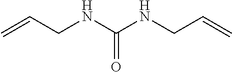 | 0.5 | Vinylene carbonate | 1 |
| Ex. 11 | MFEC | 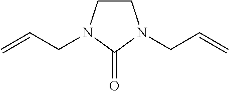 | 0.5 | Vinylene carbonate | 1 |
| Ex. 12 | MFEC | 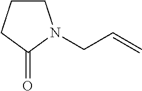 | 0.5 | Vinylene carbonate | 1 |
| Ex. 13 | MFEC | 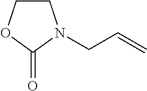 | 0.5 | Vinylene carbonate | 1 |
| Ex. 14 | MFEC | 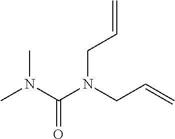 | 0.5 | Vinylene carbonate | 1 |
| Ex. 15 | MFEC | 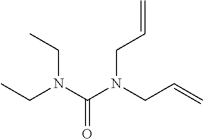 | 0.5 | Vinylene carbonate | 1 |

TABLE 3
Composition of electrolytic solution (MFEC-based)

| | | | | Other compound | |
|---|---|---|---|---|---|
| | | Compound of general formula (1), or comparative compound | | | Concen- |
| | Cyclic | | Concentration | | tration |
| | carbonate | Type | (mass %) | Type | (mass %) |
| Ex. 16 | MFEC | 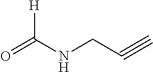 | 0.5 | Vinylene carbonate | 1 |
| Ex. 17 | MFEC | 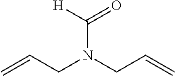 | 0.3 | Vinylene carbonate | 1 |
| | | 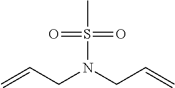 | 0.2 | | |
| Ex. 18 | MFEC | 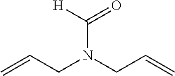 | 0.5 | Vinylene carbonate Adiponitrile | 0.5 1 |
| Ex. 19 | MFEC | 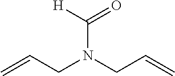 | 0.5 | — | — |
| Ex. 20 | MFEC | 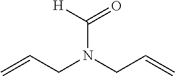 | 0.5 | Adiponitrile | 1 |
| Ex. 21 | MFEC | 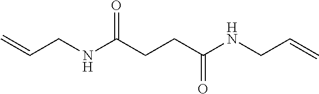 | 0.5 | Vinylene carbonate | 1 |
| Ex. 22 | MFEC | 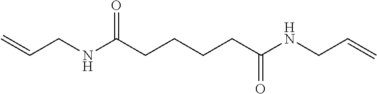 [SMILES: C=CCNC(=O)CCCCC(=O)NCC=C] | 0.5 | Vinylene carbonate | 1 |
| Ex. 23 | MFEC | 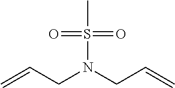 | 0.5 | Vinylene carbonate 1,6-diisocyanate hexane Adiponitrile | 1 0.3 1 |
| Ex. 24 | MFEC | 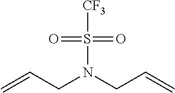 | 0.5 | Vinylene carbonate 1,6-diisocyanate hexane Adiponitrile | 1 0.3 1 |
| Com. Ex. 2 | MFEC | — | — | — | — |
| Com. Ex. 3 | MFEC | — | — | Vinylene carbonate | 1 |
| Com. Ex. 4 | MFEC | 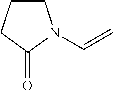 | 0.5 | Vinylene carbonate | 1 |
| Com. Ex. 5 | MFEC | 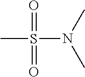 | 0.5 | Vinylene carbonate | 1 |

TABLE 4
Results of high-temperature storage test (EC-based)

| | High-temperature | Voltage after | Capacity after |
|---|---|---|---|
| | storage gas amount | high-temperature | high-temperature |
| | (ml) | storage (mV) | storage (mAh/g) |
| Ex. 1 | 0.34 | 4226 | 136 |
| Ex. 2 | 0.25 | 4235 | 137 |
| Ex. 3 | 0.25 | 4243 | 139 |
| Ex. 4 | 0.27 | 4238 | 138 |
| Com. Ex. 1 | 0.40 | 4221 | 135 |

TABLE 5
Results of high-temperature storage test (MFEC-based)

| | High-temperature | Voltage after | Capacity after |
|---|---|---|---|
| | storage gas amount | high-temperature | high-temperature |
| | (ml) | storage (mV) | storage (mAh/g) |
| Ex. 5 | 0.81 | 4243 | 135 |
| Ex. 6 | 0.62 | 4243 | 136 |
| Ex. 7 | 0.88 | 4236 | 131 |
| Ex. 8 | 0.72 | 4239 | 134 |
| Ex. 9 | 0.80 | 4240 | 131 |
| Ex. 10 | 0.53 | 4242 | 133 |
| Ex. 11 | 0.63 | 4244 | 133 |
| Ex. 12 | 0.88 | 4236 | 132 |
| Ex. 13 | 0.88 | 4236 | 131 |
| Ex. 14 | 0.93 | 4242 | 131 |
| Ex. 15 | 0.81 | 4244 | 131 |
| Ex. 16 | 0.74 | 4239 | 132 |
| Ex. 17 | 0.77 | 4238 | 136 |
| Ex. 18 | 0.63 | 4241 | 134 |
| Ex. 19 | 0.88 | 4239 | 133 |
| Ex. 20 | 0.63 | 4238 | 132 |
| Ex. 21 | 0.64 | 4238 | 132 |
| Ex. 22 | 0.52 | 4243 | 133 |
| Ex. 23 | 0.51 | 4243 | 136 |
| Ex. 24 | 0.59 | 4244 | 136 |
| Com. Ex. 2 | 1.20 | 4232 | 128 |
| Com. Ex. 3 | 0.99 | 4235 | 130 |
| Com. Ex. 4 | 1.11 | 4219 | 124 |
| Com. Ex. 5 | 0.99 | 4215 | 127 |

### Example B

### Preparation of Nonaqueous Electrolytic Solution

### Example 25, Comparative Example 6

LiPF₆ was added to a mixture of EC and propylene carbonate (cyclic carbonates) and diethyl carbonate (volume ratio 1:5:4) in 1 mol/L after being sufficiently dried, and dissolved therein in varying concentrations in the combinations of compounds presented in Table 6 to prepare nonaqueous electrolytic solutions of Examples and Comparative Examples.

### <Production of Positive Electrode>

97 mass % of lithium cobalt oxide (LiCoO₂) used as positive electrode active material was mixed with 1.5 mass % of acetylene black (conductive material) and 1.5 mass % of polyvinylidene fluoride (PVdF; binder) in an N-methylpyrrolidone solvent, and the mixture was slurried. The slurry was applied to the both surfaces of a 12 μm-thick aluminum foil to make the negative electrode capacity 90%, dried, and press rolled with a pressing machine to make the thickness 85 μm. The film was then cut into an active material size (a width of 30 mm, and a length of 40 mm) to obtain a positive electrode. The positive electrode was used after being dried at 80 degrees Celsius for 12 hours under reduced pressure.

### <Production of Carbon Negative Electrode>

One part by mass of a carboxymethylcellulose sodium aqueous dispersion (1 mass % carboxymethylcellulose sodium; thickener), and one part by mass of a styrene-butadiene rubber aqueous dispersion (50 mass % styrene-butadiene rubber, binder) were added to 98 parts by mass of a graphite powder (negative electrode active material), and mixed with a disperser to form a slurry. The slurry was applied to the both surfaces of a 12 mun-thick copper foil, dried, and press rolled with a pressing machine to make the thickness 75 mun. The film was then cut into an active material size (a width of 30 mm, and a length of 40 mm) to obtain a negative electrode. The negative electrode was used after being dried at 60 degrees Celsius for 12 hours under reduced pressure.

### <Production of Secondary Battery>

The positive electrode, the negative electrode, and a polyethylene separator were laminated in order of the positive electrode, the separator, the negative electrode, the separator, and the positive electrode. These battery elements were inserted into a bag of a laminate film prepared by coating the both surfaces of aluminum (thickness 40 μm) with a resin layer, with the positive and negative electrodes extending out of the bag. The nonaqueous electrolytic solution (0.6 mL) was then injected into the bag, and the bag was vacuum sealed to produce a sheet-like battery. For improved adhesion between the electrodes, the sheet-like battery was pressurized between glass plates.

### <Battery Evaluation>

### [High-Temperature Storage Test at 4.2 V]

The sheet-like battery was charged and discharged at a final charge voltage of 4.2 V and a final discharge voltage of 3 V under a constant current equivalent of 0.2 C at 25° C. The charge and discharge cycle was repeated several times to stabilize the battery. After 4.2 V constant current-constant voltage charging (0.05 C cut), the battery was subjected to a high-temperature storage test at 80° C. for 3 days. The sheet-like battery was dipped in an ethanol bath before and after the high-temperature storage, and a generated gas amount (high-temperature storage gas amount) was determined from the volume change. The battery voltage after the high-temperature storage, and the remaining capacity were also measured.

TABLE 6
Composition of electrolytic solution (EC-, PC-based)

| | | | | Other compound | |
|---|---|---|---|---|---|
| | | Compound of general formula (1), or comparative compound | | | Concen- |
| | Cyclic | | Concentration | | tration |
| | carbonate | Type | (mass %) | Type | (mass %) |
| Ex. 25 | EC, PC | 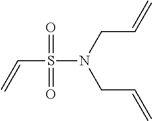 | 0.5 | Vinylene carbonate Lithium difluorophosphate | 1.5 0.5 |
| Com. Ex. 6 | EC, PC | — | — | Vinylene carbonate Lithium difluorophosphate | 1.5 0.5 |

TABLE 7
Results of high-temperature storage test (EC-, PC-based)

| | High-temperature | Voltage after | Capacity after |
|---|---|---|---|
| | storage gas amount | high-temperature | high-temperature |
| | (ml) | storage (mV) | storage (mAh/g) |
| Ex. 25 | 0.10 | 4155 | 174 |
| Com. Ex. 6 | 0.17 | 4154 | 170 |

As is clear from Tables 4, 5, and 7, the batteries of Examples 1 to 25 had the positive electrode protecting effect, and generated less gas after the high-temperature storage. The batteries were superior in terms of voltage and capacity. It can be seen that the batteries using the nonaqueous electrolytic solution according to the present invention involve less gas generation during the high-temperature storage in the charged state of battery, and excel in charge and discharge characteristics, particularly high-temperature storage voltage and capacity.

On the other hand, the batteries of Comparative Examples 1 to 3 and 6 generated more gas after the high-temperature storage, and had lower voltage and capacity. The amide compound used in the battery of Comparative Example 4 was inferior to the amide compound used in the present invention, because the amide compound of Comparative Example 4 had the carbon-carbon unsaturated bond directly bonded to the amide group. The amide compound used in the battery of Comparative Example 5 was also inferior to the amide compound used in the present invention, because the amide compound of Comparative Example 5 did not have a carbon-carbon unsaturated bond in the amide group.

While the invention has been described in detail with reference to specific examples thereof, it will be apparent to one skilled in the art that various changes and modifications can be made therein without departing from the spirit and scope thereof.

The present application is based on Japanese Patent Application No. 2011-036427 filed on Feb. 22, 2011, the entire contents of which are incorporated herein by reference.

### INDUSTRIAL APPLICABILITY

The nonaqueous electrolytic solution of the present invention can suppress degradation of the electrolytic solution in a nonaqueous electrolytic solution secondary battery, and gas generation and battery deterioration in a battery used in a high-temperature environment. The nonaqueous electrolytic solution of the present invention also can be used to produce a high-energy-density nonaqueous electrolytic solution secondary battery. The present invention can thus be preferably used in a wide variety of fields such as in the field of electronic devices that use nonaqueous electrolytic solution secondary batteries.

The secondary battery nonaqueous electrolytic solution, and the nonaqueous electrolytic solution secondary battery of the present invention are not limited to a particular use, and can be used in a variety of known applications. Specific examples include laptop personal computers, stylus-operated personal computers, mobile personal computers, electronic book players, cell phones, portable facsimiles, portable copiers, portable printers, headphone stereos, video movies, liquid crystal televisions, handy cleaners, portable CDs, minidiscs, transceivers, electronic organizers, calculators, memory cards, portable tape recorders, radios, back-up power supplies, motors, automobiles, bikes, small motor vehicles, bicycles, illuminations, toys, gaming machines, watches, electric power tools, strobe lights, and cameras.

1. A nonaqueous electrolytic solution that comprises an electrolyte and a nonaqueous solvent, the nonaqueous electrolytic solution comprising a compound represented by the following general formula (1), 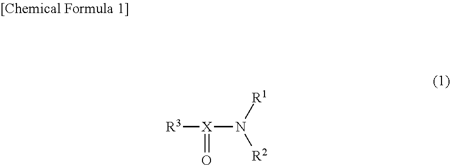
wherein R¹ and R² represents a hydrogen group, or an organic group of 1 to 10 carbon atoms which may contain heteroatom(s), R³ represents a hydrogen group, or an organic group of 1 to 20 carbon atoms which may contain heteroatom(s), R¹ to R³ may be the same or different, and two of or all three of R¹ to R³ may bind to each other to form ring(s),
in which at least one of R¹ and R² represents an organic group of 2 to 10 carbon atoms which has a carbon-carbon unsaturated bond not directly bonded to the nitrogen atom, and may contain heteroatom(s), and
X represents C, S═O or P(R⁴), and R⁴ represents an organic group of 1 to 10 carbon atoms which may contain heteroatom(s).

2. The nonaqueous electrolytic solution according to claim 1, wherein at least one of R¹ and R² in the general formula (1) is an organic group of 2 to 10 carbon atoms which has a carbon-carbon unsaturated bond at a terminal, and may contain heteroatom(s).

3. The nonaqueous electrolytic solution according to claim 2, wherein at least one of R¹ and R² in the general formula (1) is an allyl group or a propargyl group.

4. The nonaqueous electrolytic solution according to claim 1, wherein the nonaqueous electrolytic solution comprises the compound represented by the general formula (1) in an amount of 0.001 mass % or more and 10 mass % or less.

5. The nonaqueous electrolytic solution according to claim 1, wherein the nonaqueous electrolytic solution comprises at least one compound selected from the group consisting of a cyclic carbonate having a carbon-carbon unsaturated bond, a cyclic carbonate having a halogen atom, monofluorophosphate, difluorophosphate, a nitrile compound, and an isocyanate compound.

6. A nonaqueous electrolytic solution battery comprising: a negative electrode and a positive electrode capable of storing and releasing lithium ions; and a nonaqueous electrolytic solution,
wherein the nonaqueous electrolytic solution is the nonaqueous electrolytic solution of claim 1.
